(19) United States
(12) Patent Application Publication
(10) Pub. No.: US 2006/0020469 A1
(43) Pub. Date: Jan. 26, 2006

(54) Apparatus and methods for static and semi-static displays

(76) Inventor: Rodger H. Rast, Gold River, CA (US)

Correspondence Address: RODGER H. RAST, 11230 GOLD EXPRESS DRIVE, SUIT 310 MS 337, GOLD RIVER, CA, 95670, US

(21) Appl. No.: 11/177,968

(22) Filed: Jul. 8, 2005

Related U.S. Application Data
(60) Provisional application No. 60/586,588, filed on Jul. 8, 2004.

(51) Int. Cl. G10L 21/00

(52) U.S. Cl. 704/270

(57) ABSTRACT

A display device for modulating light intensity in response to programmed data output. Tapered cells within a base material containing a fluid within which are contained electrostatically responsive particles. Electrodes couple data signals to opposing portions of the cells, whereupon the position of the particles is modulated in response to the electric potential applied to said electrodes. A number of electronic ink displays, systems and method aspects are described.

### CROSS-REFERENCE TO RELATED APPLICATIONS

This application is a continuation/continuation-in-part of copending regular application Ser. No. 60/586,588 filed on Jul. 8, 2004; and also claims priority from
provisional patent application Ser. No. 60/586,588 filed Jul. 8, 2004; and
provisional patent application Ser. No. 60/266,279 filed Feb. 2, 2001; and
provisional patent application Ser. No. 60/267,115 filed Feb. 7, 2001;
each of the foregoing application are incorporated herein by reference and priority to which is claimed.

This application is also related to copending application Ser. No. 10/891,718 filed Jul. 14, 2004; and provisional patent application Ser. No. 60/487,295 filed Jul. 14, 2005; commonly assigned with the present invention.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to displays and more particularly to low-cost static and semi-static displays.

2. Description of the Background Art

Currently, in order to incorporate a display for an electronic device the system must with complex electronics for driving the display. This drawback has reduced the inclusion of displays on many low cost electronic devices.

A conventional display controls the optical state of each area of the display from a separate control line, or multiplexes the display with rows and column between which a signal is imposed for controlling the activity of those display areas. Even in a multiplexed display, the number of rows and column drive lines necessary is typically a minimum of 2\sqrt{n}, where n is the total number of display areas to be controlled.

In addition, the drive signals must be routed to the display areas for controlling them. The need for drive lines, whether 1-1 (direct) or multiplexed are required regardless of the update rates necessary within the display.

The cost and complexity of implementing these displays has limited their applicability.

Therefore a need exists for low cost displays that can be used in a variety of low-update rate applications. The display devices taught in accordance with the present invention satisfies those needs, as well as others, and overcome deficiencies in previously known techniques.

### BRIEF SUMMARY OF THE INVENTION

The present invention describes a number of static and semi-static update display related embodiments. In arriving at the invention the inventor has discovered that embedded drive lines and multiplexing can be done away on rewritable displays directed toward a number of specific application areas. The invention describes numerous forms of rewritable displays which can be implemented at low cost with reduced component count on the drive electronics.

Current package labels are currently write only, wherein a new label must be applied to alter the visually displayed addressing. In addition, other applications exist for inexpensive reprogrammable displays.

The use of electronic ink has been widely touted for use in books and other media wherein a grid of electrodes is then placed as a netting on both sides of the paper such that any small region of the material may be manipulated either on or off. However, the number and placement of electrodes on such a surface proves to be both expensive due primarily to the requirements for drivers and connection to the tiny embedded electrodes. To achieve a resolution of 300 DPI (generally considered a minimum quality level) requires approximately 3300 horizontal electrodes and 2550 vertical electrodes which must be driven by an attached electrical circuit. Supporting such as large number of connections can prove costly.

Using material coated with electronic ink with printer style devices that generate pixel sized electric fields has been described, however, it will be appreciated that driving a static array of such pixels for the width of a page requires approximately 2550 individual pixel electrodes that must be driven by the circuit voltage. The bar containing the pixel electric field electrodes, segmented electric field, is referred to as an electric field wand.

One of the advantages of electronic ink, is that once the electronic ink material is written it may be just as easily rewritten. However, in certain applications this is also a disadvantage, as others may change the state of the ink.

Therefore a need exists for a simple displays and methods thereof. The displays in accordance with the present invention satisfies that need, as well as others, and overcomes deficiencies in previously known techniques.

Accordingly, a need exists for inexpensive labels and other inexpensive displays which can be readily reprogrammed. The present invention fulfills that need without the expense and other drawbacks of prior techniques.

The present invention includes low cost reprogrammable labels and other display forms utilizing electronic ink. One aspect of the present invention provides a simplified drive mechanism for a segmented electric field configured for setting the state of the electronic ink within the material. This improved wand contains serial to parallel converters along its length wherein a bar containing thousands of pixels may be driven by a few signals from the controller. The state of the pixels being rapidly changed as the wand moves in relation to the elnk containing material.

Moving the wand over the paper requires that the pixels of the wand be modulated according to the rate at which the paper and wand move in relation to one another. The use of a standard feeder mechanism, such as in a printer, can provide a fixed speed as is generally required in devices wherein a physical material is displaced onto the paper.

However, use of electronic ink allows the field transitions that are required for changing the state of the microcapsules to take place at a widely varying rate. Therefore, the wand can be operated over the elnk containing material at a wide variety of speeds. The wand may be moved over the paper by manually moving the wand over the paper, or by manually pulling (or pushing) the paper past a wand device. In either case the speed of the paper must be discerned, and the present invention describes methods utilizing encoder wheels, and the use of detectors which detect the rate at which the material is passing past the wand. One aspect is the embedding of markings onto the paper so that a detector can determine the speed, position, and orientation of the material as it is moved in relation to the wand. A preferred marking is the printing of lines of ultraviolet responsive dyes into the material, wherein the detector reads the passing of the lines to determine position.

One challenge to the use of simplified ePaper utilization is that the electric field still needs to be modulated at the locations in accord with position of the paper. Utilizing a conventional motorized feeder, as is done with typical printers, the rate of feed is known. In conventional printers the head, (ink jet, laser, and so forth) is constrained to a given rate of operation that must coincide with the speed of the paper, given as pages per minute. It will be appreciated, however, that the electric field applied to material containing electronic ink may be passed over the surface at a wide range of speeds without altering the ability to print the material. However, it will be appreciated that the dots of the electric field scan wand still must be turned on and off at a rate that matches the spacing of characters on the page being printed and therefore the speed of the paper.

When being hand-fed, the wand can receive information on the rate of movement in the following ways: (1) roller wheels—material speed is detected in the pull direction; visible tracer lines—visible markings, such as lines on the back of a page, that are detected in order to determine material position and rate of movement; (3) invisible (to humans) markings—ultraviolet or marking visible at other spectral ranges wherein the markings do not interfere with viewing the electronic ink; (4) granularity detector—apparatus and method that utilizes the particulate nature of the deposited electronic ink microcapsules to detect the relative movement.

It will be appreciated that in order to change the state of the microcapsules they must be exposed to an electric field potential, wherein the of the materials within the associated suspension respond in alignment with the field and remain in the orientation even after the field is removed. Deposited grid lines on each side of the elnk material provides a method of addressing the microcapsules. The aforementioned lower cost displays deploying electronic ink utilize a single side wand, or screed, that is run over a single side of the material containing the electronic ink microcapsules. An opposing phase of the screed drive voltage is coupled to the opposing side of the display utilizing top side conductive areas which connect to the underside conductor, such as edge bars, grids, and conductive pad areas. The screed can then “print” an electronic label or page without access to the other side, which may be attached to another article. The conductive areas may be brought to the top surface in a number of ways. In one method a conductive grid is applied to the material (single signal—not as in a pixel addressable display) after which the elnk is applied over selected areas, thus providing access to the underside conductor. Furthermore, these edge areas according to the invention may be configured for removal, such as by segmentation (perforations) whereby the conductive areas may be removed such that the display can no longer be reprogrammed.

Electronic labels created according to the invention, provide a number of benefits within commerce as they may be topically reprogrammed. Numerous forms of electronic labels are described, including built-in programmable tags (i.e. on file folder labels, binders), reprogrammable bar code tags, package date codes which are “printed” at the time of production, package shipping addresses (originally provided as indirect addresses which are converted to direct addressed—as per another application from same inventor), warning labels whose message only appears in response to an nearby active electric field, and so forth.

A device for programming the aforementioned topically reprogrammable labels and tags is described which allows in-situ printing and optionally reading of labels. The device provides for voiced input of label information, which at user discretion is printed during a subsequent scan. The topical programmer provides an optional display so that the user can verify the proper audio conversion prior to reprogramming the label. The topical programmer also provides an optional optical reader, such that tags may be read in, and either altered or reprogrammed. This for example can facilitate relabelling items, wherein information read from the old label is used for creating the new label. This provides great utility with bar codes, pricing labels, package numbers, dates and so forth.

Very low cost reprogrammable and semi-active displays are described for use in various industries, such as advertising, point of sale, roadside, entertainment, and informational. In these displays electrode sections are configured for various forms of movement in relation to the material coated with electronic ink. By way of example thee following are described according to the invention: a circular sweep display, a cylindrical sweep display, a continuous loop scrolling display, plotters, and a spherical display. One of the displays is shown for use within lighting wherein the displayed text or graphic advertisement (backlight by the fixture) is reprogrammed by rotating the fixture, after loading in new information to the display. The above signs may also each be alternatively changed by means of manual cranking to reprogram the display.

Reprogramming sheets containing embedded electronic ink is described for extending the display area of a computer display, such that reference information may be printed on the fly to extend the “size” of the display area. For example, a screed is shown built into a peripheral edge of a laptop computer through which a panel containing electronic ink is slid. The user need only activate the screed when a desired reference item is on the screen, and then extract the panel. The panel provides reference information so that the user need not use a standard printer to print out throw-away reference pages, or toggle back and forth between screens. Alternatively, the active elements within a typical flat panel display can be adapted to generate an electric field in addition to controlling the display, such that the panel can be programmed by the display itself to a matching image.

An input tablet configured with a semi-active display of electronic ink is described. The tablet allows the user to draw with a electric-field stylus on pad containing electronic ink with embedded electric field sense grid. The input from the stylus both changes the state of the electronic ink and inputs the data to the computer, therefore, what is shown on the input tablet and represented on the computer remain synchronized. The user can erase, or rewrite the semi-active display, by means of a slidable screed, or less cost effective set of embedded upper and lower drive wires. The electric field sense grid is configured to respond to the electric field from the stylus, (either wired or wireless) in the same proportion as the electronic ink responds, so that the resultant captured image matches the image printed. By expanding the size of the tablet, a large electronic blackboard is created wherein whatever is written with the stylus can be captured by the computer. Erasers of various sizes are created with opposing electric field polarity in relation to the field potential of the large area electrode behind the electronic blackboard, wherein wiping down the display actually clears the desired region in similar manner to a conventional chalkboard, while simultaneously correcting the image held by the computer.

A simple reusable notepad is described, such that a stylus is used for applying an electric field at a moving point applied to the material containing electronic ink. The entire area can be erased at the push of a button to allow a new message to be written.

Power for a semi-active display can be derived from a conventional power-source, however, a method is described for overlaying a semi-active display utilizing electronic inks over an active area containing a photoelectric material for the generation of circuit power. In addition the photoelectric circuit may be interspersed with active devices, such as polymer transistors and the like, for controlling the pixels of the display.

Another device of the invention is a screed form of wand device for use with areas of electronic ink which span widths beyond the length of a typical programming wand; wherein the wand can be extended and contains optical detectors. The optical detectors determine the state of adjacent electronic ink pixels such that the images or text may be properly aligned although programmed in separate strips.

Embodiments of the present invention can provide a number of beneficial aspects which can be implemented either separately or in any desired combination without departing from the present teachings.

An object of the present invention is to provide a low cost reprogrammable shipping label.

Another object of the invention is to provide reprogrammable label upon which an indirect address may be reprogrammed with a direct address.

Another object of the invention is to provide low cost reprogrammable displays.

Another object of the invention is to provide electric field wand and ePaper sheet material containing electronic ink that allows scanning through by hand.

Another object of the invention is to provide segmented electric field electrodes capable of being individually driven with an applied voltage level, typically either on or off.

Another object of the invention is to provide low cost and/or large area semi-active displays which are refreshed at a non-real time rate, such as scrolling displays and so forth.

Another object of the invention is to provide optically state reprogramming in response to only gaining access to the top surface of the material.

Another object of the invention is to provide a simplified wand structure with screed that facilitates addressing.

Another object of the invention is to provide an elnk enhancement to facilitate variable-speed “wanding”.

Another object of the invention is to provide the use of tracer lines, for example optical (i.e. on back of page), ultraviolet (on either side) and so forth.

Another object of the invention is to provide exposed conductor track for making connection with wanding device.

Another object of the invention is to provide inexpensive displays—that require fewer scan lines.

Another object of the invention is to provide read-only mechanism with removal of area with conductive strip.

Another object of the invention is to provide granularity detection apparatus and method within the sensing of screed motion, for use with fixed or random elnk deposition.

Another object of the invention is to provide electronic labels with speed-tracks, with exposed ground plane.

Another object of the invention is to provide electronic labels with built-in programmable tags (i.e. on file folder labels, binders).

Another object of the invention is to provide electronic labels with programmable bar code tags.

Another object of the invention is to provide electronic labels with package date codes “printed” at the time of production.

Another object of the invention is to provide electronic labels with package shipping address (for consumer protection as per another application from same inventor).

Another object of the invention is to provide electronic field warning labels.

Another object of the invention is to provide a voice conversion programming wand, or one capable of taking external input.

Another object of the invention is to provide a semi-static circular display (such as a clock face wristwatch etc.).

Another object of the invention is to provide a semi-static drum display (like a scrolling textual display).

Another object of the invention is to provide a semi-static scroll display (i.e. advertising sign & reusable paper chart recorder).

Another object of the invention is to provide a semi-static panel printer providing extra screen surface.

Another object of the invention is to provide a semi-static panel printer in a laptop computer (built-in ewand).

Another object of the invention is to provide a semi-static panel printer as part of video display.

Another object of the invention is to provide a semi-static stylus surface.

Another object of the invention is to provide a writing tablet w/stylus and erase button—(i.e. children's drawing tablet, bulletin board, face of refrigerator.

Another aspect of the present invention is to provide a programmable static display, and material, whose transmissivity can be controlled by the application of an electric field.

Another aspect of the present invention is to provide a programmable transmissive display and material which can be fabricated at low cost in high volume rolls and cut to size for a variety of signage and display applications.

Another aspect of the present invention is to provide a programmable static display, and material, which may be utilized over backlighting and/or base materials operating in a reflective mode.

Another aspect of the present invention is to provide a programmable transmissivity display and material that also provides sufficient contrast in a reflective mode.

Another aspect of the present invention is to provide a material that may be utilized for creating transmissive active displays, static displays, and quasi-static displays.

Another aspect of the present invention is to provide a method of fabricating a programmable transmissive display and material.

Another aspect of the present invention is to provide a non-programmable material which may be utilized as a monochrome light transmissive backing for a printed article, to enhance visibility in low light and increasing apparent depth in all light conditions.

Another aspect of the present invention is to provide a programmable display and material which can provide any number of optical states.

Another aspect of the present invention is to provide a programmable display and material which can selectively direct the direction at which light is passed from a first side through to a second side of the material.

Another aspect of the invention is that it provides lower cost moving electrode programming for the display.

Another aspect of the invention is a display scroll in which both sides of page can be written upon.

Another aspect of the invention is a display scroll that can display a edge menu on each page for common selections.

Another aspect of the invention is a scroll page that can be held in either direction (page to right or to left).

Another aspect of the invention is that the scroll once extended preferably locks in out position until unlocked.

Another aspect of the invention is a scroll can be unlocked by button, hyperextension, jerk extension, and so forth.

Another aspect of the invention is the ability for extending multiple pages if desired.

Another aspect of the invention is that of displaying of a menu on extended portion of page.

Another aspect of the invention is that of verifying input on eink page in response to a “quick cast”.

Another aspect of the invention is user selections via TOC or other indexing on small active display.

Another aspect of the invention is that of utilizing programming electrodes as a user input device.

Another aspect of the invention is that it can record spoken notes

Another aspect of the invention is that it can associate notes with pages, paragraphs, lines, or specific text or graphics.

Another aspect of the invention can allow user to highlight lines of text.

Another aspect of the invention allows the user to select lines of text for copy into an upload buffer.

Another aspect of the invention is that it can be powered or charged from USB port and/or solar cells.

Another aspect of the invention is that solar cells can retain charge when not used for periods of time.

Another aspect of the invention is that content and/or notes can be downloaded or uploaded to/from device.

Another aspect of the invention is to provide a convenient means for writing labels on storage media.

Another aspect of the invention is to provide a media which can be easily label with a rewritable label.

Another aspect of the invention is to provide a method of rewriting labels such as on rewritable media.

Another aspect of the invention is to provide a means of writing media that can be performed on the fly within a media recording device.

Another aspect of the invention is to provide a means of writing media that can be performed with an inexpensive and portable device.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a schematic of a drive wand according to an aspect of the present invention, shown with series of shift registers.

FIG. 2 is a side view of the wand of FIG. 1 shown in electrical contact with an electronic ink material.

FIG. 3 is an end view of the wand of FIG. 2, shown with a mechanical motion detector wheel.

FIG. 4 is a top view of an electronic ink material whose position may be sensed according to an aspect of the present invention.

FIG. 5 is a side view of position sensing within FIG. 4.

FIG. 6 is a top view of an electronic ink material configured for single side programming according to an embodiment of the present invention.

FIG. 7 is side view of a rolling wheel contactor according to an embodiment of the present invention.

FIG. 8 is a side view of a electrical sensing contactor according to an embodiment of the present invention.

FIG. 9 is a top view of a reprogrammable bar code label according to an embodiment of the present invention.

FIG. 10 is a top view of a reprogrammable label according to an embodiment of the present invention, shown having an address region containing electronic ink.

FIG. 11 is a side view of a container containing a reprogrammable tag according to the present invention.

FIG. 12 is a block diagram for a reprogramming wand according to an embodiment of the present invention.

FIG. 13 is a top view of a low cost circular display according to an embodiment of the present invention.

FIG. 14 is a block diagram of a circuit according to an aspect of the present invention which is configured for driving the display of FIG. 13.

FIG. 15 is a facing view of a cylindrical display embodiment according to an embodiment of the present invention.

FIG. 16 is a facing view of a continuous scroll display embodiment according to an embodiment of the present invention.

FIG. 17 is a facing view of a stationary cylindrical display embodiment according to an embodiment of the present invention.

FIG. 18 is a facing view of a curving member display embodiment according to an embodiment of the present invention.

FIG. 19 is a facing view of a scrolling graph recorder according to an embodiment of the present invention.

FIG. 20 is a top view of a circular trace graph according to an embodiment of the present invention.

FIG. 21 is a facing view of a screen extension display according to an embodiment of the present invention.

FIG. 22 is side view of the extension display of FIG. 23.

FIG. 23 is a perspective view of an input tablet according to an embodiment of the present invention.

FIG. 24 is a facing view of a simple form of tablet according to an embodiment of the present invention.

FIG. 25 is a schematic of the tablet of FIG. 24.

FIG. 26 is a perspective view of an electronic ink display which generates circuit power according to an embodiment of the present invention.

FIG. 27 is a side view of the display of FIG. 26.

FIG. 28 is a facing view of a screed utilized for programming large areas containing electronic ink according to an embodiment of the present invention.

FIG. 29 is a block diagram of a label printing device according to an aspect of the present invention.

FIG. 30 is a facing view of an label according to an aspect of the present invention.

FIG. 31 is a schematic of a label printing device according to an aspect of the present invention.

FIG. 32 is a flowchart of label printing according to an aspect of the present invention.

FIG. 33 is a perspective view of a dual-electrode bar screed element according to an aspect of the present invention.

FIG. 34 is a cross-section view of an electrode bar element according to an aspect of the present invention.

FIG. 35 is a perspective view of dual-electrode bar screed element, having a programming bar and erase bar according to an aspect of the present invention.

FIG. 36 is a facing view of a plurality of electrodes within in integrated screed element according to an aspect of the present invention.

FIG. 37 is a rear view of components in the screed of FIG. 36 according to an aspect of the present invention.

FIG. 38 is a schematic of integrated screed control circuits within the device of FIGS. 36 and 37 according to an aspect of the present invention.

FIG. 39 is a flowchart of dual output/input screen use according to an aspect of the present invention.

FIG. 40A-40B are cross-section views of dual output-input screed use according to an aspect of the present invention.

FIG. 41 is a perspective view of a touch sensitive screed element according to an aspect of the present invention.

FIG. 42 is a perspective view of linear array of programming electrodes according to an aspect of the present invention.

FIG. 43 is a perspective view of a single row of electrodes within the array of FIG. 42, according to an aspect of the present invention.

FIG. 44 is a side view of a biased state display according to an aspect of the present invention.

FIG. 45 is a front view of a biased state display according to an aspect of the present invention.

FIG. 46 is a side view of a segmented biased state display according to an aspect of the present invention.

FIG. 47 is a front view of the segmented biased state display of FIG. 46, shown according to an aspect of the present invention.

FIGS. 48 and 49 are schematics of integrated sensing mechanism embodiments within an electronic ink display according to an aspect of the present invention.

FIG. 50 is a cross-section view of a conventional electronic ink laden material.

FIG. 51 is a cross-section view of a transparency modulated electronic ink according to an aspect of the present invention.

FIG. 52 is a facing view of the transparency modulated elnk shown in FIG. 51 according to an aspect of the present invention.

FIG. 53 cross-section view of another transparency modulated electronic ink according to an aspect of the present invention.

FIG. 54 is a cross-section view of another transparency modulated electronic ink according to an aspect of the present invention.

FIG. 55 is a cross-section view of another transparency modulated electronic ink having integral backlighting according to an aspect of the present invention.

FIG. 56-57 are cross-section view of a light directive electronic ink display according to an aspect of the present invention.

FIG. 58 is a facing view of a low cost electronic book device according to an aspect of the present invention, showing a semi-static electronic ink page being viewed.

FIG. 59 is a facing view of another low cost electronic book device according to an aspect of the present invention, showing menu tree selection and combined input sensing.

FIG. 60-61 are perspective views of a semi-static electronic ink book according to an aspect of the present invention.

FIG. 62 is a facing view of an electronic book with manual page advance according to an aspect of the present invention.

FIG. 63 is a side view of the electronic book of FIG. 62, according to an aspect of the present invention.

FIG. 64 is a perspective view of a low cost semi-static cylindrical display according to an aspect of the present invention, shown incorporated within a prescription medicine bottle.

FIG. 65 is a schematic of the display of FIG. 64 according to an aspect of the present invention.

FIG. 66A-69 are perspective views of rotating semi-static displays according to an aspect of the present invention.

FIG. 70 is a perspective view of a reel-mount semi-static display according to an aspect of the present invention, shown with a block diagram of drive electronics.

FIG. 71 is a facing view of motion sensing strip for the reel-display of FIG. 70 according to an aspect of the present invention.

FIG. 72 is a schematic of reel sensing for the reel of FIG. 70, according to an aspect of the present invention.

FIG. 73 is a facing view of a tape dispenser configured for semi-static printing according to an aspect of the present invention.

FIG. 74 is a schematic of the control electronic for the tape dispenser of FIG. 73, according to an aspect of the present invention.

FIG. 75 is a facing view of the printed tape from dispenser shown in FIG. 73, according to an aspect of the present invention.

FIG. 76 is a perspective view of a semi-static display configured with integral solar power according to an aspect of the present invention.

FIG. 77 is a schematic of the solar enabled semi-static display of FIG. 76 according to an aspect of the present invention.

FIG. 78A-78B are perspective views of gravity written semi-static displays according to an aspect of the present invention.

FIG. 79-80 are perspective views of slider style semi-static displays according to an aspect of the present invention.

FIG. 81 is a perspective view of a flexible rotating collar semi-static display according to an aspect of the present invention.

FIG. 82 is a cross-section view of the sleeve of FIG. 81, shown according to an aspect of the present invention.

FIG. 83A-83B are facing views of a tilting semi-static display according to an aspect of the present invention.

FIG. 84 is a schematic of the tilting display of FIG. 83A-83B according to an aspect of the present invention.

FIG. 85 is a perspective view of a tracked semi-static display according to an aspect of the present invention.

FIG. 86 is a schematic of the tracked display of FIG. 85, according to an aspect of the present invention.

FIG. 87-88 are facing views of swinging arm semi-static displays shown according to an aspect of the present invention.

FIG. 89 is a facing view of a combined field drive matrix for an electric in region according to an aspect of the present invention.

FIG. 90 is a cross-section of the matrix material shown in FIG. 89, according to an aspect of the present invention.

FIG. 91 is a facing view of staggered matrix routing for the combined field drive shown in FIG. 89, according to an aspect of the present invention.

FIG. 92 is a side view of a media label programming device according to an aspect of the present invention.

FIG. 93 is a side view of a portable media label programming device according to an aspect of the present invention.

FIG. 94 is a underside view of a portable media label programming device according to an aspect of the present invention.

FIG. 95 is a perspective view of another media label programming device according to an aspect of the present invention, shown configured for radial programming as well as line-by-line programming.

FIG. 96 is a schematic of the media label programming device of FIG. 95, according to an aspect of the present invention.

FIG. 97 is a perspective view of a stamping system according to an aspect of the present invention.

FIG. 98 is an underside view of the stamp portion adapted for stamping on various materials, as shown in FIG. 97 according to an aspect of the present invention.

FIG. 99 is a schematic of the stamping system of FIG. 97 according to an aspect of the present invention.

FIG. 100 is a facing view of a sheet of labels according to an aspect of the present invention.

### DETAILED DESCRIPTION OF EMBODIMENT(S)

Referring more specifically to the drawings for illustrative purposes, the present invention is embodied in the method generally described in FIG. 1 to FIG. 100. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

Programming Screed.

FIG. 1 through FIG. 3 illustrate an example of an electronic ink programming “screed” according to an aspect of the present invention for semi-static display. FIG. 1 is a drive circuit 10 for a printing wand, or screed, comprising an electrode drive means for application to a plurality of electrodes for programming the optical state of electronic ink spheres on a material over the screed is passing (or alternately material moving in relation to a fixed screed). The electrode drive means in one embodiment incorporates a means for converting a serial input into a parallel output, wherein simple serial line connectivity can be established rather than a large number of parallel connections.

According to one embodiment the means for converting a serial input into a parallel output within the electrode drive means comprises a series of shift registers 12a-12f (the number of which is determined by the desired resolution and length of the wand) distributed along a portion of the wand. The pixels of the wand may be driven by a set of signals for driving the conversion of serial data Din 14 into parallel data that creates electric fields at the surface of the material to set the state of the microcapsules. The embodiment shows the use of Din 14 connected in series to the shift registers which are clocked by a Clk signal such that the data is loaded across the span of shift registers. An optional reset line 18 is shown for clearing the shift registers simultaneously, such as for an erase operation. The outputs of the shift registers are connected to sets of pixel electrodes 20 and 22 (each shift register has a set of pixels). The signals 24 continue to subsequent shift registers including optional Out 26. The shift registers upon receiving an edge transition cause the output of data contained in the bits of the shift register to the pixel electrodes. It is preferred that the output bits of the shift register as set to output either a positive or a negative voltage in relation to a ground held on the opposing side of the material.

FIG. 2 is the wand 30 according to the invention being passed over an elnk material 32 having conductive backing 34 which is in electrical contact with the wand 30 having electrode 36. The pixels of wand 30 are driven in relation to the backing electrode by opposing voltages 38 and 40 logically switched between either positive or negative voltage in relation to the backing electrode 34.

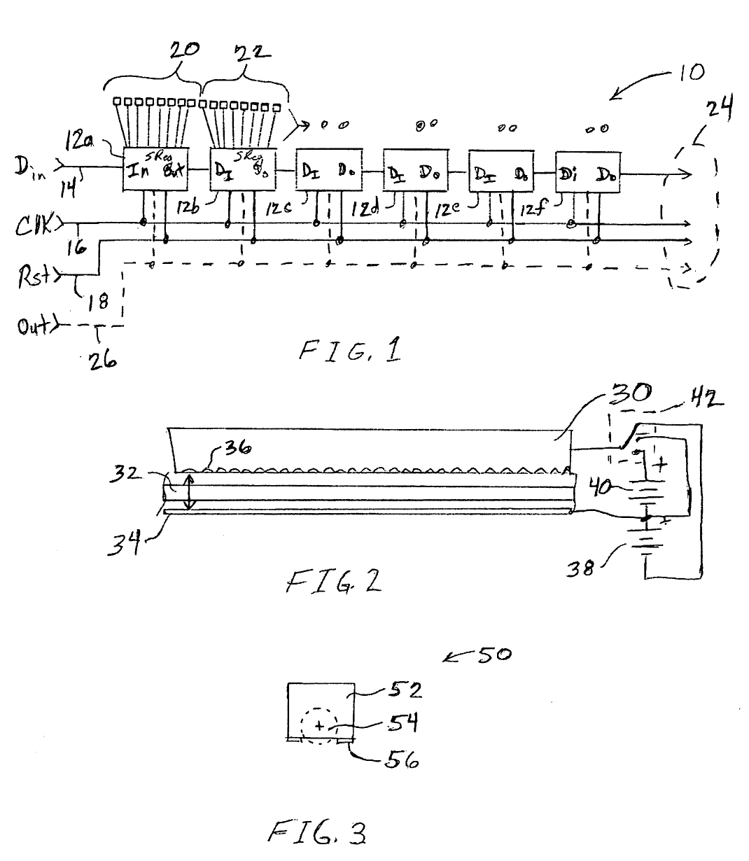

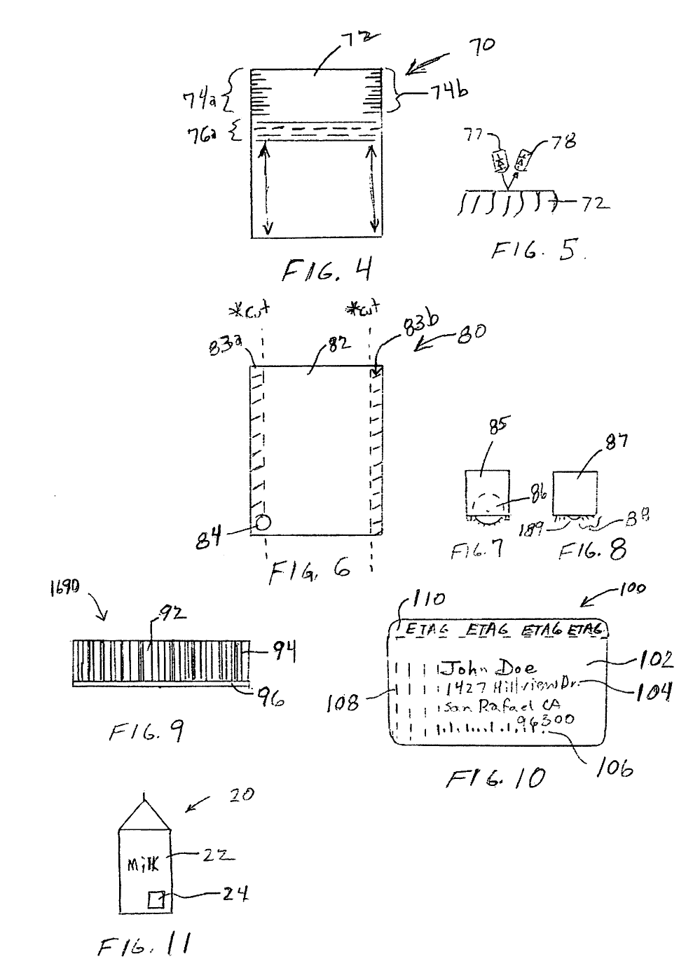

FIG. 3 is a wand 50 containing a bar 52 with a mechanical detector wheel 54 for sensing the movement of the wand over the material containing the electronic ink. It should be appreciated that other sensing means can be used for detecting motion, for example texture sensing, position sensing, or optical sensing such as the low resolution optical imaging systems used in all optical mice. The pixel electrodes are preferably contained in a strip 56 retained proximal to the elnk material so that wand 50 may be passed over the material to set the optical state of the electronic ink material 32.

Reprogrammable Tags and Labels.

FIG. 4 through FIG. 11 illustrate a number of embodiments of tags and labels which can be utilized with the screed described in FIG. 1-FIG. 3, or variations thereof.

The present invention includes reprogrammable labels which may be utilized in the marking of packages associated with the consumer privacy system described above, or utilized separately in labels and low cost displays.

FIG. 4 is a material 70, configured for being positionally sensed electronically. A sheet of material 72 is shown having embedded elnk microcapsules and configured according to the present invention with track scan lines of various types. The track scan lines allows the material to be properly printed with correct ratiometric proportions despite speed fluctuations between the electric field and the material. A track scan sensing means, such as a reader (i.e., optical sensing head) is positioned adjacent the material which detects the lines on the material as it is moving in relation to the electric wand. One aspect utilizes a series of various length lines 74a, 74b, wherein the rate of movement as well as positioning is determined by the circuitry of the present system, in response to detecting the time between passing over the various lines and the characteristics of the lines.

Although the lines are shown at varying length for ease of representation, they may be of different colors, line widths, have different dash patterns or be solid, and so forth and combinations thereof, wherein the system can detect positioning better than if all lines are of the same characteristics. This aspect is depicted as a full span set of lines 76 having diverse character (such as different width, breaks versus solids and so forth). The lines on the material may be printed with ink that is visible or preferably with ink that is reflective only to limited wavelengths of light, such as ultraviolet.

FIG. 5 shows another embodiment of motion sensing which has a means for sensing rate of movement over the electronic ink spheres within material 72. In this embodiment the small microcapsules, often approximately the diameter of a human hair, or on the order of approximately 25 um to 100 um can provide the speed detection matrix for the wand or screed. A light source 77 and detector 78 are shown, such as for detecting visible, or ultraviolet lines on the material as described in FIG. 4. The use of a highly collimated focused beam 77 allows for detecting the particularity of the microcapsules within the material in response to the rate of movement between detector 78 and material 72. As the microcapsules are typically randomly, but evenly, distributed on the material the particles can be detected to ascertain the speed of the wand. Light reflection angle and intensity changes in as microspheres pass through the sensing area, therein modulating the optical signal input of sensor 78 and generating a modulating frequency which is proportional to the rate of wand movement. The circuit is preferably configured with an averaging means wherein slight variations in local electronic ink sphere density are not incorrectly registered as speed changes. The circuit may comprise analog circuits which can perform averaging, or programmatic means for factoring in this averaging.

FIG. 6 is a sheet material 80 containing elnk configured for having the optical properties of the material set on a single sided as desired by a wand as shown in FIG. 1 and FIG. 2. The material 82 has a conductive backing connecting to conductive strips along the front of the material 83a, 83b. The wand is moved over the material 82 and the wand makes contact with the conductive strips such that electric fields may be generated across the material. Alternatively, one or more contact points 84 can provide the electrical contact. It will be appreciated that high levels of conductivity are not necessary. Sufficient conductivity can be achieved with polymeric materials, semiconductive material, sputtered materials, sprayed on materials, printing techniques, and so forth. Conductive materials (e.g., microparticles of metal, amorphous semiconducting materials, conductive polymeric materials, and so forth), may be mixed with otherwise conventional inks and printed onto the backing and/or edges of the material, or even loaded into cartridges wherein the wand interface for the reprogrammable material can be printed on-demand by a user in any desired shape or configuration. Even sheet resistances above 1000 ohms/square can provide sufficient conductivity for setting the state of electronic ink spheres, as the elnk sphere rotational change is in response to a sufficient electric field, not in response to current levels.

FIG. 7 and FIG. 8 show additional forms of contactor wands 85, 87, for contacting the opposing side of the material when programming the optical state of the electronic ink spheres in the material. In FIG. 7 the bar 85 of the wand contains a wheel 86 with exterior protrusions that puncture the membrane to electrically connect to the backing material. In FIG. 8 the bar 87 is configured with conductive brush segments 88 and an electrode bar 89.

FIG. 9 is a reprogrammable bar code label 90, containing strips 92 and spaces 94, a conductive strip 96 provides conductive access to the backing portion of reprogrammable bar code label 90. The backing again forming a background contact to operate in combination with the electric field potential on the modulated electrode moved across the surface of the material during programming. The wand for programming the bar code label 90 is preferably adapted with a single elongated electrode, or a number of elongated electrodes, whose electric field potential in relation to the backing potential is modulated between a first and second state as the wand moves for programming the optical state of the spheres in response to wand movement.

FIG. 10 is a reprogrammable label 100 having an address region 102 with electronic ink showing a programmed address 104 and zip code bar code 106. The speed of wand movement is determined by detecting the particulations of the electronic ink capsules, or by the sensing imprinted or embedded lines 108, or other characteristics (i.e., ultraviolet lines). A strip 110 contains a sufficiently conductive region to provide a connection for the wand to apply a voltage to the background in relation to the potential at the electrode wherebetween the two the elnk spheres are subject to the applied potential in rotating to a desired optical state.

FIG. 11 is a container 120 with conventional material sides onto which is printed a reprogrammable tag 124 which can be printed at the time of production, such that recent information can be written onto the tag. This tag is preferably configured with the conductive backing and conductive material access on the front surface, wherein the stamp or wand can be applied to the label after the label is attached to the container. Alternatively, tag 124 can be integrated within the material of container 120, for example as a portion of the material, such as a section on a printed cardboard, which contains the electronic ink and the conductive backing and access regions to provide for programming of the optical state of the label at a later time.

Programming Wand/Screed Control Electronics.

The following circuit may be used with the screed shown in FIG. 1-FIG. 3, or variations thereof and provides for programming of the optical state for electronic ink retained on a material.

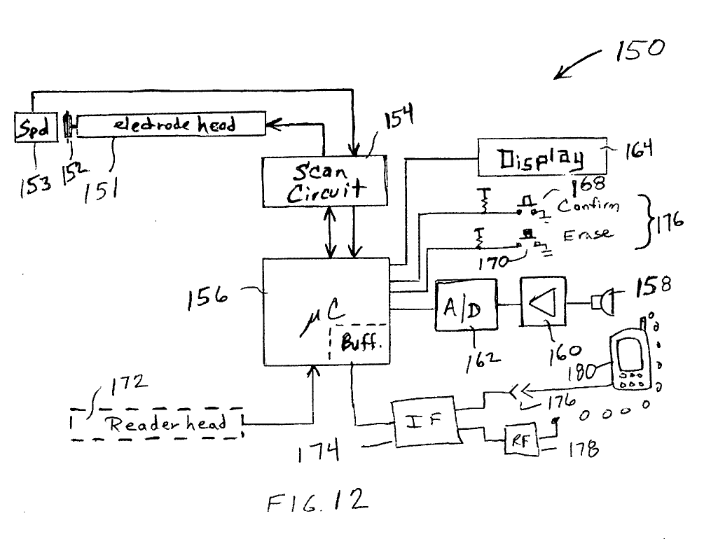

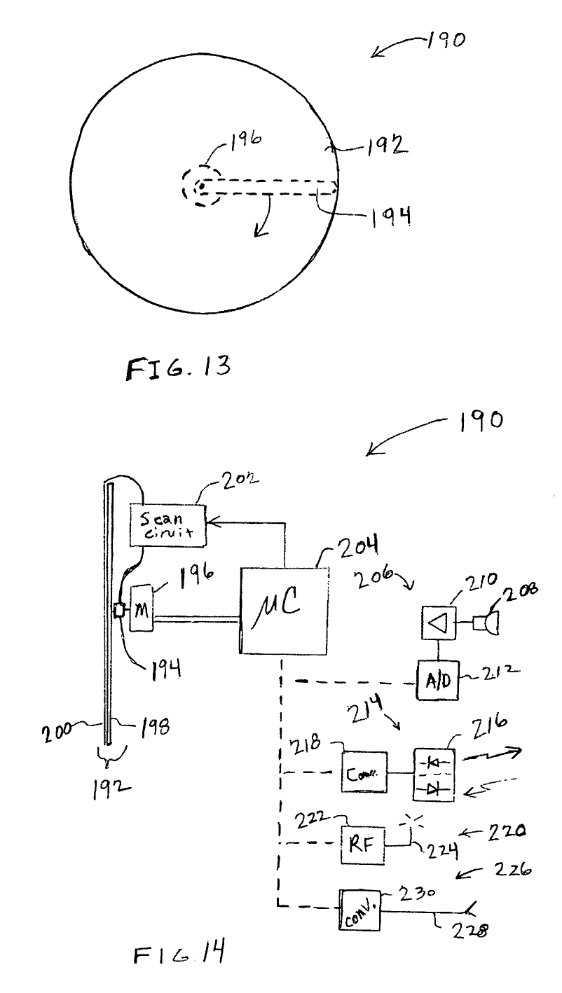

FIG. 12 is a reprogramming wand 150, including a screed such as described earlier, that allows tags printed with electronic ink to be conveniently reprogrammed in response to external input. In a first mode a voiced input, such as language, command strings, and so forth are registered, decoded and utilized for determining how the optical properties of the electronic ink spheres are to be programmed. For example, language can be detected and converted within a microprocessor to text to be displayed. Alternatively, or additionally, the voice input can be used to select one or more predetermined or preloaded sets of text, graphics and/or commands as the basis for setting the optical states of the electronic ink. The commands may include selecting of preprogrammed elements to be programmed, or included within the programmed output. The voice input may also be used to select commands and the like for output. If the application is one of displaying voice characteristics the amplitude, frequency, waveforms, and other characteristics o combinations of characteristics can be detected and output for programming the state of the electronic ink spheres using the wand.

Another external input is illustrated by example utilizing an interface 174 which can receive text and/or graphics information either by a wired connection 176 to an electronic device 180 which sources the text and/or graphics information from either an internal memory, from user inputs, or in response to communicating with other systems. For example the input data can be received from a computer, laptop computer, personal digital assistant (PDA), cellular phone, dedicated programming device, and so forth. It will be appreciated that a wireless interface means 178 can be integrated for receiving text, graphic data, and/or commands from a remote device, such as using an RF link (or optical, inductive, capacitive, electric field intensity and so forth).

The electrode head 151 has a contactor wheel 152 for providing the opposing programming voltage. A speed detection circuit 153 provides feedback on programming speed. The electrode head 151 and speed detection circuit 153 are both connected to a scan circuit 154 which coordinates the speed and printing head of the wand. The scan control circuit is connected to a controller 156 which coordinates the actions of the circuit elements and generates the signals to drive the scan circuit. The microphone 158 is connected to a conditioning circuit 160 and an A/D converter 160 that digitizes the voice input. The microcontroller provides DSP functionality for speech to text conversion. An optional display 164 allows the user to see the converted speech prior to printing a label. A user interface 166 allows control inputs to be given by the user. A confirm button 168 is shown that the user can press after verifying the correct text on the display 164. Additionally, an erase button 170 allows erasing the converted speech such that additional speech may be input to the device. An optional reader head 172, allows a label to be read either textually, or by a bar code. The text is read in and can be communicated to other systems, after which the label can be reprogrammed with a new bar code or text.

Semi-Static or Slow-Scan Display Embodiments.

In addition to quasi-static reprogrammable labels, a number of inexpensive semi static, or slow-scan, displays are described. It will be appreciated that the conventional use of electronic ink that utilizes an the microcapsules interposed between matrices of fine grids, or deposited over an active transistor matrix, require a large number of addressing lines and associated circuitry which increase cost.

FIG. 13 is a low cost circular display 190 which is capable of displaying text or graphics. A circular region of material 192 is covered, or has embedded, electronic ink microcapsules. A screed section 194, as described previously, is disposed in proximal contact thereon and attached to a center axis 196 through which rotational drive is applied and the signals are received for the electrode bar. The screed 194 rotates periodically, or when the display requires refreshing. The technique is well suited to low cost displays, for example alarm clocks, meter readouts, and so forth. Text or graphics may be displayed in a horizontal orientation or following curve of the circle. It will be appreciated that when implementing clocks and meters, the display can be swept when the associated clock, or meter needs updating, and can activate both the readout portion, such as hands of a clock or meter, but the static portion as well, such as the units. In addition, the device can display text or graphics, such as notes, graphics, or other relevant items. In one mode of the invention a clocking circuit generates a drive signal to a motor to rotate screed section 194 one quick circular sweep around the display (i.e., taking less than 10 seconds and more preferably less than 1-5 seconds) which takes place every n seconds, for example every 30 second, or a minute.

The screed may also take the place of one of the hands of an analog clock, such a second hand or minute hand, wherein it can update the display in the course of its normal movement, or more preferably perform a quick sweep and return just ahead of its former location, therein fulfilling two purposes. Example, in a clock with hour and minute hand the minute hand is adapted as the screed. In response to a trigger, such as a periodic signal, or the receipt of updated data (i.e., stock changes, news and the like), the combination minute hand/screed makes a quick revolution, such as within 1-2 seconds (depending on size of clock and motors used) and returns to a position just ahead of where it left. A portion of the minute hand is preferably transparent or has an aperture wherein the user's view of the programmed portions of the display is not substantially hindered.

FIG. 14 illustrates an example embodiment of a circuit for driving the circular display of FIG. 13. The circle 192 is shown comprising a material 198 containing the embedded microcapsules which is overlayed by a substantially transparent conductive coating 200. The motor 196 is shown coupled to the electrode bar 194 and connected to a scan circuit 202. The scan circuit is shown connecting to a controller circuit, exemplified as a microcontroller 204. The combination of microcontroller 204 and scan circuit 202 are capable of driving the motor and electrode bar for writing the display. It will be appreciated that the motor 196 can comprise any of a variety of types. The motor can be made to sweep the screed continuously about the circle, or to periodically perform a more rapid sweep. A preferred method is to utilize a motor that is swept through a full circle when the data needs to be updated. The motor need not be accurately controlled, it is only necessary to sense its position at one point on the circle from which power is applied and removed. It should be noted that the use of this display allows for the display of text and/or graphics in line form or in circular patterns, while it can simultaneously display analog clock hands, or sufficient portions thereof, to support displaying simultaneously both time information as well as text and/or graphics.

Numerous mechanisms can be used for getting the data into the controller circuit. If the display is utilized for a clock, for example, the microcontroller 204 can maintain the time which may be set by external interface buttons. The display may be loaded with data in a variety of ways. A voice input section 206 is shown which comprises a microphone 208, a conditioning circuit 210, and an analog to digital converter 212 which is connected to a microcontroller capable of performing speech to text conversion, or additionally comprising a circuit containing DSP routines for performing speech to text conversion. A user can thereby give voice commands to the display, or enter notes that are then displayed on the circular display.

Alternate input is also shown by way of an optical link 214, typically infrared, comprising an optical receptor 216 (and optionally transmitter) coupled to a conditioning or modulation circuit 218 that is coupled to the microcontroller 204. The display can thereby be programmed by any form of optical remote control, PDA, cellular phone, and so forth. Additionally, an RF interface 220 is shown comprising an RF module 222 with antenna 224. A data connection 226 is also shown comprising a connection 228 and a level conversion circuit 230. The data connection can support connections to any form of digital output.

FIG. 15 exemplifies a cylindrical display embodiment 250 in which a cylinder whose outer surface 252 contains a layer of electronic ink microcapsules retained over a conductor. The cylinder has a central axis 254 and is driven by motor 256 and pinion gear 258 (or other form of actuating means) that are preferably connected to a control circuit similar to that shown in FIG. 14. An electrode bar 260 is shown spanning at least a portion of the cylinder 252 wherein under rotation it programs the electronic ink on the cylinder 252 into either an on or off state. Optional lighting 262 is shown within the cylinder for backlighting the text. It should be appreciated that the backlighting can highlight static sections of printing on material of cylinder 252, but not conventional forms of electronic ink. The inventor elsewhere describes a novel form of electronic ink which is particularly well suited for backlite applications.

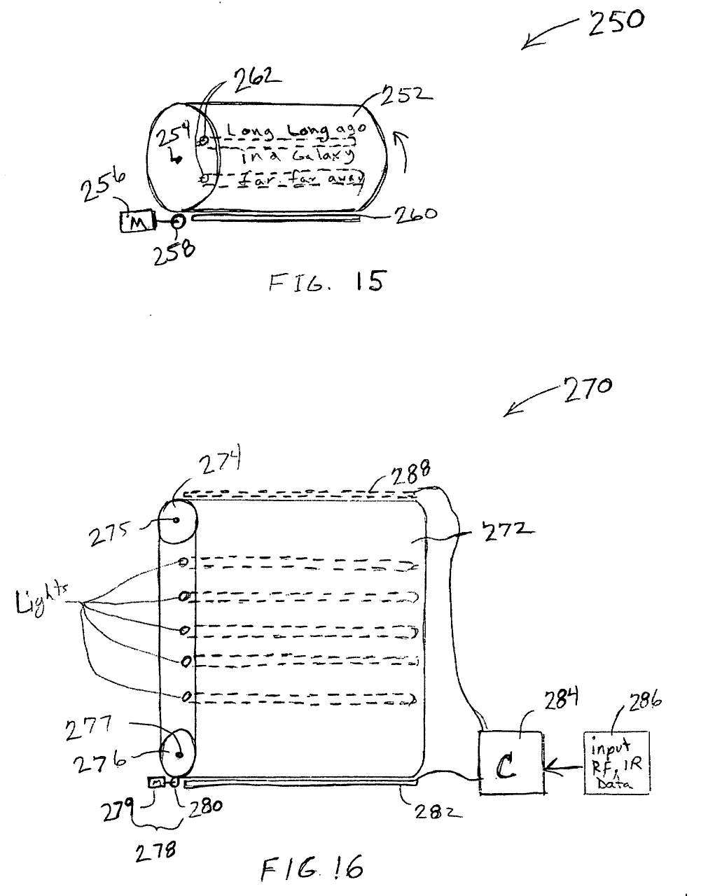

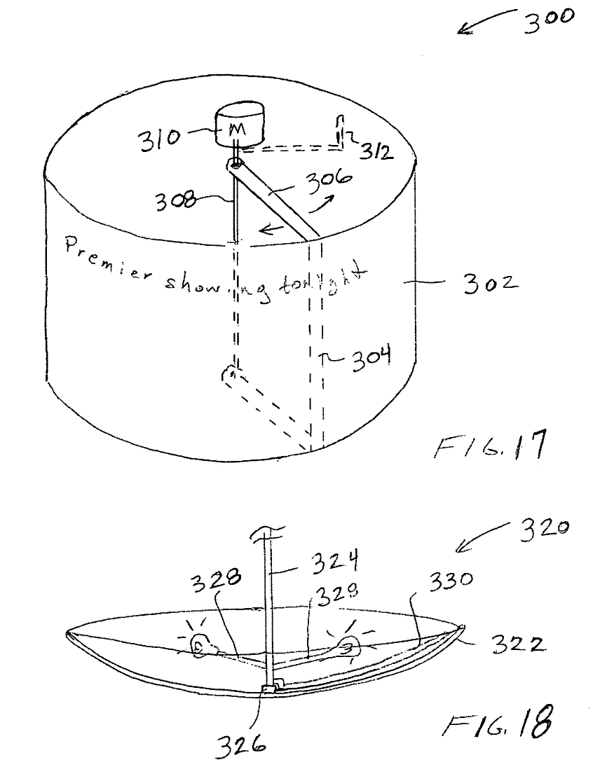

FIG. 16 exemplifies a continuous scroll 270 for displaying text and graphics. This form of display is economical and well suited to many applications, including billboard forms of advertising. A loop of material 272 contains electronic ink spheres adhered over at least portions of its surface. Loop 272 may have a conductive backing as the background electrode or with electrode positioned over a conductive cylinder can attain program voltages. A top cylinder 274 is shown with axle 275 and a lower cylinder 276 with axle 277 are utilized for providing the paper path.

The invention may be practiced with additional rollers to suit the application. A drive mechanism 278 moves the rollers and overlayed material. Numerous actuating means (e.g., motorized actuators, stepping motors, mechanisms, and so forth) may be utilized for driving the scroll, such as by way of example a motor 279 with a pinion gear/wheel 280. A screed section 282 provides a series of electrodes for generating electrical fields at pixels along the span. The screed section 282 is shown connected to a controller 284 and a display input system. It will be appreciated that a wide variety of inputs are contemplated for this display device. In the case of a roadside billboard, it should be appreciated that the input device, such as an RF or IR link allows the contents of the billboard to be changed on the fly, without the conventional needs for manually attaching strips of colored paper materials to a structure. It will be further appreciated that an additional screed section 288 may be added so that the opposing side of the display may be utilized, however, the downward scrolling may be undesirable for certain applications.

FIG. 17 exemplifies a stationary cylindrical display that utilizes a movable internal screed. The walls of the cylinder 302 contain electronic ink microcapsules with an exterior conductive layer. An electronic screed bar 304 is retained proximal to the material of the cylinder 302 and attached to a structure 306 for retention to an means for rotation, such as an axle 308, driven by motor 310 or manual crank 312. Scanning and controller are not shown, however, these can be provided in similar manner as those previously described. The pixels of the screed bar 304 are driven so that it generates electric fields in response to the data that is to be displayed. The text and/or graphic data is printed on the material as the screed moves about within the cylinder. A motorized control unit 310 allows the data to be updated rapidly, while a manual crank 312 is more suited to applications that rarely need to be changed. It will be appreciated that position sensors, switches, or stepper motors, are preferably used so that the control electronics determine the position of the screed as it generates pixelated electric fields under rotation. A display such as this is particularly well-suited for large area displays, for example theater signs or marquees and it may also be configured with internal lights to provide backlighting of the sign, although the conventional electronic ink does not have selective transparency in response to its programmed state. Inventor elsewhere describes a form of electronic ink which is particularly well suited for use with backlighting.

FIG. 18 is a semi static display 320 shown with a curved member 322 that contains a layer of electronic ink spheres and an external conductive layer (or matrix) attached back to the controller. The display is exemplified in a light fixture (although it can be implemented in a number of alternative embodiments) that is supported by a rod 324 connected to a pivot 326 attached to the curved member 322. The light fixture contains light sections 328 into which bulbs (e.g., fluorescent, incandescent, halogen, or more preferably LED-based) are attached. A screed 330 is attached to the central axial section such that the curved member may be rotated by hand while the screed section 330 is retained stationary whereby the screed is brought into contact with, or sufficiently proximal, the interior surface of the curved section for applying a programming voltage to the electronic ink spheres in combination with the opposing polarity of the conductive layer. The scan circuit, position sensing, and controller circuit are not shown for this display. It will be appreciated that such a display is capable of providing easily updated text and graphic messages through the curved section 322 which provides a diffuser for the light. This embodiment, and other embodiments described herein and elsewhere, can also be enhanced by utilizing the electronic ink described according to another aspect of the invention whose transparency changes in response to its programmed state.

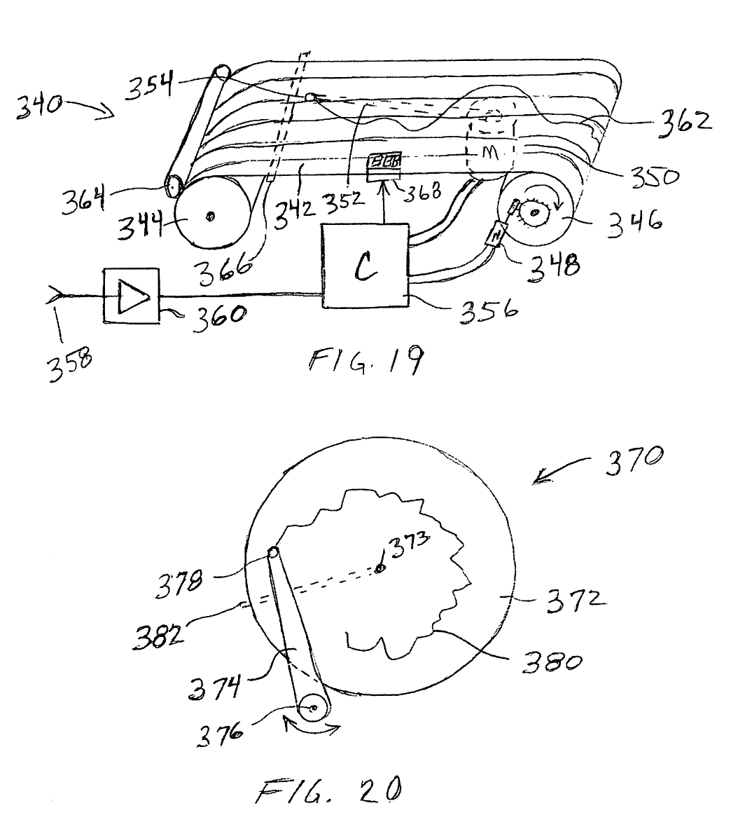

FIG. 19 and FIG. 20 illustrate forms of graph recording instruments which are capable of recording an input on a chart. Typically chart recorders are used for recoding various events such as seismological events, power transitions, and so forth. Currently these devices utilize an ink containing head apparatus that draws a line on a paper recording media that is metered off into lines and other graph backdrop mechanisms. The graph recording instruments shown can be used continuously without the need of replacing the graphing material on which the lines are shown. In one embodiment, the rolls are partially rewound for viewing any desired portion of the historical track, or fully rewound to start a new track. In one mode, the system retains the old track and only change the state of the electronic ink along the path of the screed to add a new track. In another mode the electronic ink can be set to a first state during rewinding, wherein the electronic ink along the path is set to a second state, as the trace is made. Still further an earlier track can be erased at a new track is being laid down.

FIG. 19 shows a scrolling graph recorder 340 wherein a material 342 containing electronic ink microspheres and graphing indicia such as lengthwise lines. A pair of rollers 344, 346 attached to a drive mechanism 348 provide for moving the material from one spool to the other. An arm actuator 350 moves an arm 352 containing an electrode 354. The electrode 354, the drive mechanism 348, and the arm actuator are controlled by a control circuit 356 which is responsive to an external input 358 through a conditioning circuit 360. The electrode is maintained at a voltage level opposite of the exterior face of the material as the arm actuator moves in response to the signal provided at 358, such that a line 362 is created on the material 342 which wraps on the spool 346. An optional roller 364 is shown for setting the conductive exterior of the material to a given potential so that the opposing electric field of the head can activate the material. An optional eraser bar 366 is shown that erases the material as it is being rewound on the spools, such that a new race may be made. It will be appreciated that an electrode screed, as shown in previous embodiments may be utilized instead of the actuated arm having a single electrode. It will be appreciated that utilizing a screed form of electrode head allows a simple mechanism of simultaneously recording multiple traces.

A stamp means 368, such as time stamping module, is illustrated which comprises a plurality of electrode regions, such as organized in a 7-segment numeric pattern, 15-segment alpha-numeric pattern, a graphic pattern of elements, a bar for generating bar coding, or any other desired pattern type to be programmed onto the electronic ink. Optical state programming voltages are applied by a controller between the electrodes within the stamp and the background electrode for setting the electronic ink to a desired state. In this embodiment the controller maintains a time and/or date value and periodically outputs this for printing on the chart, for example at intervals which depend on the charting rate (e.g., every 5 minutes, 15 minutes, 1 hour, and so forth). It should be appreciated that this aspect of the invention can be used with the other inventive aspects described herein.

FIG. 20 shows a circular trace graph 370, such as is often utilized for recording voltage level changes within a power grid over a 24 hour period. A material containing electronic ink 372 is shown centered for rotation about an axis 373. An actuating arm 374 is moved about a pivot 376 in response to an input signal to the device. The circular material is rotated at a fixed rate as dependent on the application, while an electrode 378 on the arm 374 is held at a different voltage level than the opposing surface of the material 372 such that an electric field is maintained between the electrode on one side of the material and the conductive surface on the other side of the material. The conductive surface may be provided by a conductive disk upon which the graph material is attached. A line 380 is shown that has been drawn on the electronic ink material by means of the electrode 378. An optional eraser bar 382 is shown which allows the trace to be quickly erased prior to commencing a new trace. The eraser bar, as in FIG. 19 retains an electric field across the material which is of opposite orientation than that used for recording the trace.

Semi-Static Display Device.

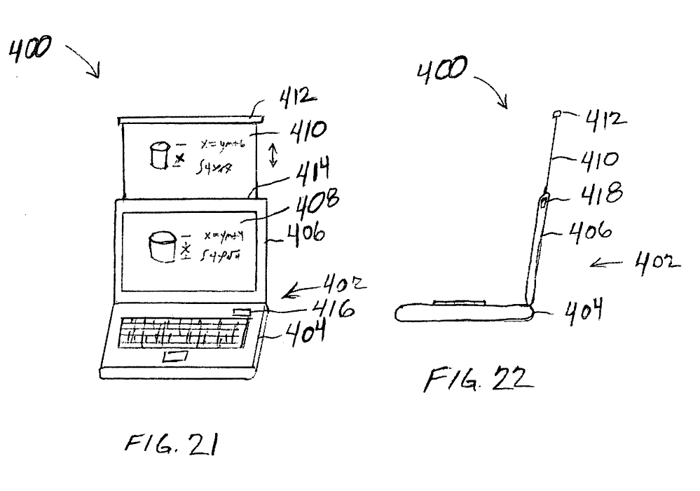

FIG. 21 and FIG. 22 depict an extending semi-static display 400, which by way of example is shown incorporated within a laptop computer as an auxiliary display means. The static screen means comprises a flexible or rigid panel containing electronic ink material. Often it is desirable to view one document in a static mode while editing another document; such as referring to a diagram while editing corresponding text.

FIG. 21 exemplifies a laptop computer 402 containing a base 404, and display 406 with active display area 408 onto which text and/or graphics may be displayed. A section of the device, laptop in the instance shown, is configured with a slot into which is received an electronic ink panel 410 containing electronic ink microspheres and a conductive layer. The example shown is preferably self-supporting wherein the panel is substantially rigid. An optional stiffener/handle 412 is shown to facilitate moving the panel in or out of the laptop display section 406. A button 416 is shown on the laptop computer that loads a display buffer with on-screen information in preparation for printing on the elnk display panel 410; after which the display panel is simply extended from the laptop and is written upon by an internal screed held within one side of the slot through which the panel is received. The software detects the press of button 416 and converts present screen data to a data format compatible with outputting on the electrodes of integral screed 418, and in synchronization with the rate at which the panel 410 is extended data is output on the screen electrodes in reference to the background voltage therein writing a copy of what is on the active screen 408 to the static screen. In one embodiment display 408 itself can be configured with integral electrodes for programming the electronic ink, either in a two dimensional pattern, or from a single line of electrodes onto the moving panel.

FIG. 22 illustrates a side view of the display panel 410 within the laptop 402, and shows the location of the internal screed 418 containing the electrodes for generating the electric field used for writing on the panel 410. To utilize the display panels the user upon needing to refer to a particular text of graphics material selects it on their screen, then presses the ewrite button 416 and extends the panel 410. As the panel is extended the graphics and text are written on it. The panel is preferably loosely constrained in the slot so that it may remain extended above the display of the laptop to provide the additional “static screen area”. It will be appreciated that other activation mechanism aside from a specific button may be utilized for triggering the buffering of the display contents for writing to the panel 410. Furthermore, the panels 410 may be made removable for other forms of attachment, or wherein multiple static items need to be referred to.

A preferred mechanism allows the display panels to be attached to the exterior sides of the display to extend it sidewardly with the static information. As in the previous examples, erasure can be performed on a panel by having the screed generate an opposite phase electric field as the panel is reinserted, or upon user activation of an erase feature coupled with movement across the panel. Alternatively, depending on the particular form of electronic ink utilized, the write operation can write portions of the display panel 410 to an active (such as dark pixels) while setting the remaining portions to a non-active state (such as light pixels), such that a specific erase procedure is not necessary. It will be recognized that non-rigid display panels may be printed by the screed section, and even relatively flexible sheets of material can be extended as a semi-static display, or sheets containing electronic ink may be hand fed through the slot to enable writing of static rewritable information thereon. It will be recognized that a motorized mechanism can be added proximal the slot for moving the panels and/or sheets of material in, out, or through the slot, however, this adds a measure of complexity and cost.

Input Tablet Devices using Electronic Ink.

FIG. 23 is an input tablet 450 such as used by graphic artists for inputting lines and brush strokes into a computer system. Typically, input tablets provide a mechanism for receiving input, such as by utilizing a force sensing matrix that is responsive to interaction with a stylus. However, in the present device additional benefits are inexpensively gained by having the device provide output in addition to registering user input. A housing 452 contains a writing surface 454 upon which the user can write using electric field stylus 456. An optional screed 458 may be utilized for certain embodiments of the device. The input tablet is connected by an interface cable 460 to a computer 462. It will be appreciated that the interface between the input tablet and computer may be of any available standard, for example, firewire, IEEE-1394, RS-232, and so forth. A couple of implementation versions are described.

A version which provides active updating can be constructed which utilizes embedded perpendicular grids and between the opposing grids is sandwiched a material containing elnk microcapsules. Substantially conventional electronic ink paper may be utilized as forms of it are provided with opposing grids to allow the setting of pixel regions at the crossing points where the grids overlap with appropriate signals. Used herein, the grid is connected to a driver circuit with programmable I/O pins that provide selective input and output and very high input impedance, such as I/O pins on certain microcontrollers manufactured by Microchip Incorporated™. The drivers on the grid lines vacillate between input and output modes.

While in an input mode they are set as high impedance inputs to register the electric field on the vertical and horizontal lines. Since the hand of the user itself is capable of acting as an antenna to couple an electric field to the input tablet, the electric field of the stylus 456 is preferably modulated, at a frequency that is not a multiple of the 60 Hz line frequency, or to assure distinction from other IF sources the electric field is modulated with a specific recognizable waveform pattern. Multiple input lines and output lines, depending on the pitch of the grid lines, may detect the electric field and the software determines the center for the line based on the center of the responsive area corresponding to the crossing in the grid associated with the received voltage pattern. It is preferable that the activation voltage of the electronic ink correspond with the detection potential of the grid lines, such that as the use writes with the stylus, the elnk capsules change state indicating the line being drawn, while the system also detects the new input to update the electronic version of the drawing, or writing.

The stylus used can be either wired or wireless, and it generates an electric field when pressed against the material. Preferably the stylus is configured with a force sensor and a control circuit which modulate the intensity of the electric field in response to the applied pressure and the selected simulated writing instrument, much as the depth of color and width of a pencil mark is determined by pressure, or the width and composition of a brush stroke changes with applied pressure.

The tablet toggles the I/O lines connected to the grid to output mode in order to drive the elnk spheres (capsules) to new states. In one embodiment the outputs are generated in quick bursts having a duration approximately equal to the maximum response time of the microcapsules, wherein the grid lines are utilized to drive an electric field in the conventional manner to change the state of the pixels. It will be appreciated that the grid can be driven in either polarity such that the pixels may be turned either on or off. Once set, the lines are quickly toggled back to input mode such that user inputs can be registered. A short simultaneous burst, such as one microsecond, of a single potential on all grid lines can be used to clear any stored charge on the input capacitance of the I/O drivers prior to switching back to input mode so that aliasing does not occur.

Certain forms of electronic ink may require that active elements be embedded below the pixels of elnk for activating the microcapsules. It will be appreciated that these active elements are to be configured with an input mode wherein a sensitivity to an electric field can be read through the addressing of the active elements.

The above active input tablet can be expanded to a large size as an electronic whiteboard whose contents can be collected by a computer.

Other non-grid forms of electric field detectors may be utilized within the input tablet. If the form of electric field detector utilized does not provide for driving the elnk, then a screed 458 is provided on the tablet to allow the erasing of the lines drawn by the stylus. In addition, the stylus itself is preferably configured with an “erasing” surface which generates an opposing polarity of electric field to erase the state of microcapsules back to their original, typically white state.

An otherwise conventional force input tablet can be augmented for semi static display by providing an electronic ink material overlay and changing the stylus. The electronic ink overlay has a conductive backing retained at a given, or selective potential. The stylus generates an electric field potential which is capable of driving the state of the electronic ink microcapsules. Preferably the electric field is generated in response to applied pressure, whereby the force tablet registers a particular force corresponding to a given brush width while the pixels of the electronic ink overlay are simultaneously being set to a given state in response to an electric field generated according to the same force.

FIG. 24 illustrates a simpler form of tablet which may be utilized as a reusable notepad 470. A notepad housing 472 retains a material containing electronic ink 474 with conductive surfaces overlaying the top and bottom to allow the electronic ink to be programmed by the stylus 478 or mass erased. The stylus may be wired 476 to a source of power, or have a self-contained power supply such as batteries. The stylus generates an electric field when the nib contacts the surface of the material. The electric field is in relation to the conductor retained below the material, such that nearby pixels of electronic ink are set into a visible state. An erase button 480 is optionally provided for erasing what has been written 482 on the surface of the tablet.

The upper conductor, or partial grid conductor is held in a floating state during stylus writes. The upper conductor may be left off, if the difficulties with electric field dispersion or the intents of the specific implementation warrant. The side of the stylus 478, or a separate erasure screed can be utilized for clearing the electronic ink on the tablet.

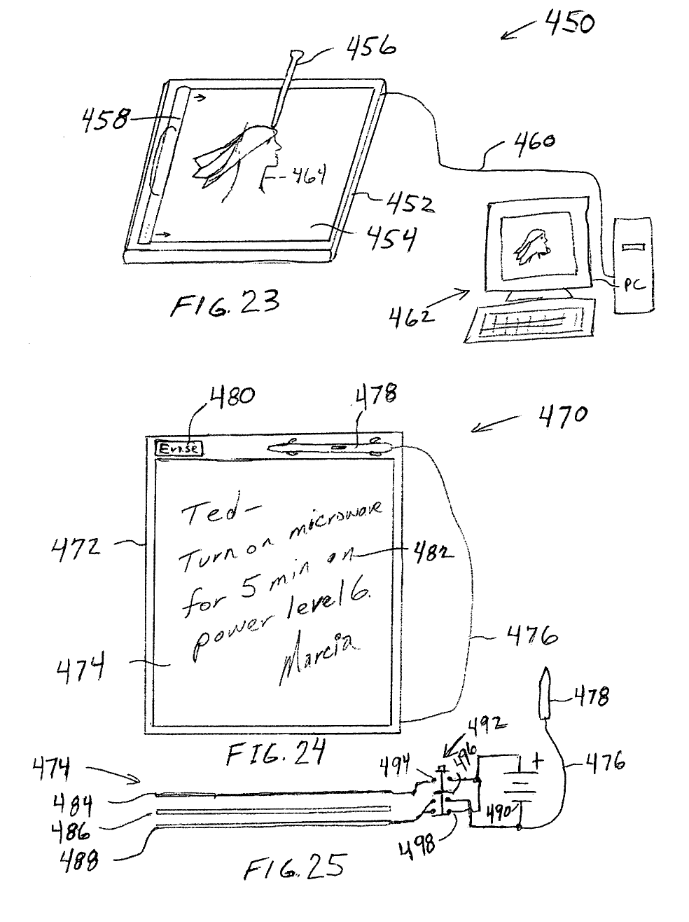

FIG. 25 is a schematic of the tablet of FIG. 24 having the material containing elnk 474 which is shown with three layers. A top conductive layer 484 that is preferably configured as a grid; a material layer 486 containing electronic ink; and a conductive backing layer 488, preferably a thick conductive layer. The stylus 478 is shown connected by a wire 476 to a battery 490. The battery is connected to a push-button triple throw switch 492 associated with the erase button 480. In normal mode the stylus 478 is capable of imposing a negative voltage in relation to the positive voltage of the conductive backing which is connected via closed contact 2098, such that setting of the electronic ink takes place. Pressing the button reverses the potential with the conductive backing, through contacts 2094, 2096 being set to a negative potential and the top being set to a positive potential thereby creating an electric field between the electrodes which reset the electronic ink to a non-written (such as white) state. In one embodiment, a full screen erase button is provided which sets the entire screen to a first or second optical state of the electronic ink layer. In one embodiment the opposing blunt tip and/or wide side of stylus 478 is configured with an electrode which is the reverse of the electrode voltage at the pointed writing tip of the stylus, wherein the user can erase portions as desired.

Self-Powered Electronic Ink Display.

FIG. 26 and FIG. 27 illustrate a display 500 which provides a display element while simultaneously generating power. Retained under an overlayed conductive membrane, or grid, are deposited pixels of electronic ink 502, or a sufficiently thin layer of electronic ink micro capsules so that light is capable of penetrating the layer, or around pixels areas on the membrane, over a membrane 503. Under the membrane are situated a photocell structure 506 (e.g., amorphous Si solar cell, polymeric photocell material or other photoresponsive materials) attached to a backing 504. Optionally, the photocell structure can be interspersed with active cells 508 containing drive transistors for controlling the state of the deposited electronic ink. The photocell regions 506 collect power for driving the active areas of the display such that external power sources are not required.

The display described above can also be implemented with all or portion of the display using a transparency controlled electronic ink, such as the embodiment described in another aspect of the invention.

Large-Area Optical State Programming Screed.

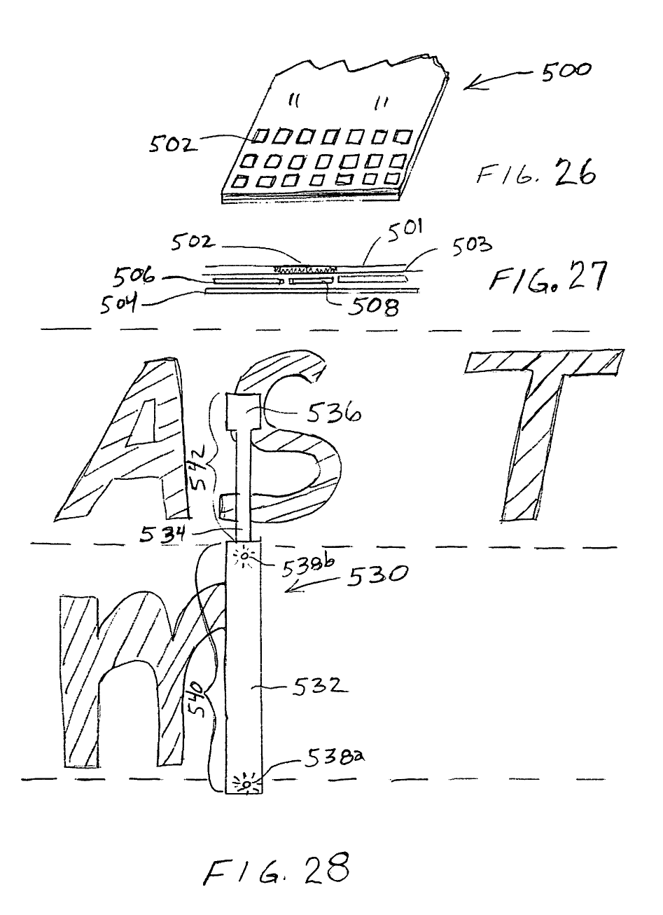

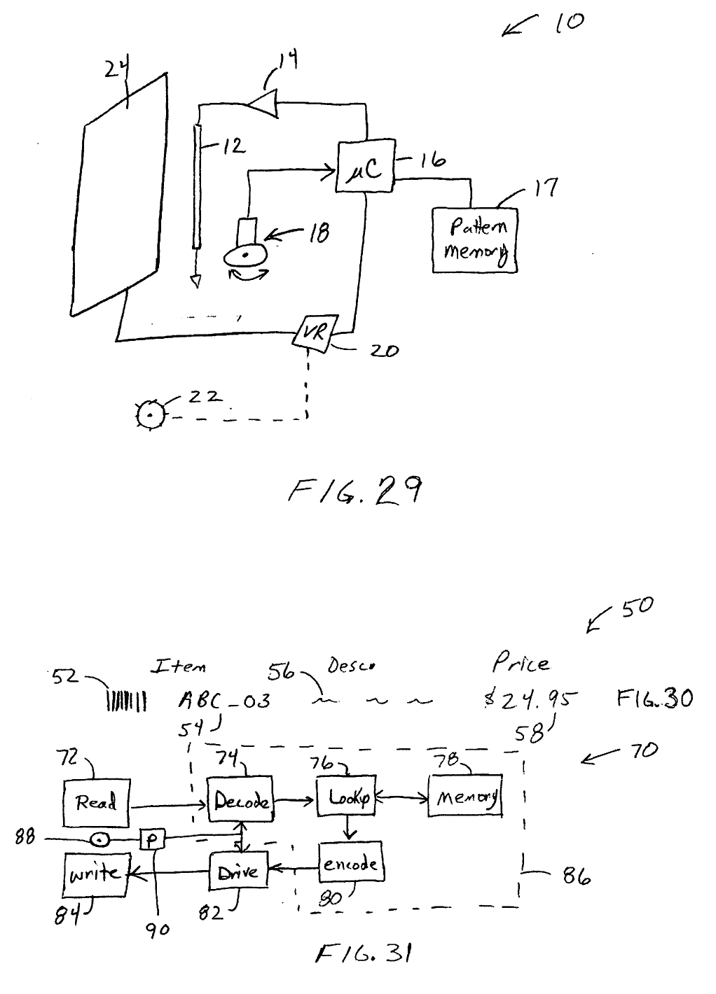

FIG. 28 illustrates a screed 530 for programming the optical state of large semi-static display areas that are covered with electronic ink. The screed 530 allows the elnk microcapsules within these large display areas to be programmed or erased following data programmed into or communicated with the screed. This screed device is similar in construction to that described in FIG. 1-3, 12, 14 and elsewhere in the application, however it has been adapted for use over a wide area, such as billboards, sides of buildings, sides of vehicles (in particular big rig trailers, vans, trucks) and so forth. The screed has a main body portion 532 with neck 534 and a head 536. In one embodiment (shown) the neck 534 is extendable, although it may be set in one or more fixed positions.

In one embodiment screed 530 incorporates a movement annunciation means configured to alert the user as to how to properly move the screed, and/or to indicate when it is not being moved properly as regard to direction, speed, and location. According to one simple example embodiment lights 538a, 538b are configured for indicating when the proper orientation of the screed is being retained. The lights are coupled to an orientation sensor whereby for horizontal use both lights are active if the screed is at the proper position and speed. A single light going out indicates that the corresponding end of screed 530 has not kept up with the other side of the screed. If both lights extinguish then the screed is being moved too slowly. In a more complex movement indicator, direction arrows can be provided about a center indicator, wherein both the direction and rate of motion can be indicated to the user by changing the direction and length of the displayed arrows. It will be appreciated that other forms of annunciating screen motion may be incorporated without departing from the teachings of the present invention.

In another aspect of the invention the screed is configured to provide a wide area synchronization means. The lower section of the screed is configured with electrodes, as previously described, for programming the elnk to an active or erased state. In one embodiment the synchronization means is embodied with upper portion 542 incorporating a set of detectors for registering the on/off state of the adjacent display area such that the position of the screed 530 in relation to the prior lines of programmed output may be determined and synchronized. The screed, as described previously is configured with a motion sensing mechanism, such as rollers, so that screed speed may also be registered. The wireless screed 530 is configured with an RF section so that text and images can be downloaded for printing on a conductive surface over which electronic ink material, or microcapsules have been overlayed. Screed 530 allows the large areas to be seamlessly programmed or erased by a single operator.

Accordingly, it will be seen that this aspect of the present invention provides a method for creating low cost reprogrammable display and labels.

Reprogrammable Printing on Bar Coded Tags.

It is often necessary to print new barcodes for different applications, or to update printed information as new pricing or other information changes, such as on shelf tags.

A few aspects of electronic ink reprogrammable printing are described. The first being the printing of bar codes on electronic ink labels. Wherein the configuration of a simple programming device is described.

The printer need only have a single electrode to generate the bar codes, the unit can sense motion across the label using mechanical sensors, optical mouse type sensing (high rate image comparison). Labels may have buried electrodes allowing the bar codes to be programmed automatically. The elements of the label can be programmed simultaneously, without the need to traverse (move) across the label. For example a set of electrode bars or a dot style of coding (such as used on packages delivered by United Parcel Service), can be programmed in response to a two dimensional low resolution array. Furthermore, even small text or graphics patterns can be programmed using simultaneous programming from a two dimensional electrode array.

Secondly, a method and system is described for updating the printed elements associated with a specific identifier, such as represented by a bar code. For example, wherein an electronic ink printing device contains a reader means, such as for reading a bar code. The identifier is read and used to determine which content is to be written to the electronic ink, and as the unit is moved over the area to be printed, the appropriate text and/or graphics is printed on the electronic ink.

Well suited for information that is subject to periodic change, such as for example client information sheets, patient information sheets, pricing, price lists, menu items, and other displayed information which changes periodically but not generally enough to warrant display on a dynamic display screen.

By way of example the device can comprise a reprogramming device which reads an identifier from the label, such as a Client Number, UPC, or other record identifier (such as preprogrammed), annunciates when it has looked up information associated with that identifier (such as locally or via a communication with a server, for instance a wireless communication), and then reprints information on the reprogrammable information element. The information element may be made reprogrammable using electronic ink and providing a first electrode coupled to a first side of the information element, and a programming device with electrodes for applying programming voltages to a second side of the information element.

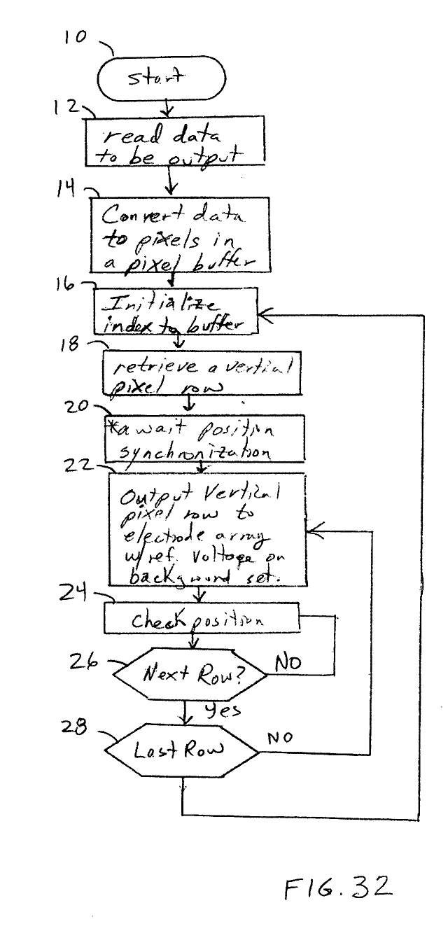

FIG. 29 depicts a printer head 10 for printing/reprinting bar codes printed on items having a layer of electronic ink and a conductive background electrode. A single electrode element 12 is shown of a sufficient width to span the desired width of the bar code to be output. The voltage on element 12 is driven by driver 14 controlled by a microcontroller 16, or other computer element, in conjunction with a pattern memory store 17. A means 18 for sensing motion of electrode element 12 over a surface is shown as a mechanical wheel with attached encoder, although optical methods may be utilized such as utilized within optical mice over any surface, or other means of detecting motion of a head in at least one direction. The background electrode 22, 24 is shown being set to a desired voltage, such as from a reference source 20 controlled by computer 16, in relation to electrode element 12, so that the electrode 12 output voltage can swing both positively and negatively in relation to the background to allow for setting or erasing of the electronic ink. Background electrode 22 is shown with a wheel having a conductive exterior for making an electrical connection with a conductive layer of material within an electronic ink label to be printed. Background electrode 24 is shown for being placed behind a thin sheet of material containing electronic ink, which need not have an integrated conductive layer.

FIG. 30 depicts an example of identifier based reprinting 50 wherein an identifier (preferably non rewritable) is associated with a rewritable area, such as of electronic ink. In this example a bar code identifier 52 is shown with reprogrammable text regions having an item number 54, description 56, and price 58. The bar code is read (i.e. LED light output with photodiode pickup) in preparation for overwriting the text (and/or graphics) with new electronic ink programming. It should be appreciated that the identifier may be provided in any desired form, and/or location. The following is provided by way of example only. Visible identifiers adjacent reprogrammable areas, on opposing sides of sheet, on a heading or footing, supplied as page identifier coupled with separate section/line identifiers to narrow down area being written. Furthermore the identifier may not be visible to humans, such as an identifier written in UV sensitive inks, magnetic strips, or other forms of non-visible configurations. A number of reprogrammable documents may utilize this form of updating, such as menus, product lists, product shelf pricing tags, and so forth.

One of the applications that is well suited to this technology is that of product shelf tags which typically contain both a bar code indicia along with product information comprising a code, name, description and price. It will be appreciated that the prices are often subject to change. Installing electronic shelf tags is expensive, The present invention allows the shelf tag to be written with a fixed UPC bar code and a section of electronic ink. A wand, preferably containing a set of update data, entire database, or which communicates with a database, is wanded over the tag reads the UPC looks up the associated data and then writes the updated information over the elnk area on the shelf tag.

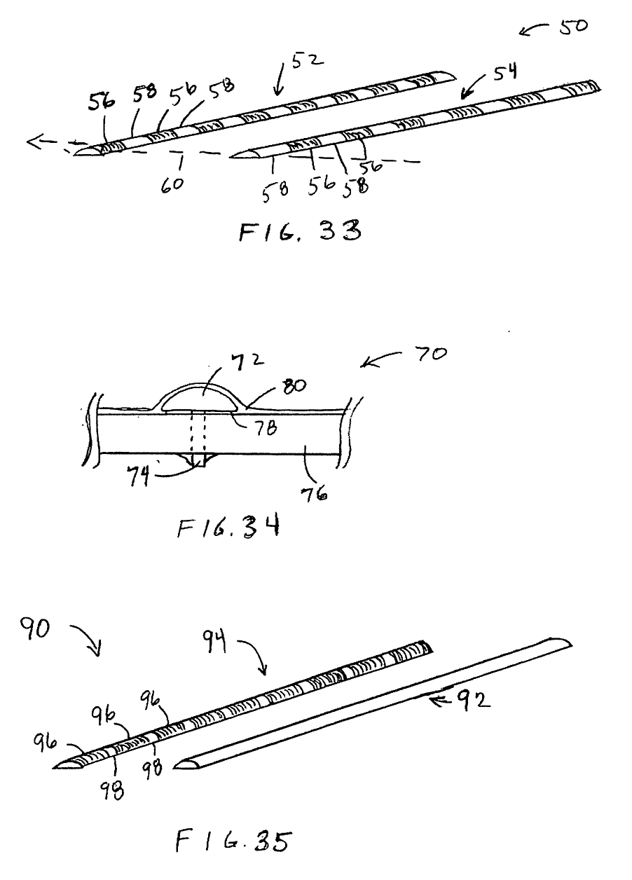

FIG. 31 depicts a block diagram of a system for implementing this elnk writing based on reading the identifier. A reader 72 allows reading the bar code or other form of coding for the identifier. The data is decoded by a decoding means 74 and a lookup means 76 finds the associated updated text and/or graphics from a memory store 78. The looked up data is then encoded by encoding means 80 and output through a driver 82 to a write head 84 configured for programming the electronic ink or other static display element with the data read from memory. Preferably, the means for decoding, looking up, storing information, and encoding retrieved information is implemented as a microcontroller or microprocessor 86. Optionally, a motion sensing element 88 is shown with a position signal generating circuit 90 which aids in the decoding of the identifier and the proper driving of the output.

Electrode Bars and Other Display Enhancements.

This aspect of the invention describes what are referred to herein as integrated electronic ink electrode bars which provide a simple interface for driving the programming of electronic ink displays being programmed in response to moving the electrode bar over the electronic ink. The integrated electrode bars can be fabricated in a number of ways according to the invention.

The invention also describes a method of utilizing electronic ink electrodes as input devices in combination with their use for programming the electronic ink. The input function can allow for instance registering user touch inputs. The input function can be utilized with electrode bars made according to other inventive aspects by the same inventor, or with the electrode bar described herein.

SW for Creating Elnk Drive Signals.

The present aspect of the invention describes software for converting images etc. into electrode patterns for operating a scrolling display, such as display scroll loop, circular display, wide area screed programmer, a scrolling display or intermittent programmed display, each of these subject to being programmed from single of multiple linear arrays of programming electrodes coupled to the system.

FIG. 32 depicts programming a static display, preferably containing electronic ink, in response to data retrieved from a data base or other source of textual and/or graphic information. The program starts executing at block 10 and reads the data to be output at block 12, the data may be in any desired format. At block 14 the data is converted to a pixel format compatible with the electronic ink, such as binary pixel format, and buffered with pixels from vertical rows being buffered in adjacent memory locations. Although the data may be buffered conventionally, this requires that the bits be collected via an indexing mechanism prior to output. The data being buffered is cut, filled, expanded or shrunk as necessary to fit the number of pixels in the electrode array. Further, the number of vertical rows of data is configured to match the number of rows in the display being output to. An index is initialized at block 16 to the start of the buffer for retrieving sequential vertical rows from the buffer, and a vertical pixel row is retrieved in preparation for output at block 18. The software waits for the arrival of an optional periodic index mark at block 20, such as once per revolution of a drum display or other rotating display. It should be appreciated however, that in some displays there is no need for synchronization to a fixed output location. A vertical row is output at block 22 to the electrode array while the background is maintained at a proper reference voltage. The position of the display is checked at block 24, and it the next row has not yet arrived as per block 26, as sensed by display motion sensors, then a series of checks is performed until that position arrives. Alternatively, the rows can be triggered by an interrupt which is connected to a position sensor for registering the movement and/or position of the movable display. A check is performed at block 28 to determine if the last row the display has been output, wherein the index into the buffer is reloaded to the start of the buffer.

Electrode Bars for Modulating the State of Electronic Ink.

Electrode bars for use with moving electronic ink displays. A series of conductive electrodes are placed in close proximity and preferably covered with a thin layer of Teflon, UHMWPE or similar material slippery abrasive resistant surface to protect the electrodes and reduce friction and prevent any chance of scratching the surface over which the electrode will be proximal to or retained against. Preferably make electrodes as raised protrusions having a curved surface. Preferably a laminate with alternating conductor and insulator (spacing?? i.e. 25% conductor—75% conductor—preferably about 50% conductor) preferably a serial interface chip on a PCB having the electrodes).

FIGS. 33 and 34 illustrate example electrode bars. In FIG. 33 an electrode configuration 50 is shown with two staggered electrode bars 52, 54 with active electrode sections 56 alternating with non-active sections 58. The use of two separate staggered electrode bars allows programming all areas of the electronic ink to a desired state without missing even thin regions. It will be appreciated that a single electrode bar would be subject to not programming the small non-conductive areas between each electrode. The present configuration leaves no areas unprogrammed.

In utilizing the dual bar electrode array, it will be appreciated that in order for the outputs to be synchronized with the desired output pattern, the modulation of one bar will occur a select time before the other. The pixel buffer may configured with separate areas for output to each electrode array, wherein output is generated to the first electrode and then data collected for output to the second, and after a selected time, or in response to position information from the display, output is generated to the second electrode array.

FIG. 33 depicts a dual bar electrode array 50 having a first electrode array 52 and second electrode array 54. Each array comprising alternating sections of electrodes 56 and non-active areas 58. It should be recognized that any number of active electrode segments may be incorporated in each array, such as into the tens, hundreds, or even thousands of electrodes along the segmented array of electrodes. The electrodes on the electrode arrays are arranged in an offset configuration in relation to the motion of the electrodes over the display, or similarly the display over the electrodes. A path of travel is seen 60, passing through a non-active electrode 58 and then past an active electrode 56. In this way the entire width of the electronic ink area is spanned by electrodes, wherein it may be written or erased properly.

FIG. 34 depicts a cutaway view 70 of an electrode bar attached to a printed circuit board or other material to which electrical connections are established. An electrode 72 can be through-hole mounted 74 on a PCB 76, or surface mounted 78. The electrode bar is preferably covered by a slick abrasion-resistant coating 80, which smoothes the contours, prevents marking of the surface, and protects the electrode from dirt and moisture.

FIG. 35 illustrates another dual bar electrode array 90 in which a first electrode bar 92 comprises one long electrode which is utilized for erasing the entire area and a second electrode 94 is configured with a plurality of pixels 96 for printing pixels associated with text or graphics, and small inactive areas 98 between pixels. Although only nine electrode sections are shown in FIG. 4, it should be appreciated that any number may be incorporated such as into the tens, hundreds, or even thousands of electrodes along the segmented array of electrodes. An advantage of this arrangement is that the pixels writing is performed simultaneously on the single bar instead of with staggered timing across two pixel bars. In addition this arrangement is more forgiving insofar as the traversal path may vary from one sweep to the next without leaving any artifacts whatsoever between electrode paths, as the path is erased each time by the first electrode bar 92 before being written over by the second electrode bar 94.

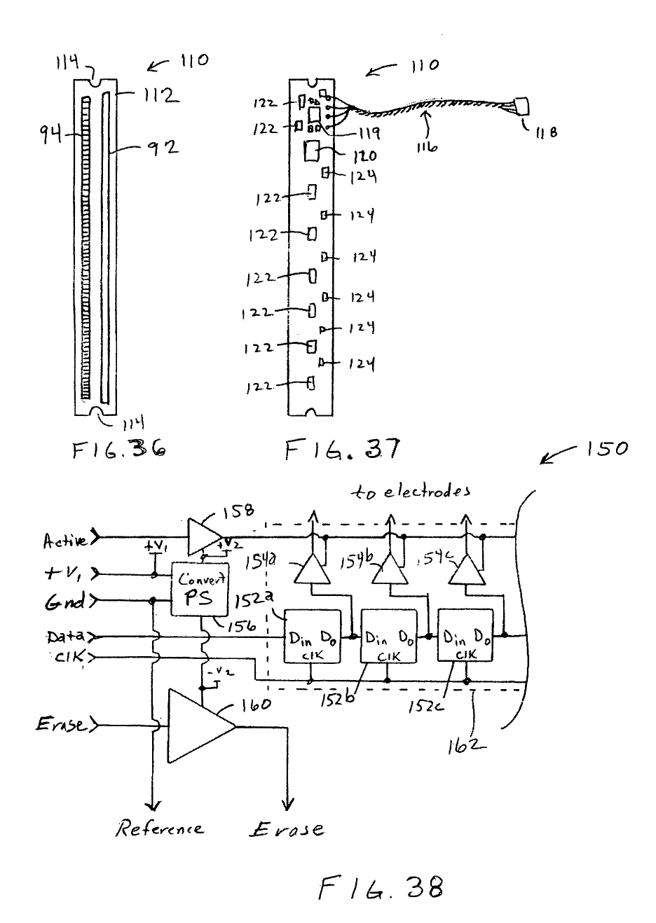

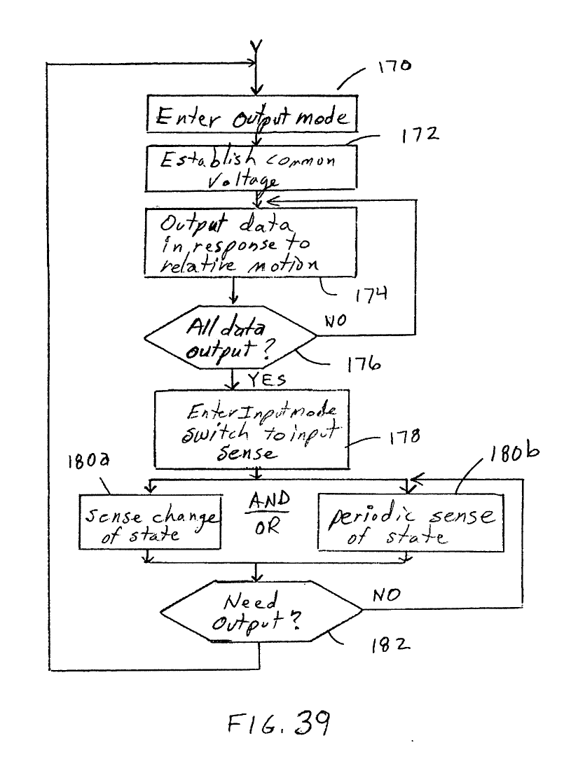

FIG. 36 and FIG. 37 depict electrode heads similar to that of FIG. 35 incorporated within an electrode module 110 according to the present invention. FIG. 36 depicts the electrode side of the module, in which a printed circuit board 112 forms the base of the module, the module being configured for mounting, for example via mounting cutouts 114. Longer electrode modules are preferable configured with mounting locations along their length, such as periodically placed mounting holes along the length to sufficiently secure the module for maintaining the desired distance from the surface being programmed.

FIG. 37 depicts the circuit side of electrode module 110 with an optional connection pigtail 116 having a connector 118. An optional on-board power supply circuit 119 is preferably provided wherein the hosting device need not provide its own set of voltages for the background reference voltage and the voltages needed in relation to the reference voltage to drive the electronic ink to at least a first and second state. The connection is preferably a serial connection to reduce the number of interface lines to electronic ink electrode module 110. Electronic components are shown mounted to the surface of the board, such as in a dice mount, surface mount, flip-chip, or any other conventional mounting configurations. By way of example the circuits shown comprise a controller 120 and latching shift registers 122 distributed along the length whose outputs are coupled to each of the electrodes within electrode bar 94. Bypass capacitors 124 are shown distributed along the length of the electrode module 110 to reduce power fluctuations and noise transients.

FIG. 38 illustrates an example 150 of a drive circuit without a controller. The circuit preferably receives power and ground along with serial data and a clocking signal. A shift register is formed, such as with a series of D flip-flops 152a-152n (n depending on the number of electrodes to be driven). The outputs from the flip-flops are buffered by output stages 154a-154n. Preferably the serial shifting elements and the buffered output stages are integrated within an integrated circuit 160 configured to drive a number of electrode outputs, (i.e. 8, 10, 12, 16, 32, 50, 64, etc.), as represented by the dotted lines surrounding a series of stages. It will be appreciated that the serial data applied to the data input will be shifted along the series of shift registers in response to clock transitions.

Thereby if a series of 100 stages are used then the data is setup and clocked 100 times to propagate a new setting through the flip flops in preparation for output. Once loaded the output buffers are activated to drive the pixels programming them into an ON state (or reverse video off state).

The circuit is shown having its own power supply 156 for establishing the proper drive voltages for driving the states of the electronic ink, this reduces the constraints on the host system, which only need to generate conventional level signals, such as from a microcontroller. Power supply 156 in this case utilizes ground as the backplane reference voltage (prevents any chance of shorting out as typically the housing and other elements of an electronic unit are retained at ground potential. Therefore, setting the electronic ink (or similar technology providing a static output of display elements in response to the application of a sufficient voltage field) to a first and second state requires applying a voltage to the electrode which is at a first voltage (+V₂) to reach a first state, and a second voltage (−V₂) to reach a second state. It should also be appreciated that the voltages required to reach said first and second state could be skewed wherein reaching one state may require a different absolute voltage than reaching the opposing state. In the circuit shown the data latches operate from the originating supply voltage and the outputs are translated in the buffer stages 154a-154n, which are driven to the output voltage in response to the active signal that supplies +V₂ to the output stage of the buffers. In similar manner a voltage of −V₂ is output to the erase electrode in response to the erase signal. The reference voltage output is shown for driving the electronic ink reference plane.

Electrode module 110 may also be adapted with a number of other optional features. Output latches may be incorporated between outputs of the flip flops 152 and the inputs of the buffers 156. The latches would be preferably driven by the active signal after all bits were loaded into the shift register. This arrangement would allow the electrode outputs to be active while new data is being loaded for into the shift register, therein reducing the reliance on the processor to rapidly send a serial string between pixels during a string.

To support a reverse video output, the voltages output by the output stages to the segmented electrodes and to the erase electrode can be swapped in response to another input signal, such as reverse (not shown). For example each output may have both a +V₂ driver and a −V₂ driver side, wherein a first state of the reverse signal selects a first polarity for the segmented electrodes and the opposing voltage for the reverse electrode, while a second state selects the opposite voltage selection.

A microcontroller may be integrated with the module, although for supporting a large number of segmented electrode outputs, the shift register-buffer elements are still preferably included. It should be appreciated that incorporating a simple microcontroller within the electrode module (as in FIG. 38) can provide some additional advantages, such as the following, which may be implemented separately or in combinations thereof. (1) Allows simplifying the serial interface, wherein two or three wires are all that is needed to supply power and serial communications. (2) Provides two-way communications between the module controller and an external controller. (3) Provides for buffering up pixel data from the host, wherein the host is then even more loosely coupled to the module. To buffer the data in the module, the module then must be configured for determining the output timing or registering position information of the electrodes over the surface being programmed.

As mentioned above motion detection can be integrated within electrode bar module 110, or a separate position detection module provided for the given form of display being supported. It will be appreciated that binary detectors (i.e. optical, magnetic sensors, Hall effect, electrical contact sensors, and so forth) may be utilized for detecting markers on a display material for synchronizing the output of the vertical rows. The movement of the electrodes in relation to the display material containing the elnk may be sufficiently constant to allow the segmented bar to be driven in response to timing, for example outputting new data to the electrode module at a fixed rate (i.e. 1 row/10 mS). Motion may also be detected with rolling sensors (i.e. having potentiometer feedback elements, optical feedback, switch encoder feedback, or other form of position detection.). Alternatively, optical imaging techniques may be utilized, such as currently utilized within optical mouse devices that sense the motion of a material in relation to he device. In any of these instances the electrode module can be implemented as a largely self-contained module that only relies on receiving data associated with text and/or graphics to be displayed.

Method for Programming elnk and Collecting User Input.

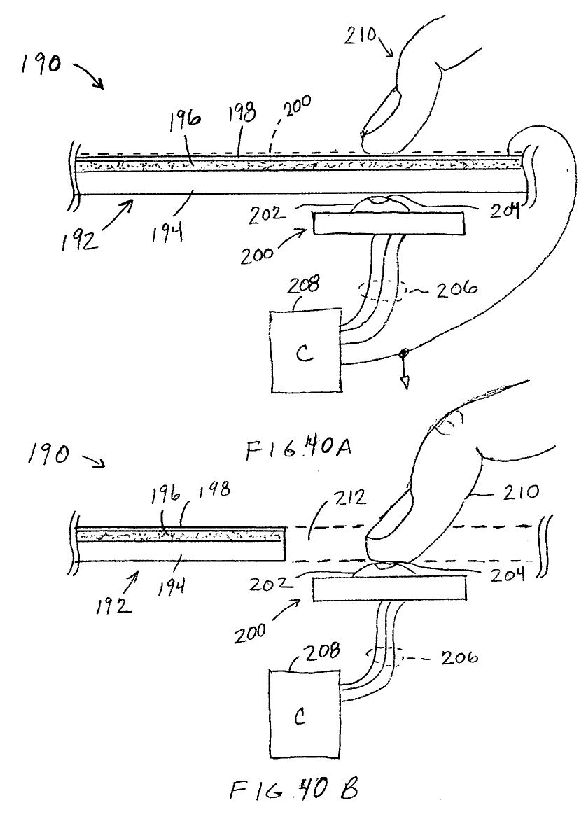

FIG. 39 illustrates by way of example a method of using a plurality of electrodes for both programming the state of electronic ink, as well as for registering user input. The inventor has appreciated that in the semi-static electronic ink programming being described, that the electrodes are only intermittently utilized, wherein they can be utilized to provide a sophisticated user input device along a single dimension or spread across two dimensions.

In this example programming is considered to be executing within a controller attached to the electrodes for programming the state of the electronic ink. The electrodes are moved in over the electronic ink display area, or the electronic ink display area is moved over the electrodes, or a combination of the two.

Represented by block 170 the output mode is entered by the system, wherein at block 172 a common voltage is established on the common electrode. The output mode can be entered in response to user input, detection of motion of the electrodes and/or electronic ink layer, programmatically, or otherwise. However, it will be appreciated that output can not be produced unless relative motion between display and electrodes is occurring. In block 174 the data is being output as voltages on the electrodes in relation to the common voltage for programming the state of the electronic ink. The data output is synchronized with the relative motion so that pixels are properly programmed and not unduly in response to incorrect motion information. The outputting of data continues until all data has been output, the full motion has been reached, the end of a movement cycle or programming cycle has been detected, or condition for terminating output to the display as detected by block 176.

If output is completed, at least temporarily, then an input mode is entered at block 178. If an integrated electrode bar is being utilized, such as described above, then the mode of that device may need to be changed to input. Furthermore, depending on how the inputs are to be sensed (i.e. conductance, capacitance, inductance, AC-coupled (radio-frequency), electric field changes, and so forth), other changes may need to be made, such as changing the voltage on the common electrode, or applying a alternating signal on the common electrode, erasure electrode, or other element. Additionally, the inputs may be sensed directly, or in response to conveying of another signal. For example, a signal (i.e. oscillating signal) can be output on the common electrode, a separate single electrode bar, or on alternating electrodes not being used for input, wherein the signal is coupled from the output to the input. Many of the modes of sensing can be performed through small thicknesses of material, such as RF, capacitive, inductive, and electric field and so forth.

When established in input mode the input can be sensed in response to changes in state as depicted by block 180a, and/or based on periodic sensing as depicted by block 180b. The input data is preferably interpreted by the processing element, such as to determine what the input means in a given context. It will be appreciated that the input can span a number of electrodes (although not all of the output electrodes need be involved in the input process), and may comprise a motion across the input wherein the controller needs to interpret the motion and contact data relative to the current context of the device, such as depending on what menu or other user input selection is provided. These electrode inputs can be additionally, or alternately, utilized for sensing other environment conditions. The inputs can also be adapted to provide input sensing other than provided by strictly electrodes, such as coupling signals to the electrodes when they are in input mode, although this is more complex and generally less preferable.

Finally, when the display needs to be updated, such as in response to motion of the display or electrode, as sensed by block 182, then the programming causes a switch back to output mode.

Electrode Bar Configured Also as User Input.

FIGS. 40A and 40B illustrate example embodiments 190 of utilizing the plurality of electrodes which are scanned over an electronic ink field in an input mode. In FIG. 9A the input sensing is performed through the material of the display, wherein in FIG. 9B the sensing is performed in voids or apertures in the display material.

An electronic ink display material 192 is shown with a base layer 194, electronic ink sphere layer 196, a transparent common electrode 198, and an optional insulator 200 covering the transparent electrode. Conductor of electrode 198 may be deposited on a face of an insulator directed toward the electronic ink layer 196. An electrode 200, or more preferably the side view of an array of programming electrodes 200, is shown with optional smooth raised base and electrode tip 206 for assuring retention at a fixed distance from the eink layer. It should be noted that the material passing over a flat surface is more subject to separating from that surface and changing the distance between electrode and eink particles, although this is not generally very critical if the movement away from the electrode, or electrode array is sufficiently constrained so that sufficient programming voltage is provided.

Electrodes 204 may be integrated within an electrode bar, which can contain additional circuits for driving and interfacing, and preferably a serial interface, such as represented by three wire connection 206 to a processing element 208, such as a microcontroller. Alternatively, connections may be provided to each separate electrode, or to drive circuit for inputs and outputs of each electrode. It will be appreciated, however, that the integrated electrode bar, as described herein provides a readily implemented solution for both directing output and collecting input.

In FIG. 9A an input 210, depicted as user finger input, is shown being received over the display adjacent the electrode(s) in an input mode. The input can be sensed, such as capacitively, inductively, by the induced RF, change in the electrical field, and so forth. For example the input threshold may comprise a very high impedance (−10 MOhm) having a capacitance that stabilizes the signal and stores charge in response to user input as shown by finger 210.

In FIG. 40B the input is shown being directed on the electrode through a void or aperture 212 in display material 192. In this way even resistive sensing can be utilized between the electrodes.

It will be appreciated that a legend may be printed on the electronic ink over (FIG. 40A) or adjacent (FIG. 40B) the contact points for accepting user input. In this way the menuing can change with every display change while input collected when the display is not being updated. Alternatively, or additionally, permanent marks in the material may be utilized for marking the locations for input.

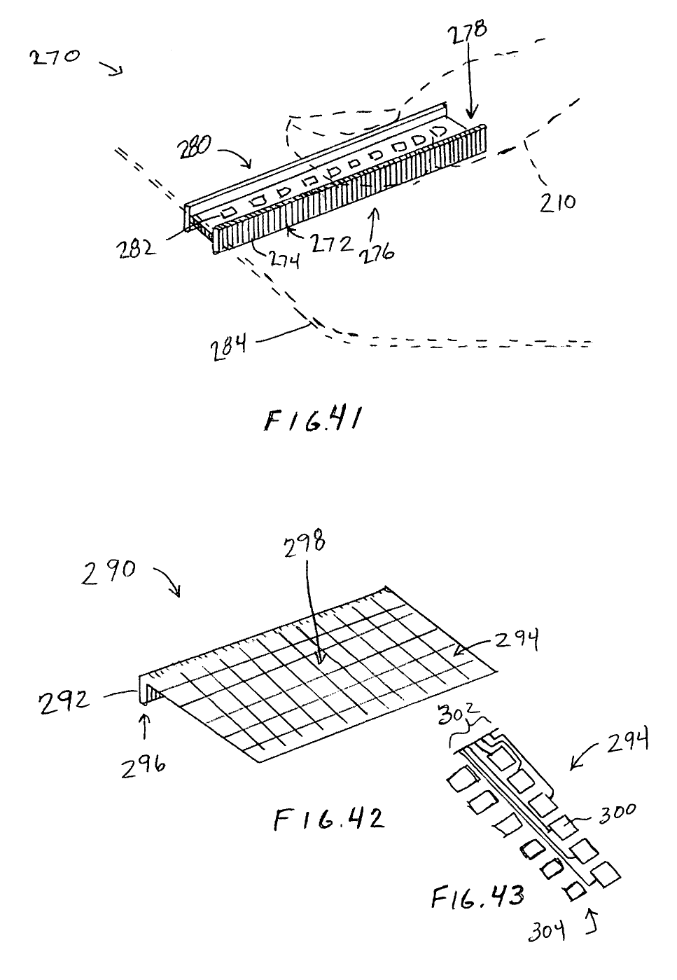

FIG. 41 illustrates by way of example another embodiment 270 in which the eink programming electrodes are configured with a programming surface and an input sensing surface. A first plurality of electrodes 272 is shown, such as in a linear array with a insulators between each electrode 274. A programming surface 276 (i.e. shown on the underside) is provided and a input sensing surface 278 (i.e. shown on the top-side). The input sensing portion is shown protruding through a housing 284, providing input access. A finger 210 is seen in phantom whose presence and position on the plurality of electrodes can be sensed when the electrodes are configured in an input mode.

Circuits can be added to FIG. 38 for detecting input which crosses a threshold which can be sensed by the connected circuit. In one embodiment these threshold detection circuits (i.e. logic inputs, differential amplifiers, comparators, etc.) can be coupled to another string of flip flops, which are loaded in response to an external trigger (periodic sensing) or triggered into a state by the threshold crossing (change of state sensing). User input data can then be read from the string of flip-flops using the serial interface with an input mode selected. This aspect of the invention provides a number of benefits with regard to lowering parts count, costs and the like. The inventive teachings are the only ones known to have recognized that the programming electrodes can serve double duty by being configured to also sense inputs. This is particularly attractive because the display being driven is preferably semi-static, wherein the input mode does not detract from achieving high update rates as needed for full-motion video and the like.

It will be appreciated that the number of input electrodes can be reduced from the number of programming electrode as the resolution needed for input is typically much less than required for output. For example reasonable text and graphics output is typically output on a small display with between about 16 to 300 pixels per inch, while a finger input selector may need only about 1-4 contacts per inch, although more can be utilized for collecting sliding user input. For example every nth electrode can be extended to provide the input, simplifying the processing of the inputs, and reducing the circuitry necessary for processing the inputs.

This embodiment is shown with an optional erasure bar 280, which in this embodiment has a first surface for erasing sections of the display and a second surface for detecting the presence of a user input, and alternatively for conditioning the user input, for example for outputting an AC signal which is coupled from the erasure bar 280 to the input electrodes 272.

Interface circuitry 282 can be integrated to form a combination output and input electrode bar circuit, therein allowing OEMs to quickly implement new electronic ink embodiments.

It should also be appreciated, that the electrodes may be grouped wherein some are set in an input modes while others are set in an input mode. This mechanism can provide specialty functionality.

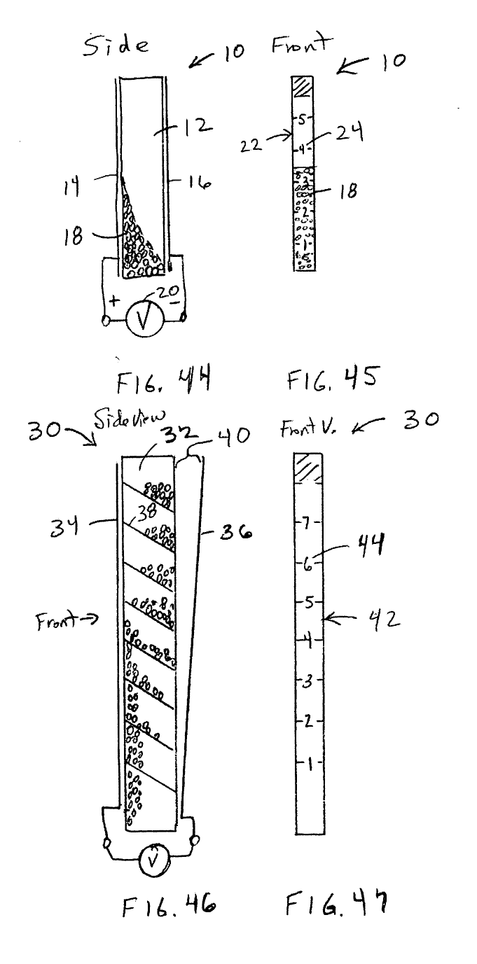

FIG. 42 and FIG. 43 illustrate and embodiment 290 by way of example wherein a linear array of programming electrodes 292 is coupled to a two-dimensional surface 294 for collecting user inputs. In this example, the high density of programming electrodes can be put to full use as the input electrodes. The programming output for the electronic ink is oriented in a first direction 296 having a single axis (although multiple rows of electrodes or a two dimensional array can be provided), which is coupled to a two dimensional array input area 294 oriented in a second direction 298 (i.e. can be any desired orientation in relation to input electrodes—shown in opposition for sake of a clear example). The input mode of this embodiment allows capturing inputs over a larger surface.

FIG. 43 depicts a single extended row of separated electrodes 300 from two-dimensional surface 294. In this example a group of adjacent electrodes 302 are connected to the input electrodes extending from the output electrode, with other rows 304 connected similarly. The spacing between electrodes is shown for clarity, but spacing may be very close with traces spaced within a few hundreds or whatever tolerance the process of subtractive or additive forming of the input electrodes allows. The electrode input surface may also be formed using multilayer techniques if desired to increase the proximity of the electrodes.

In one embodiment, the two-dimensional array can be implemented as a transparent layer which overlays a display, such as a portion of the electronic ink material being programmed by electrode array 292, or any other form of display. In this way the selections can span a two dimensional array of choices, or allow a user to enter handwriting, drawings, and so forth.

Biased Output State Electronic Ink for Return to Default.

Electronic ink provides a low power and low cost method of actively displaying information. By altering the electric field on either side of the ink spheres (or other form of field sensitive optical elements) the optical characteristics of the material can be changed. One advantage of electronic ink is that once set in an active or inactive state, no more power is needed to retain that state, wherein power needs are greatly reduced.

However, this advantage of electronic ink is a disadvantage when the display is utilized as a readout of changing conditions.

In some applications, it is actually desirable that the display return to a default state when a programming voltage is removed. However, despite this being generally an advantage, there are some applications in which having the output remain in its last state after the drive signal disappears is problematic, because for example one may be desiring to indicate the presence of the drive signal.

The present aspect of the invention describes methods of making electronic ink, or similar technologies, so that they return to a fixed state under no-signal conditions. The present electronic ink enhancements provide mechanisms that force the electronic ink (or similar field driven optical output) to return to a fixed non-signal state, such as active or inactive.

The feature is implemented by including a form of biasing mechanism to urge the ink toward a fixed state, without the need to supply a sufficient field to change the electronic ink back to that fixed state (i.e. active, or inactive), such as when no power is available or otherwise being applied. Although an electrical bias could be used with conventional electronic ink, this has the disadvantage of requiring power and is really more of a signal state driven display.

This feature of the present invention may be implemented with a number of other aspects of electronic ink which have been described in the applications referenced above, which are incorporated herein by reference. For example with altering the field potential at which the electronic ink changes state, wherein output indications can change with changing field intensity, for example in a linear voltmeter display, or other field response applications.

In response to applying a field across the electrodes, between which the electronic ink is positioned, the eink changes from the biased state to the opposite state. Upon removal of the voltage potential across the ink layer it returns under the urging of the bias force to its original state.

Biasing the electronic ink to a fixed power-off state can be accomplished in a number of ways. By way of example these can comprise: (1) increasing particle size and/or density; (2) electrical biasing; and/or (3) magnetic or chemical biasing.

It will be appreciated that numerous other mechanisms can be utilized for biasing the materials inside the electronic ink spheres toward a given state, without departing from the teachings of the present invention. The present electronic ink invention can be utilized for a number of different applications, such as electronic indicators, labeling, field sensing.

In a first set of embodiment the electric field sensitive particles are biased to a default state by gravity. By way of example, the particles and the fluid filled capsules can be sufficiently increased in size until gravity effects become sufficient to bias the particles into a position when the voltage across the electrodes is relaxed. This also adds an advantage of increasing the depth of view. The density of the particles and/or fluid can also be altered to optimize the characteristics for using this biasing mode. It will be appreciated that as the particles are enlarged the time required for changing the display state increases as does the required electrode to background voltage levels.

Very low cost displays may be fabricated using the biased electronic ink. These displays can provide a number of benefits such as low power, adaptable transfer functions, high visibility, elegance of a display having a depth of view (as opposed to flat eink implementations as described in other applications by the inventor).

FIG. 44 and FIG. 45 depict an example of a voltage meter utilizing aspects of electronic ink technology in a display biased toward a default, no electrode power state, wherein the display is no longer a static display like a conventional electronic ink display. It should be appreciated that the size of the cell chambers housing the particles is shown far larger than desired for the sake of clarity. The cells are implemented of suitable dimensions to allow the particles to be pulled toward an electrode in response to the application of voltage.

In FIG. 44 and FIG. 45 it can be seen that a fluid filled chamber 12 is adapted with electrodes 14, 16 on a first and opposing second surface. Particles 18 are retained within the fluid filled chamber. Application of a sufficient voltage 20 across the electrodes causes the particles to move into position against one electrode, depending on the particles. The face of the display 22 is transparent, with indicia 24, allowing the user to see a representation of the voltage level as spheres cover that portion of the interior display. The size that can be supported in this manner, however, may be significantly limited, such as on the order of a few centimeters, due to the need for the particles to traverse a large distance. When the electric field is removed the particles under the influence of gravity fall back to the bottom of the fluid filled container. Application of an opposing voltage will cause the particles to adhere to the rear of the chamber and thus the negative nature of the voltage is also indicated.

FIG. 46 and FIG. 47 depict another embodiment 30 which need not be constrained by any size dimensions, as it is segmented with a plurality of fluid filled chambers 32, a first electrode 34 and a second electrode 36. The floor 38 of each chamber is slanted downwardly toward the back of the chamber, wherein upon relaxation of the input voltage the particles under gravity flow down to the bottom rear of each cell. The electric field created in response to the applied voltage is attenuated at the top of the display by providing an increasing separation 40 between the electrodes along the length of the display, preferably by separating the rear electrode from the housing. In response to a voltage of the proper polarity the particles (larger and/or higher density than with conventional electronic spheres), are attracted to the front electrode and rise up the incline to the face of the display. It will be appreciated that the curvature of the rear electrode can be altered to vary the way the display reacts to input voltage levels. It should also be appreciated that the chambers may be aligned horizontally diagonally, in circles or in any other desired configuration while utilizing the same gravity relaxation technique. FIG. 47 depicts the face 42 of the display with indicia 44.

Although it appears of less practical value, one can provide electrodes in the face of each cell, wherein as conductive particles are pulled to the face of the display provide a conductive path wherein the setting of the display is registered. Although every cell could be configured in this manner, this is particularly well suited for one or more upper cells for registering if a threshold has been crossed. A display may be sold with connections available within each cell allowing the user to select their own limits, in response to which a small signal is generated when crossed to activating over/under threshold alerts and the like.

It will be appreciated that a number of ways exist for reducing the electric field strength for a given input voltage, or to otherwise register other aspects within the display.

Electronic Ink with Integrated Sensing.

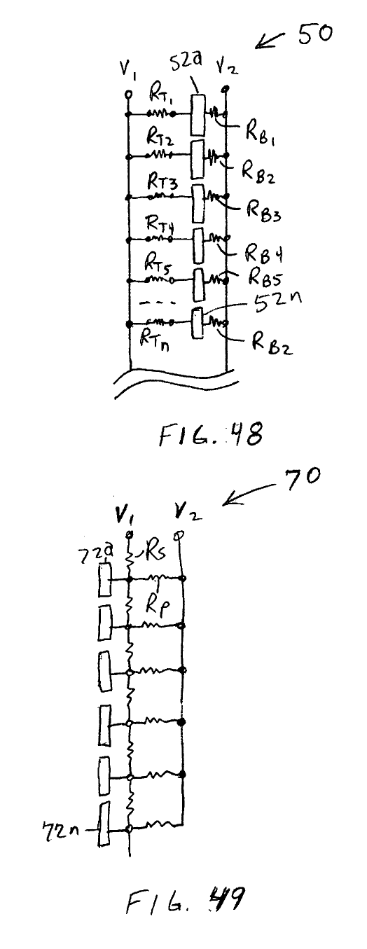

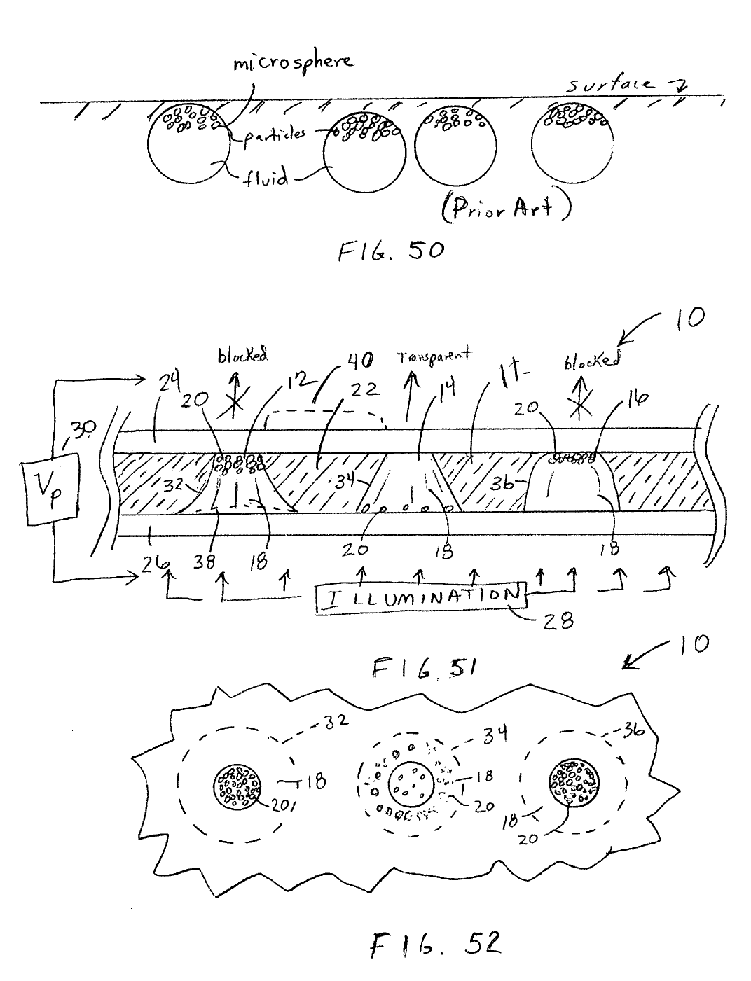

FIG. 48 depicts a thermal display electrode 50, wherein a ladder of thermally responsive segments R_{T1}-R_{Tn} are coupled to the electrodes 52ₐ-52ₙ and through a bias resistor R_{B1}-R_{Bn} to a reference voltage (i.e. ground). The thermally responsive segments may comprise thermocouples or similar materials whose resistance changes with temperature. The voltage at each electrode is therefore determined by the current flow through the thermocouple toward ground. The voltages on the electrode are applied to the display while a reference voltage is applied to an opposing side of the display. Preferably the resistors and thermally resistive elements are deposited as materials over a conductive grid that connects to the electrodes on the face of the display.

FIG. 49 depicts a similar ladder arrangement with series resistors Rs and parallel resistors Rp. The voltage applied at each electrode being a function of both series resistance and parallel. It should be readily appreciated that an input can be readily converted to any desired display response utilizing generally simple circuit techniques.

By way of further example, a switched capacitor input can be configured wherein, as the applied voltage drops below an activity threshold, switches (i.e. analog FET switches) changes state to reverse the capacitor connection to direct an opposing field voltage which resets the output to an initial state.

One preferred method is the inclusion of materials in at least one of the ink material of the sphere which is magnetically attracted to material on one side of the electronic ink, such as adjacent the one electrode. For example a ferromagnetic material may be retained in particles which is attracted to a magnetic material layer near one of the electrodes. This has a similar effect as the gravity technique described above, but it not affects by directionality. It will be appreciated that other variations can be incorporated, such as including a magnetic material within at least one of the electronic inks that is magnetically attracted to a ferromagnetic metal on one side of the electronic ink. Further, both inks could be configured to alternatively attract and repel one or more external materials.

Repulsive chemical properties may also be relied upon to bias the retained two elements of material within the spheres to a fixed position in the absence of a sufficient electric field to force alignment in a given direction.

An electronic ink display (or similar) which is biased magnetically as described can be applied for use in sensing magnetic fields and reporting the intensity of the field without the need of converting sensed magnetic field to a voltage for driving a display. Similarly, electronic ink that is biased to a given state in response to other stimulus may be configured to change state in response to sensing related conditions, for example depending on the temperature, presence of liquid, presence of other chemical constituents, and so forth.

Electronic Ink incorporating Light Transmission Control.

In many display applications it is very desirable or necessary to have display backlighting wherein light shines through either the active or non-active elements, wherein the outline of the displayed text and/or graphics can be seen even when insufficient direct lighting exists. Conventional electronic ink technology, however, does not provide selective transmissivity.

Therefore, a need exists to develop a light transmissive form of electronic ink. The present invention solves that need and can be implemented utilizing substantially conventional processing.

Previously, the present application described the use of a form of light transmissive electronic ink was referred to, however, details were not provided on the construction details of the material. The present aspect of the invention describes methods and apparatus embodiments for producing transmissive electronic ink displays and materials which are programmable or non-programmable. These embodiments may be utilized with backlighting or have integral backlighting, and may be utilized in combination with printing techniques adapted for use with the material for controlling the transmissivity of the resultant signage or display.

FIG. 50 depicts a conventional electronic ink embodiment, having particle and fluid filled spheres embedded on, at, or near the surface of a material to which an electric field can be applied. In an electronic ink display a fluid and particles are retained in small spheres which can be distributed across a surface or embedded in a material. The particles are attracted to a sufficient electric field orientation, but remain in that position after the field id removed (i.e., a static display form).

In the present inventive aspect, the particles are retained in a section of a “fluidic light pipe” which tapers from a wide first end to a narrow second end. A sufficient quantity of particles is incorporated within the fluidic light pipe to provide a substantial blockage of the light when they are disposed at the narrow end of the light pipe, without duplicity (i.e., minimum number to achieve a given percentage light reduction, for instance 95%). It will be recognized that when the particles are at the wider end of the light pipe that the increased spacing will allow a greater percentage of light to pass through the medium. Therefore, changing the position of the particles in response to an electric field has the effect of altering the transmissivity of the material from a first state to a second state.

In the present invention a transmissive display technology is created utilizing the basic operating principles of electronic ink. It will be appreciated that the utilizing the electronic ink spheres within a paint material matrix does not easily lend itself to transmissivity because the spheres are symmetrical, blocking light through the material regardless of direction. Furthermore the matrix within which the spheres are randomly embedded also poses problems; with a clear matrix light passes through voids better than through the spheres, while an opaque matrix prevent light transmittal when material overlays any spheres. These problems with present technology have been recognized by the inventor.

### Structure of Example Embodiment

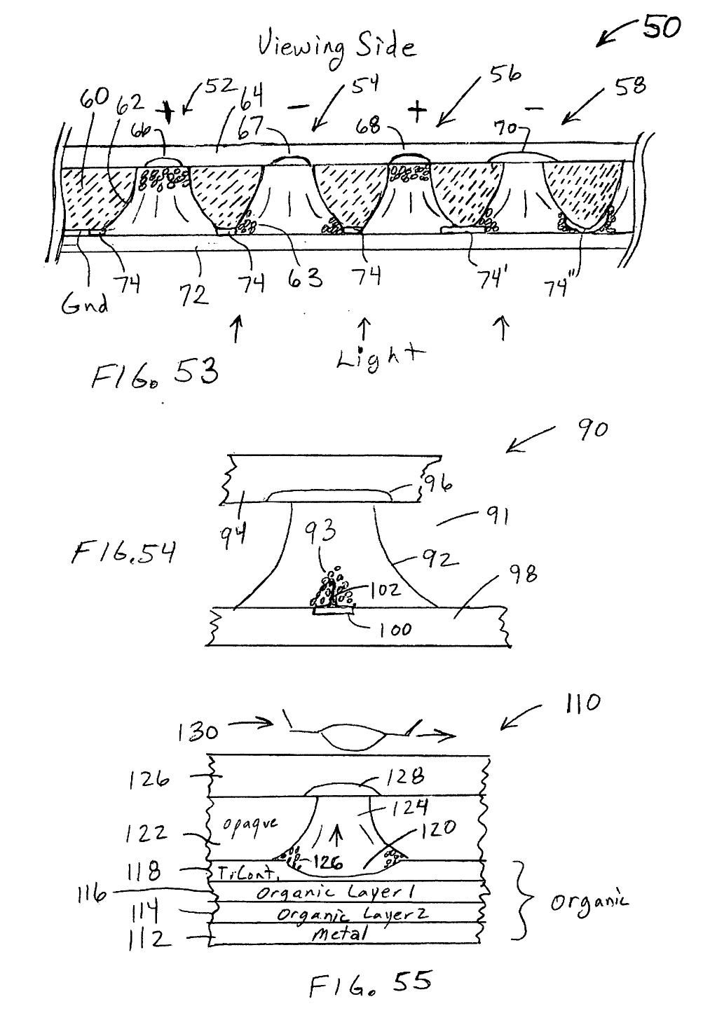

FIG. 51 and FIG. 52 illustrates an example embodiment of the transparent electronic ink 10 of the present invention. A preferably opaque material 11 is configured with non-symmetrical “light pipe” containers 12, 14, 16 for retaining the fluid 18 and particles 20 of the electronic ink, the fluid being preferably fully transparent (clear or with one or more transparent colors) and the particles being opaque (black, or other desired color). The relationship between the color and reflectivity of the particles within the containers to that of the surface of the opaque material as seen from the viewing side can be configured to provide a good display contrast from the backlighting effect AND/OR from the differences in reflectivity (as in a conventional eink display). From the viewing surface of the material, the cross section of containers 12, 14, and 16 are shown by way of example. Container 12 is shown with concave sides, container 14 with straight sides 34, and container 16 with convex sides 36. The sides 32, 34, 36 may be of the opaque material, or they may be covered with a material, such as a reflective material (i.e., non-ferrous metallic coating such as by vapor deposition, sputtering, or any other convenient coating method), which increases the efficiency of the light being coupled from the wide side of the containers through to the narrow end of the containers. The containers may have any desired cross section as seen from either side of the plane of material, although typically a circular cross section is easiest to fabricate. Each container is preferably configured with smooth light reflective sides, which direct incoming light from the wide end of the container toward the narrow end. It should be appreciated that although the light source may be placed behind the narrow end container side of the material, this would reduce the amount of light which could be passed through the material, since the light pipe properties of the containers (apertures within the opaque material filled with light transmissive fluid) would not come into play.

The size of the tapered containers should be sufficiently small so that the particles move in response to a moderate voltage applications level. Furthermore, the use of a sufficiently small chamber and small particles assures that the particles remain in a given location within the tapered container after electrode programming voltages are relaxed. Preferred size ranges for the containers are expected to be with diameters in the range of from approximately 30 microns to 1000 microns, and more preferably between 50 microns to 500 microns with the thickness of a single opaque material layer being about the same thickness.

It should be appreciated the material 11 need not be opaque if light is otherwise restricted from passing through the material except through narrow and wide windows. For example covering 24 and/or 26 can be patterned to provide selective transparency to align with the windows, or the front or back of the material may contain an opaque coating for preventing the light from passing through non-window portions of the material.

Non-symmetrical containers 12, 14, 16 are formed in a substantially opaque base material 22, preferably a form of plastic selected for proper workability, durability, temperature stability and so forth. Forming top and bottom covers for sealing the containers are transparent layers 24, 26 (clear or colored) allowing light to permeate to the containers 12, 14, 16. It should be appreciated that additional structures may be incorporated for directing the particles or controlling their distribution toward either surface. For example a conical protrusion 38 extending into the cavity of the container can aid in biasing the particles toward the fringes of the container, and a steep enough protrusion could result in stacking the particles wherein more light can be transmitted. Other structures will be obvious in view of this structure, such as having a series of tapered wells on the wide side into which the particles stack automatically when moved from the narrow side to the wide side of the container. From the teachings above one of ordinary skill in the art will readily be able to create a number of alternate structures for redirecting particle alignment, without depart from the teachings of the present invention.

The containers are preferably closely spaced and may be adjacent one another, but preferably not overlapping, which would allow particles to migrate leaving uneven particle distribution and display properties. The optimum spacing of the containers depends on a number of factors, including material costs, fabrication techniques, fabrication costs on the opaque material, and the maximum amount of light to be transmitted through the material.

Example scenario determining light transmissivity. The following considers an example scenario in which circular cross section containers are placed with the widest portions being adjacent and the wide side having twice the diameter of the narrow side. The apertures for the containers provide up to about 75% transmissivity to the panel from the wide side, assuming near optimum light reflection from the interior walls of the light pipe. The particles at a density to block about 95% of the light at the narrow end, will block about 25-30% of the light when they are pulled to the wide end of the container. Therefore, the transmissivity of the panel can be changed from less than 5% to approximately 50%, which provides a high contrast ratio for the display. The size relationship between the wide and narrow ends and other aspects in the above example not limiting the practice of the invention.

It should be appreciated that although a single layer is shown for the sake of clarity, the material can be constructed with multiple layers, insofar as a light path is still provided between containers in one layer and those of another layer. The layers actually don't need to be aligned so long as a light path is created, for instance incorporation of a sufficiently thick diffusive layer can be placed between subsequent apertured layers wherein they need not be aligned. By way of example another opaque layer with tapered apertures can be coupled to layer 26 or layer 24 having the same orientation as the opaque layer shown. In this way the opacity of the non-windowed sections can be increased while the opacity of the material can be increased when the particles are directed at the narrow portion of the containers.

Embedded programming may be established to program the layers separately, although more preferably it is configured for programming the multiple layers simultaneously. For example multiple aligned layers of the material shown may be assembled, in particular for increasing the opacity of the base material 22 and the particles when retained at the narrow end of the containers. Another method of increasing the opacity of the base material is to attach an aligned overlapping aperture layer to the material, wherein light is further attenuated which attempts to pass through the opaque material. This may be placed on either side, but used on the wide portion of the display can increase the amount of light coupled through the container.

An illumination source 28 is shown disposed on one side of the electronic ink, herein depicted as the wide side. A means for generating an electric field 30 across the material is shown with a source Vp. It should be appreciated that any convenient method may be utilized with the material for generating a sufficient electric field for “programming the ink” (directing the spheres to a first or second side of the material).

By way of example and not of limitation, row and column techniques may be utilized with preferably substantially transparent conductors. Mechanical programming techniques may be utilized in which an electrode array generating electric field domains is slide over the material to program the portions into a first or second state. It should be appreciated that the material may be utilized with other techniques for programming the state of the electronic ink without departing from the teachings of the present invention.

Construction and Uses of Materials.

The present electronic ink invention lends itself to numerous fabrication techniques for creating the container walls in the opaque material, for filling the containers with particles and fluid, and for covering the opaque layer with a transparent layer. It should be appreciated with any of these techniques, however, that a manufacturer can generally produce one or a few varieties of the material which can be deployed within any active, semi-static, or static applications. Unlike conventional displays the manufacturer does not have to worry about producing specific sizes and types, they can concentrate on the lower the cost on creating rolls of the material, and the process should become more like producing paper than producing a display.

The following describes, by way of example and not of limitation, a few contemplated methods for fabricating the material of the present invention. One of ordinary skill in each fabrication art can utilize their expertise to modify the teachings herein for reducing the cost and complexity of manufacturing the display material without departing from the present invention.

In a first contemplated manufacturing process, appropriately shaped apertures are created in a sheet of opaque material forming the walls of the containers. A transparent covering 24, 26 is attached over either side of the opaque material. The container are filled with particles 20 and fluid 18, and then the cells are sealed off with another sheet of material 24/26. A number of aspects of manufacture should be considered with the material.

The apertures in the opaque material may be formed in a number of alternative ways, for example by ablation techniques, chemical etching, laser cutting, mechanical cutting, molding, mask forming techniques, additive processes, printing techniques and so forth. The material may have printing 40 (FIG. 51) on it to further block light passing through the opaque material and to impart any desired color to the material.

The overlaid sheet may also provide a selective bonding surface, for example allowing paint or inks to adhere only to the material 40 while remaining clear, or being easily removed, from the ends of the containers. It will be appreciated that in this way a sign can have a reflective printing but be enhanced by the use of the transparent electronic ink display capability, wherein light can be generated through selected portions of the print (i.e. a monochrome rendition output in conjunction with a colored reflective rendition), thereby enhancing visibility in all conditions, but especially in low light conditions.

In another aspect of the invention a printing device can be configured with a means for detecting the position of the transmissive matrix of the present material, and a means for selectively applying inks or paints to the material, wherein the areas of the transparent apertures can be selectively prevented from being overprinted, or even selectively printed over, or ignored in a section on which that aspect is not important. One means for detecting the positioning of the material is by using a light mask having a similar sized apertures and pitch of the target material and modulating the position of this mask in relation to the position of the material, wherein a conventional optical sensor can detect the position at which maximum light passes through the mask and material. The position at which the maximum signal is detected is the position at which the holes in the mask optimally align with the material.

The above being described, it should however, be recognized that the size of the apertures (container ends—narrow end or wide end) is on the order of hundreds of microns, wherein precise pixel ink/paint deposition control would be required to achieve this level of accuracy. Alternatively, the optical mask above may be coupled to an inverse mask, wherein when the optical mask is aligned the inverse mask covers the apertures on the material. The printing may then be relegated to smaller masked sections, as it will be difficult to achieve the same temperature coefficients for the mask and material while preventing any pressure induced permanent or temporary distortions in the material or mask. Configuring the covering material of the transmissive material with one or more selective adherence layers is preferred as this can be performed at the factory making the high precision material, and allows for the use of generally conventional printing techniques which may be modified for aiding the difference in adherence and/or for providing a post printing cleaning operation which removes non-adhered inks/paints from over all or selected container ends (narrow or wide), or sealed apertures in the opaque material.

In addition the material need not be utilized with a backlight, as it can rely on light reaching the face of the display and either being reflected or absorbed by the particles, or passing though the container and reflecting off of the backing surface (which is only partially covered by the particles) back out to the viewer. For example the backing 26 may contain a reflective material. In a more preferred use of the material, the backing may contain a graphical image to be displayed (i.e. color or monochrome), wherein the user selectively sees the colors on this backing in response to the position of the particles, when programmed to the wide side the particles allow most of the incoming light to reflect from the backing thereby reflecting that color back out to the user. When the particles are positioned in the narrow end of the container, then the incoming light is directly reflected back to the user and the user sees the color of the particles themselves. The backing material may comprise a colored transparent backing wherein backlighting may be provided to enhance the amount of light reaching the user and not relying incoming light.

It should also be appreciated that the opaque material can be configured as a light pipe material, without the inclusion of the particles, such as for use behind signs and the like as described above. This material being also described as an aspect of the present invention. The light can be set to shine through all portions of the display, or be selectively attenuated by the application of inks or paints to provide the backlight transparent monochrome image overlaid with a reflective color image as described above, without the reprogrammability aspects, the reprogrammability may not be desired (except if special effects are wanted) for a sign intended to display a static message. The light pipe apertures in the opaque material may even be selectively formed in a process which converts a monochrome base image to determine the presence, spacing, size, and characteristics of the apertures formed in a layer of the opaque base material. For example utilizing optical masking techniques adopted from the semiconductor processing industry.

The above manufacturing method describes a process of creating apertures in opaque material, bounding a first surface, filling, and then bounding the second surface. It should be appreciated, however, that a number of alternative techniques can be adopted for creating the display material of the present invention, and derivatives thereof.

As a first example the opaque material can be formed with the tapered apertures into which capsules of electronic ink are coupled, using any convenient form of self-assembly technique. For example applying a vacuum pressure to the front surface (narrow side of apertures) while flowing capsules, optionally in a fluid or other carrier, over the back surface—wherein capsules get lodged under vacuum pressure into the tapered apertures. Glues or mechanical protrusions from tapered structure can be provided to enhance retention of capsules. A coating or covering can then be placed to retain the capsules and preferably to apply the conformal pressure, in particular from the backside. It will be appreciated that the narrow front aperture is sufficiently small to prevent the capsules from passing through the material, and can form a beneficial domed surface on the front side. Preferably in this way the original shape of the capsules, such as spherical, is forced to substantially conform to the interior of the tapered cavity. One big advantage of the technique is that it can be produced without the need of filling the individual containers with fluid and the proper volume of particles, wherein it can rely on techniques utilized for manufacturing conventional electronic ink spheres.

As a second example, electronic ink capsules can be formed individually having the asymmetrical shapes (narrow on one end and wider at the other end) and then these can be assembled (i.e. fused, adhered, attached to a backing, etc.) into a material layer.

It should be appreciated that a number of different aspects of the present invention and manufacturing techniques have been described above which can provide numerous options for creating various forms of both programmable and non-programmable signage, displays, and so forth.

The transparent electronic ink material and methods of the present invention may be utilized for constructing a variety of semi-static signs as well as for creating low cost, low power active displays. The material may be utilized within any conventional application for electronic ink, such as those described by the inventor or by others, although it is particularly well suited for backlite display applications, such as road side signage and so forth.

Optimizing Transparency.

It will be appreciated that by forcing the spheres to the edges of the wide end of the containers that the transparency can approach 100%, actually over 100% of the output area. One method for increasing the transparency is by forming the electrodes so as to redirect the spheres. In this embodiment electrodes are configured about the perimeter of the wide end of the cells, wherein the reflective elements are drawn to the edges of the display and to the center on narrow end of the cells.

FIG. 53 depicts a cross-section of a display 50 having transparent display elements 52, 54, 56, 58 showing slight different implementations. The display section is formed from an opaque base material 60, into which tapered cells 62 are formed (i.e. etching, cutting, additive process, and so forth), containing a fluid and electronic ink spheres 63. A transparent insulator material 64 is formed over the small end of the cells containing in this instance transparent electrodes 66, 67, 68, 70 (i.e. row or column). It will be appreciated that the transparent insulator material may be formed over the cells after the electrode layers are in place. The electrode can also be formed prior to etching out the cells. It will be appreciated that each shape of electrode can provide a slightly different arrangement of the spheres. On the opposing side is another electrode 74, 74′, 74″ which in this case is a complement (column or row) of that of 66, 67, 68, 70 found, and may be transparent or non-transparent. Note that electrodes 74, 74′ and 74″ are all connected but illustrate by way of example different shapes for the electrode. A row and column drive mechanism is thus formed across the cells containing the electronic ink, wherein the state can be changed by providing a sufficient positive or negative voltage in relation to the ground electrode 74, 74′, 74″.

Electrode 74 is a small flat electrode which forms a ring about each cell periphery. The electrode can also fill in the larger areas between the cells diagonally, if desired, however, this in some case could distort the distribution of spheres away from a strictly circular pattern. Electrode 74′ is shown being larger than the area between cells, wherein it can provide additional force to draw the spheres, but blocks a portion of the incoming light to the cell. Electrode 74″ is shown formed over the structure, such as by sputtering or other additive processes.

It can be readily seen that the spheres collect about the periphery of the wide end of the cells when polarity is applied in that direction. This increases the central transparency of the cells allowing the light to pass through with less diffusion although the reflected light about the periphery is reduced.

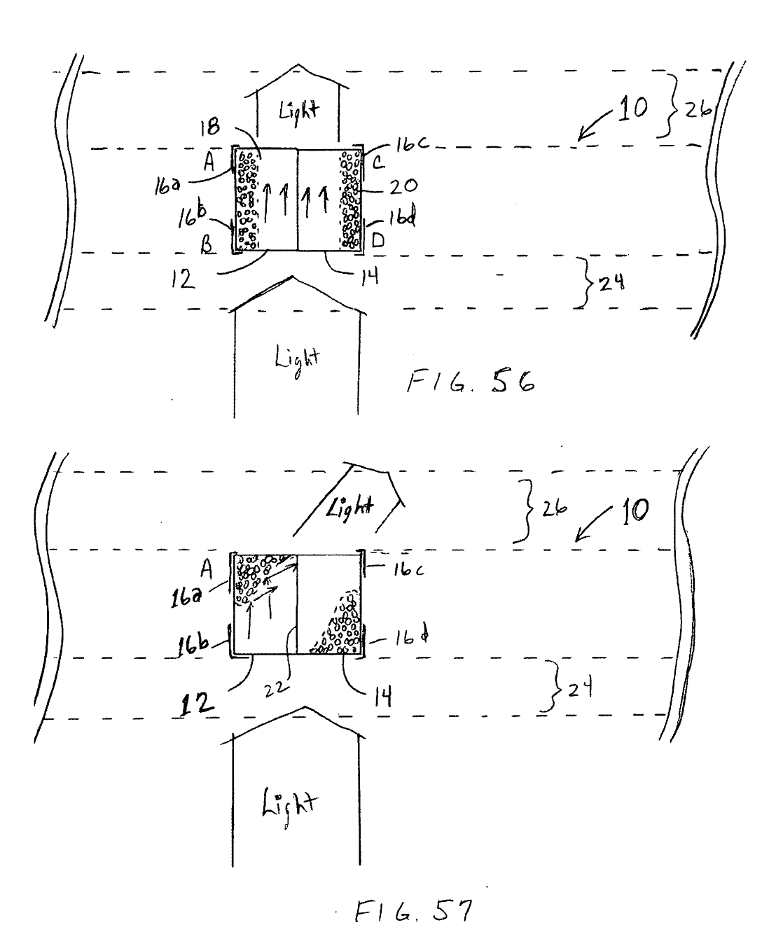

FIG. 54 depicts another example 90 in which cells 92 are cut into opaque material 91 and contain elnk spheres 93 within the cells liquid. A first transparent cover 94 has an electrode 96 over the narrow end of cell 92. A second transparent cover 98 has electrode 100, with optional vertically displaced element 102. The vertical element could be produced for example by etching the shape of element 102 into the opaque material 91, depositing a metallic layer including the row or column connections between cells. Then the cell is etched out from either desired side removing the opaque material. In this example the light picked around the edges is improved and the spheres are somewhat stacked at the central structure to reduce the area taken up by the spheres. It should be appreciated that a large number of different embodiments can be created without departing from the teachings of the present invention.

The above example illustrates the material utilized in a row and column type of drive, however, it can also be utilized with a display in which the pixels are programmed by a moving electrode in reference to a fixed electrode. In the above example the fixed electrode can comprise the ringed electrode structure 74, 74′, 74″ covering the back portion of the display. The programming voltages then applied from an electrode moving over the face of the display will still cause the spheres to either collect to block the narrow end or be distributed about the periphery of the cell (FIG. 53), or stacked in the center (FIG. 54).

Transparent Electronic Ink with Integral Backlighting.

It has been recognized by the inventor that a planar electronic ink construct which changes transparency in response to programming is particularly well suited for use with an integral and evenly distributed light source. Using discrete light sources requires that the material of the electronic ink and the light source be separated by a distance that is many orders of magnitude above the thickness of the electronic ink layer. Accordingly, one aspect of the present invention describes a transparent electronic ink with integral light source.

FIG. 55 depicts a structure of the electronic ink display with an integral backlighting 110, such as one that generates white light (or any other desired color). The light is generated by the bottom stack comprising a first metallic electrode 112 upon which are deposited two semiconducting organic films 114, 116, although one or more organic films may be utilized. A second electrode 118 is transparent, and in this example formed with a reduced thickness well 120, although is could be formed in any desired shape. An opaque material 122 is cut with tapered cell 124 which retains a liquid and the eink spheres 126. The well 120 provides an aid to directing the spheres about the periphery of the cell when programmed to be in that direction. A second transparent layer 126 is formed over the opposing side with electrode 128. The light is generated by the organic LED formed from layers 112 through 118. The static eink control is provided by the cells and row-column electrode 118 in combination with a fixed column-row electrode 128. Alternatively a electrode 118 may comprise a single planar electrode used in combination with a moving electrode 130. It will be appreciated that either a row-column form or a moving electrode technique can be utilized for controlling a display. This display can be utilized for various applications, and provide visibility by generating its own light or using reflected light.

Multistate/Directional Optical Output.

In some applications it is desirable to be able to use a material for altering the direction of a light source. Although mirror arrays and the like may be utilized they can be expensive in large sizes and are not structurally robust.

Therefore a need exists for an apparatus and method for redirecting light using electric fields. The present invention fulfills that need and can be manufactured as a sheet material that may be cut for use in numerous applications.

Apparatus and methods are described for modulating the direction of light utilizing the movement of reflective particles within a fluid filled capsule, which utilizes electric field attraction properties found in electronic ink devices.

The above material presumes the setting of the electronic ink into a first or second state as is done with conventional reflective electronic ink. However, aspects of the invention may be utilized and extended for implementing various multistate output display materials, such as for directing the light output in a similar manner to a programmable mirror array.

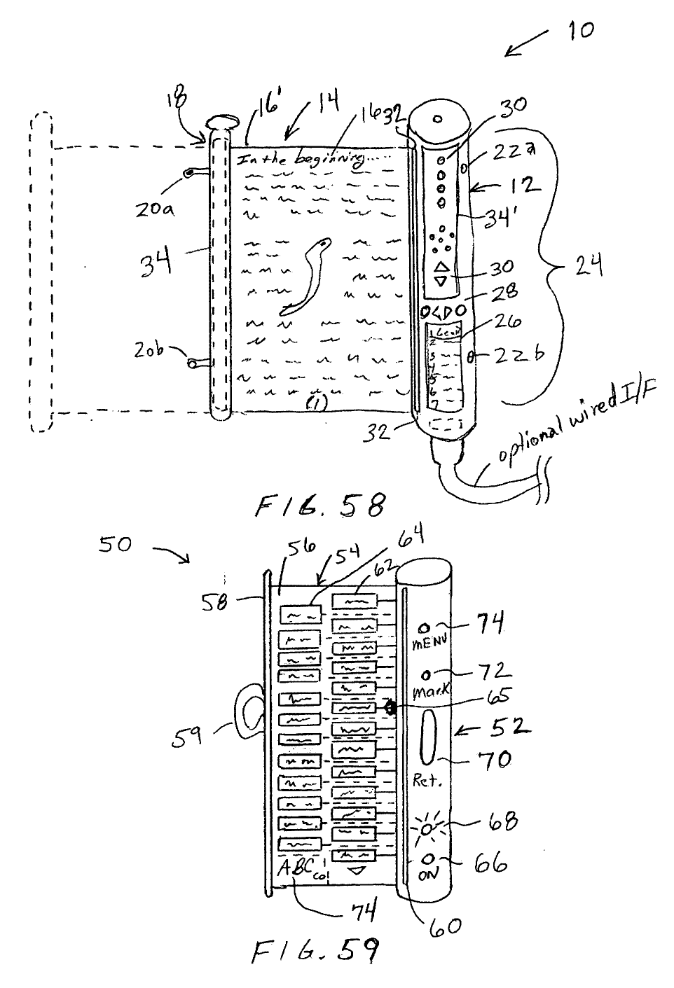

FIG. 56 illustrates an example of a light reflective material 10 having a plurality of container cells 12, 14, having reflection particles 20 within a transparent fluid 18 to control the direction of light output from the material. The walls of the cells are transparent allowing light to pass between cells 12, 14. The example illustrates the direction of light in two dimensions (right to left control), however, it should be appreciated that numerous adaptations of this may be configured for directing light in various two and three dimensional patterns to suite a wide variety of applications.

Transparent layers 24, 26 may be applied to the material to seal apertures 12, 14 in creating the encapsulated fluid filled area, or to provide extra protection to the thin walls of the container cells.

Electrodes 16a-16d are shown adjacent to portions of container cells 12, 14. To simplify control it is preferred that the particles within cell 14 respond to the opposite polarity as the particles within cell 12, although the technique can be alternatively implemented using all the same type of particle. The particles utilized within this embodiment preferably have a highly reflective exterior surface for redirecting the light output. A transparent conductive connection grid is coupled between layer 10 and layer 26, and another between layer 10 and layer 24, wherein voltage are applied for directionally controlling the light output. The light can be directed straight through the center of the cells, toward the outside edges, or deflected at an angle controlled by the application of electrode voltage.

In FIG. 56 the particles are lining the exterior walls of the cells, such as in response to applying a sufficient electrical potential between electrodes 16a, 16b (i.e. positive) and electrodes 16c, 16d (i.e. negative), wherein the different particles are pulled toward the exterior walls allowing a portion of the light to pass through the material without directional bias.

In FIG. 57 a voltage is applied between electrodes 16a to 16b with the same voltage applied between electrodes 16c to 16d. The particles collect attempting to minimize distance to electrode forming the triangular reflective sections shown and directing the light toward the right in the diagram. It should be appreciated that a number of different arrangements can be formed for redirecting light.

To use the same particles in each cell an upper and lower transparent electrode can be embedded between the walls of cell 12 and cell 14, a region 22 which is depicted in FIG. 57. In this way applying a first potential to the center electrode and an opposing voltage to all electrodes 16a-16d directs all particles toward the center where the center electrode is located, or toward the outer walls, depending on the polarity of the applied voltage. The use of a center electrode can also simplify creating a desirable profile for the particle buildup as it can be configured to repel the particles toward the edges while the outside electrodes are activated in an opposing pattern. Example apply first voltage (repel) to center electrode, with a second voltage to electrode 16a and to electrode 16d, wherein a curved path of reflective particles are distributed similarly to that shown in FIG. 57, however, with a slightly different curve. By varying the application of voltages among the electrodes it will be appreciated that different average reflection angles can be selected in response to the application of voltage fields. Furthermore, this technique maintains a given reflective profile (direction) after the programming voltage is removed from the electrode providing a static form of light redirection. It should be pointed out that due to the slow reaction of the particles and the diffraction of the light from the uneven surface of the particles this technique is probably not very well suited for most optical switching applications.

Material 10 can be configured with all like electrodes connected together, wherein all the cells on the material will similarly direct light. Alternatively signals can be coupled separately to each cell, or more preferably to pixel clusters of cells, wherein the direction of light output can be controlled separately for each pixel area. This aspect of the invention allows for a wide variety of lighting effects to be created. Alternatively, regions in the material, such as bands or rings within a section of material, can be connected sharing common signals, thereby allowing separate control by section while significantly reducing the cost of interconnection and output driving a large number of separate pixels.

Inexpensive Electronic Book Embodiments.

A number of electronic book formats have been proposed for allowing a reader to view book pages electronically. These devices all utilize a dynamic display screen which is updated with a conventional row and column addressing matrix and therefore unit cost is often above what individuals are willing to pay for an electronic book display device.

Therefore a need exists for a lower cost alternative electronic book viewing device that provides the majority of the benefits of prior systems while doing so at a reduced unit cost, the present invention satisfies those needs.

A viewing device that utilizes a static display element, such as electronic ink, which is voltage field programmed to display text and graphics information. The display region does not contain the buried row and column drivers of a conventional display wherein cost per unit is reduced.

The viewing unit is particularly well suited for a paperback book replacement device, and it operates on the same concept as described with regard to FIG. 21 and FIG. 22, wherein a static view of data can be viewed on the extended material in response to extending the material from the housing. This embodiment adds additional aspects to that description, directed toward use as an electronic book device.

In addition, another device by the inventor describes a “location-aware audio tour device” which utilizes many of the principles espoused in FIG. 21 and FIG. 22.

One of the primary advantages of the present invention is that it does not require the expensive row and column drives embedded in the sheet of a dynamic e-book. Cost can be brought down to the $10-$50 range. It should be appreciated that a page of 5″ by 8″ having 100 pixels per inch (which is not especially high resolution), currently requires 500 drive lines in a first direction and 800 drive lines in a second direction. These 1300 lines need to be connected to a myriad of circuits. In the present invention a single distributed electrode is required, which controls 800 drive lines, but can do so from a serial interface. Therein the electronics are substantially simplified. Furthermore, more than a single page can be extended if the user wants to briefly look back or forward to nearby pages.

Each retraction-advance cycle yields next page—unless other selection mechanism is used. The page is pulled from a housing, such as perhaps rolled-up under tension and in transit it is programmed with new data, such as text and graphics. The page may be left substantially flexible or stiffened in a number of ways. One preferred manner of stiffening the page to simplify holding is with a scissor mechanism that supports the extended page. However, use of a stiffener makes it more difficult to inexpensively implement the use of multiple pages.

Single button retraction and extended by pulling out the page. In one mode of the display, when the page is retracted and then pulled out again, the text and/or graphics being display is automatically updated to the next page. A small table of contents (TOC), such as with a dynamic LCD or eink can be incorporated on the housing to facilitate movement between sections of the device, and provide for directly setting page numbers and other overall reference functions. Buttons increase utility, such as for TOC, Index, Chapter forward, Chapter reverse.

Since no embedded sets of electrodes are necessary. Multiple pages can be pulled from the unit as the scroll can span numerous pages if desired. This is particularly useful during normal reading for going back to the prior page to refer to some content, without the necessity of changing the active page back to the prior page.

Other beneficial features are also described, such as a user input device that relies upon the electrode array used for programming the eink. User inputs can be sensed on the raw electrode array, such as conductively, of even through the material of the screen, such as capacitively or by registered the presence of RF (i.e. person's body acts as an antenna). In addition, the system can be configured to allow the user to take notes, listen to recorded music and the like. In one embodiment the notes taken can be stored in association with locations in the text, or graphics, to which they apply. A number of additional features are also described.

### Electronic Book Embodiment

FIG. 58 depicts an embodiment 10 of an electronic book, having a housing 12 with a pull-out page 14, which contains electronic ink, or similar electric-field programmable static display material, which can be set to at least two different optical display states (i.e. black or white). Housing 12 is configured in a round shape, although it should be appreciated that it may be manufactured in any desired shape (i.e. rectangular, square, oval, etc.). Furthermore, although shown as a standalone device, the unit functionality can be integrated into other devices (i.e. PDAs, phones, memory sticks, audio and video players, cameras (still and video), games, game consoles, industrial equipment, and so forth) without departing from the teachings of the invention.

### Relation to Prior Embodiments

It should be appreciated that this embodiment provides output on a slide out electronic ink sheet, programmed by a fixed electrode as described in a previous portion of the application (FIG. 21-22) in which the device from which the sheet was extended was shown embodied as a laptop computer. The present embodiment shares those aspects while describing a number of elements which are particularly well-suited for use with electronic books, or similar content access applications in which the content is largely static—so that the extra cost of a fully-dynamic display is not necessary warranted. It will be appreciated that a fully dynamic display allows changing the content moment-by-moment and can display animations, video and the like. The present device is configured to provide low cost static to semi-static content display, such as is common in books and similar content.

Basic Functions.

Embodiment 10 depicts the eBook as a small dedicated device, or one that is part of a memory stick, audio player/recorder, although it may be implemented in a number of alternative embodiments.

An optional stiffener 18 is shown attached to a distal side of page 14, therein making it easier to handle by the user. In this embodiment fasteners 20a, 20b are shown configured for attachment to structures 22a, 22b respectively therein protecting the user interface 24, such as allowing the unit to be carried in an attaché case, backpack, purse, hand bag, or whatever.

User interface 24 is shown comprising an optional active display 26, such as active eink, LCD, OLED, or other form, allowing interaction with the user. It will be appreciated that single LEDs or other indicators could be alternatively utilized, or menuing provided on the roll out screen, wherein even the small active display is not necessary. However, a small screen is preferable if the device is to be used for other functions aside from an electronic book, such as an file retaining memory stick, audio playback system, and so forth, wherein the user need not open the screen to select simple functions of the device. User scroll buttons 28 are shown along with various selection inputs 30, therein allowing the user to fully program the operation of the device.

According to the embodiment depicted, when the unit is utilized in an electronic book mode a desired index mechanism, is shown on the active display, or a combination of index mechanisms. For example a table of contents can be shown, a last displayed position shown, as well as user programmed bookmarks, note locations, page numbers and so forth. In this way the user can select how they want to select the content to be viewed. Furthermore, when the unit is loaded with multiple content elements, such as different books, lists of quotes, and so forth, a menu can be provided to allow the user to select which content. In one mode the unit defaults to the last content accessed, as this is the predominant selection for book readers, while other content may be kept for reference, such as dictionary, thesaurus, Bible, and so forth for other information.

User Input Via Programming Electrode Array.

One aspect of the present invention that increases the utility of the system, without substantially increasing the cost is that of using the elnk programming electrodes in both an output mode, as described, as well as in an input mode. This is possible within the semi-static display as the electrodes are not in use unless the screen is being programmed. Another aspect of the present invention describes this in detail, wherein it will not be described in this section. A linear input 32 is shown which contains a series of separate conductive elements which are coupled to the programming electrode bar. All or any portion of the electrodes may be coupled to linear input 32. It should be appreciated as described elsewhere that the unit can sense using conductivity, capacitance, RF, inductance or other sensing parameter for detecting user interaction with the electrode. It should be appreciated that this input in this form can detect not only a single selection in response to a single touch, but a range of selection inputs in response to a sliding motion, as well as rate or intensity in response to the speed of sliding motion on the input. Furthermore, this linear input can be expanded as described to provide a two-dimensional input allowing more elaborate functions to be selected.

This input control can be utilized in various modes in the present invention, such as for selecting areas of text (for notes, highlighting, etc.), selecting analog parameters such as volume level, or supporting user interface functions, such as selecting options from a menu, sections of content, page numbers, and so forth. In a mode in which the display or a portion of the display is used as a legend for the linear input 32. input mode of the display menuing mode of the invention the screen is extended to a first menu wherein the user selects the menu option by pressing on an associated area on input 32. The screen only need be extended sufficiently to allow the user to see the choices from which to select.

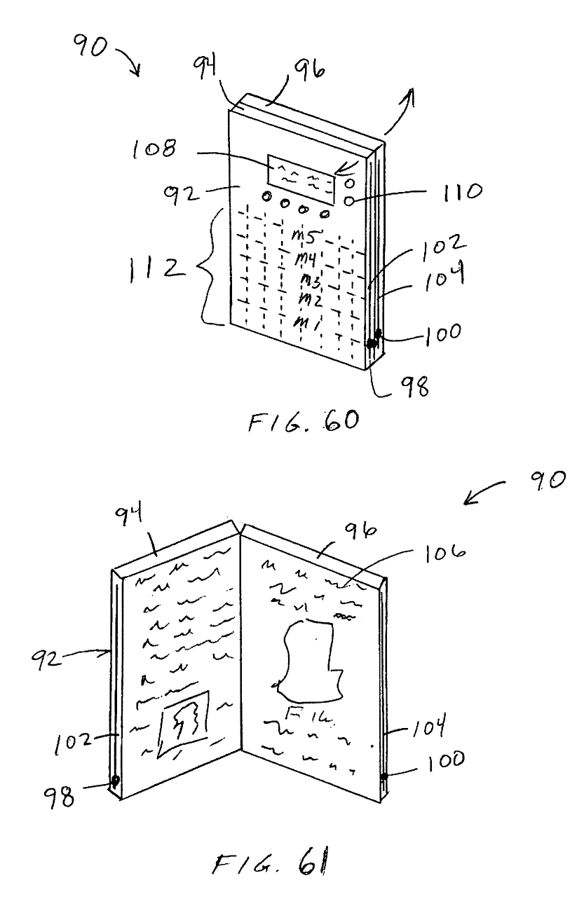

FIG. 59 depicts an embodiment 50 of a simpler electronic book. A housing 52 is shown with extended page 54 having electronic ink 56 on at least one area or surface. A handle 58 stiffens the page and provides a handle for grasping, which is shown augmented with an optional thumb-hole handle 59, as this is a comfortable means of holding the device. The linear input 60 is shown for performing the majority of user inputs. The extended page provides a control for selecting menu items, or a location from a table of contents. In this depiction a main menu row 62 is shown with submenus 64 showing up if desired as the page is extended further. It will be appreciated that the user need only extend the page sufficient to see the level of content detail that they need in this instance, wherein they can make a selection and then let the page retract and be extended again to execute the menu, or other form of, selection.

In another aspect of the embodiment the screen does not latch into the extended position when not fully extended, therein saving the user the step of pressing a retract button between selections using this interface. Furthermore, once a selection is made the do a “quick cast” by allowing the page to slightly retract, wherein they pull it out again. The system upon recognizing the short retraction stroke, marks the position that is the current selection, as seen by 65 marking a menu item. Unless the page is fully retracted, at least past the visible screen items, the selection made will not take effect. This feedback assures the user that the right choice has been entered, an especially important feature if the menus are crowded and the users hands are large.

It is preferable that a setup option allows the user to set the minimum spacing between items in the menus, such as small, medium, large, for example based on their hand size and dexterity. These same setup options can contain options for the font sizes and other parameters of the device.

When reading sequential content, such as an electronic book, newspaper and so forth it is preferable that the unit will advance the page with each “full cast” wherein the page is fully retracted and then extended. It is also preferred that a certain menu items be selectable from the extended page, for example: backpage, menu, next chapter, last chapter, table of contents, and so forth to facilitate user control. Preferably there are few enough menu choices wherein the user will not need to verify that the correct item has been selected. Upon retraction and extension, referred to herein as a “full cast” the action is performed wherein the display now contains the information, page or whatever as selected by the user.

In view of this form of input with control 60 few other user inputs are required on the device. In this example the device contains an ON button 66, which can be configured to turn off automatically after a period of inactivity, or when the button is pressed again. An indicator 68, such as an LED, displays activity as well as can indicate the status of the power source.

A retract button 70 is preferably configured as a mechanical retraction input which disengages the mechanical latch holding the page in the fully extended mode wherein the user need not apply continued force during reading. The retraction can be configured in other ways such as a pull-pull mode, wherein once pulled past a certain extent it will latch, wherein a quick jerk pull on the handle can release the latch to allow retraction. Or the retraction can be deactivated by extending the page sufficiently past a border line (a “warning track”), wherein retraction occurs. In addition, this last mode is very helpful as additional menuing, table of contents, or other selection device, can be displayed past the normal boundary of the page, wherein the user can make a wider range of choices if they desire.

A marking button 72 is shown wherein the user can select a region to be highlighted, or otherwise marked. After pressing the mark button, such as with the thumb of the hand holding the “scroll”, the user can slide their finger along a section of the linear input 60 to make their selection. The results can be seen by doing a “quick cast” if desired, wherein the edge of those lines will show up as highlighted. The user can also mark sections for doing voice annotation if the microphone and memory are provided in the unit as shown in FIG. 1. Bookmark locations can also be inserted so that the user can readily find information, if the unit provides voice input, then notes associated with the bookmarks can be provided allowing the user to better find elements within the content. The marking button also preferably is configured to allow the user to select a section of text to copy into a buffer, such as double-clicking the button and then sliding their finger along a the linear input 60 to select the portion of text to paste into a buffer for later upload. Preferably pressing the mark button prior without selecting a section allows selecting the page.

A menuing button can be provided so that the user can go directly to a menu. The button is pressed and then the scroll retracted and extended to reach the menu. It will be appreciated that a menu selection can be contained on each page, wherein this control can be eliminated.

Optional Solar Collection.

The electronic ink book device can be powered by any desired form of electrical energy source, such as fuel cell, conventional primary batteries, or the use of rechargeable (secondary) batteries (or supercapacitors). However, it will be appreciated that secondary batteries and capacitors lose their charge over time. Therefore, the system of FIG. 58 is shown optionally configured with a solar cell region to charge or maintain the state of charge. In this embodiment one solar collection region 34 is shown on the exterior of the stiffener so that the device can be kept in a good state of charge despite periods of non-use. The solar collection preferably comprises a polymeric device wherein it is manufactured inexpensively, can conform to various shapes, and is rugged. The attachment structure in this depiction preferably providing the electrical connectivity from the solar panel to the device. It should be appreciated that the solar cell can be retained on housing 12 as region 34′, on the reverse side of display 14 as a flexible solar panel 16′ wherein a large surface is provided for charging, or other location. Solar collection may additionally or alternatively be provided on the front surface 16 of display 14, such as using a layer of polymeric collector in layers behind the electronic ink layer, insofar as sufficient radiation is received through the eink spheres to the collection regions. It should be appreciated that the use of even a small section (i.e. less than or equal to one-half to one square inch) of solar panel is advantageous in that the unit can be retained in a charged state without the need to keep it coupled to a charger at all times, or periodically. The use of a larger solar panel can eliminate the need for even the normal charging, or provide sufficient power that conventional charging or adapters are necessary only in periods of heavy use. It should also be appreciated that the low power requirements of electronic ink are well suited for use in a portable application, such as this. (Integration of a flexible solar panel that rolls up in a small portable device for non-use charging is also described within another application by the inventor.)

Optional Backlighting.

Utilizing the backlite electronic ink described in another portion of this application, the unit can be configured for reading in dim light situations at little extra cost. The OLED layers add little cost to the basic scroll cost. The backlight can be controlled, such as by replacing the menu button 74 with a backlight control 74.

### Fold-Up Embodiment

FIG. 60 and FIG. 61 illustrate an embodiment 90 by way of example of a moving electrode array form of electronic book, having a housing 92 formed in this case as a fold-up book with a first half 94 (front) and a second half 96 (back). It should be appreciated that this form of device can be integrated within personal digital assitants, telephones and the like in addition to the described eBook application. Slider controls 98100 are shown on an edge of the book halves for being moved along slots 102, 104 respectively, to change the selected page by updating the electronic ink on the display. Although this embodiment could be implemented as a single half with slider, the incorporation of two halves provides protection for the electronic ink surface and allows the user to maintain their view on a first page while changing their view on the second. For example displaying a table of contents on a first half and displaying a page of interest on the other half. The interior of each half is configured with a material having a common electrode near the surface underneath which is a layer containing electronic ink spheres beneath which a movable array of programming electrodes can be slide to program the state of the electronic ink. A mechanism for registering the motion of slider 98, 100 is also provided to synchronize the output to the electrode bar with the motion of the slide to assure properly formed text and graphics.

An optional active display area 108 can be provided with user inputs 110, and/or the electrodes on front or back may be utilized in an input mode, to detect inputs on a surface input area 112, shown in a menu grid.

Alternatively a separate row of electrodes can be coupled to slider 98 wherein both the front and/or rear surface of the section 94 can be programmed in response to the sliding action. In this instance the front surface can also be selected for gathering inputs. The slider can update the menus or selection on area 112 and in input mode the user can make a selection, write a character, draw, and so forth.

In an alternative embodiment of the above, a single two-sided slider can be provided which rides between the two halves, writing to either or both halves simultaneously. It should also be appreciated that a large number of embodiments can be provided by combination of those described.

### Vertical Roll Embodiment

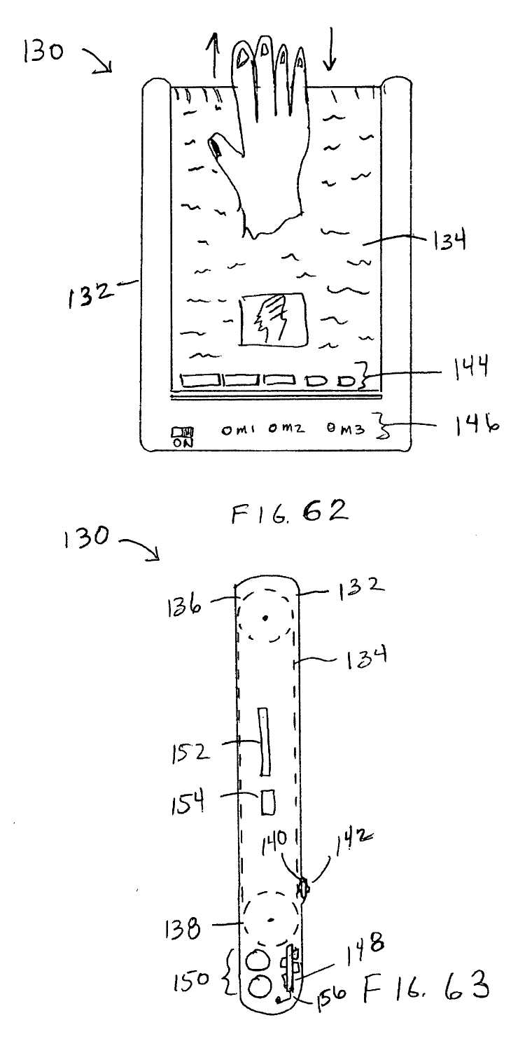

FIG. 62 and FIG. 63 illustrate an embodiment 130 by way of example of a rolling scroll embodiment of the present invention. This describes a variation of a display described previously by the inventor in a application incorporated herein by reference. In this embodiment the user changes pages by scrolling the electronic material forward wherein additional lines of text are displayed. In a variant of this embodiment the user can scroll back to view the previous page which is retained on the backside and has not been overwritten yet.

A housing 132 is shown within which an electronic ink laden material 134 is retained between two rotatable retainers 136, 138 at each end (i.e. circular, oval, octagonal, or other polygonal cross-section). A portion of the backside of housing 132 may be open, or more preferably transparent, allowing the user to view both sides. An array of eink programming electrodes 140 are retained proximal a surface of the material 134, in this embodiment the upper surface. The electrodes are also used as an input device 142 for allowing the user to select items from the screen, in response to pressing one of the menu commands 146. Once the menu has been used the user can back scroll the display to erase the menu returning the original content stream (i.e. lines of content) if desired. Electronics 148 contain a processor for controlling the user interface and outputting data from a memory to the electrodes which program the electronic ink on the display. A power source, such batteries, are shown retained within the housing 132.

Interfacing for downloading content to the viewer, or installing memory modules is depicted as a slot 152 and an interface connection 154, although the unit can be equipped with a transceiver (i.e. BlueTooth etc.) for wirelessly 156 downloading content. Connections 152, 154 can be coupled to circuit 148 with wiring, flex circuit, or other means (not shown).

Other Beneficial Features.

These beneficial features are written with regard to FIG. 58 although they can be implemented, or variations thereof, on a number of the embodiments.

Note taking. Embodiments of the system can be configured with other beneficial features can be added to the system, such as a recording element. In one embodiment a mode of recording provides context sensitive notes, wherein the entered speech is stored with tags to the location or locations of the text to which it is associated. The notes can be stored in relation to the whole page (i.e. such as by default), or the user can select the paragraph, line, or even word, to which the notes are to be associated. It will be appreciated that an embodiment within this invention has been described to allow the electrode bar to be utilized for capturing input, which can facilitate allowing the user to select where to place the note.

Furthermore, in one preferred mode of the invention the user can select whether the reader should listen to the note first (pre-note), or after reading this portion of the text (post-note). For example, if the user records the note first and then places it, then it is registered as a pre-note, if they place first and then record then it can be considered a post-note; making the user interface intuitive. In this way, the user can annotate the text they are reading.

Upon later viewing the page containing the spoken notes, markers are displayed indicating the location of the notes. The user can elect to play the notes as desired. Alternatively, the user may select a note, wherein that page is accessed by extending the page. In a playback mode the user can play the notes sequentially, pausing to read the associated text. If pre and post notes are designated then the unit can direct the user to read first, if that is what a note indicates, or otherwise will play the audio first wherein the user knows to then read the text.

It should be readily appreciated that the present device allows users to share information and notes about book content. If the content of the book (i.e. book, paper, document, and so forth) is public domain, then the content as well as the notes can be shared between users. Features can be provided for converting the notes to text as desired, however, this is less preferable in a small unit as the user has little facility toward correction. If conversion to text is desired, it is preferable that the notes be passed to a computer system having a keyboard, touch screen or other user interface which provides sufficient controls for editing text. Once converted to text the file can be input to the present system and the voice notes deleted, if desired, (user may want to select either text or spoken notes). The system can be configured for showing the textual notes as footnotes for each page, as this makes the distinction between content sources evident. In this way the author of the footnote can be more readily indicated as well. The text notes could be displayed with the other text, however, this could lead to confusion, it also requires that the content be reformatted based on the notes being input, which adds complexity, especially when text and graphic elements share the pages of the system. To provide communication of notes, as well as content, the present system is preferably configured with a wired connection, such as USB, Firewire, or other convenient standard, although wireless connectivity is another option.

It should also be appreciated that the above features can be performed on a reading device having an active display, instead of a static display which requires movement of the electrodes over the page to program the electronic ink. With an active display additional features can be readily provided, such as markings locations for the notes at the time of their creation.

The display features described can be utilized for an electronic book or other equipment wherein material is displayed. Other applications may additionally provide audio output and other forms of sensing. For example, as described in another application by the inventor, a tour guide device is configured for sensing its external environment, such as with an RFID reader for challenging tags within the environment of the tour. GPS can be utilized, although preferably with a differential signal source to increase accuracy to that necessary for identifying locations within the tour location. In addition a bar code reader or localized RFID reader can be incorporated for identifying elements in the environment for which information is available. These features can be incorporated into the book devices described herein along with audio output, such as through headphones, to facilitate the tours. The electronic book devices described herein can be utilized for manuals, incorporated into other equipment and the like in which its display properties are utilized.

Cylindrical Semi-Static Display Types.

Displays are utilized in a wide variety of applications, wherein manufacturers are always looking for novel display methods. This is particularly true in the case of low cost display systems. Therefore a need exists for lower cost alternative electronic controlled displays. The present invention fulfills that need and others.

Various embodiments of rotating semi-static displays are described within the present invention. These embodiments are particularly well suited for being implemented at low cost and having a low power consumption. The displays generally comprise a electronic ink sleeve over a housing, or cylinder within a housing. The creation of relative motion between the eink material and separate electrodes in the housing allow setting the state of the eink to be changed in response to the electrodes for displaying text and/or graphics.

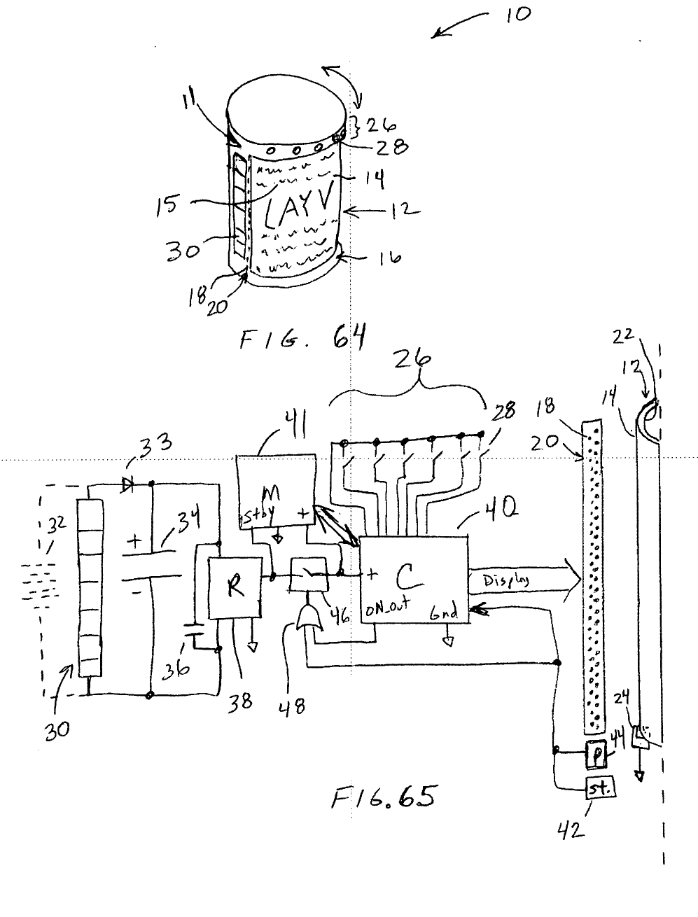

FIG. 64 depicts a rotating sleeve display device 10 with a sleeve-like housing 11 and a rotating cylinder 12 having an electronic ink region 14 whose optical state can be programmed to depict text and/or graphics 15 in response to rotating cylinder 12 within a housing 16. Text and graphics 15 is depicted in a paged arrangement, wherein rotating cylinder 12 causes a subsequent page to be displayed. By orienting the text rows vertically on cylinder 12, the user can smooth scroll the text and graphics exposing new content line by line as old content is rotated into sleeve housing 11.

A plurality of programming electrodes 18, preferably in a row, or bar 20 electrode, are retained adjacent the electronic ink material 14, and configured for applying programming voltages through the electrodes in combination with a rear electrode 22 (shown in FIG. 65). The electrode array is shown comprising two adjacent rows of electrodes, although other combinations may be utilized such as single row, single row with a single elongated erasure row, multiple rows of electrodes, and so forth. The electrical connection with the common electrode may be made through a sliding contacter 24 configured for making contact with the common electrode 22, for example connecting it to ground potential, or any other convenient conductive connection. Applying sufficient voltage between the individual electrodes of electrode bar 20 in relation to the common electrode allows setting the optical state of the electronic ink 14 over which the electrodes 18 are passed.

The device is shown with optional user inputs 26, shown in the form of buttons 28, for allowing the user to control what is to be displayed on electronic ink 14 as cylinder 12 is rotated. It should be appreciated that any convenient form of user inputs may be coupled to the device. For example the electrode array may be utilized as described previously with an input mode. The inputs shown are preferably aligned with a portion of the cylinder 12, wherein a menuing system is provided, wherein the system displays selections on the electronic ink which the user can select by pressing the buttons. The buttons may be coupled to housing 11 or cylinder 12, or otherwise coupled to the control electronics.

An optional solar collector region 30 is shown for powering the display system, for example implemented as a plurality of solar cells preferably connected in series, or alternatively in parallel or a combination thereof. The solar collector is preferably fabricated from a low-cost polymeric material fabrication technique either upon or attached to housing 11. It should be appreciated that since the eink display is fully static that display power is only needed when changing the state of the display by rotating cylinder 12. Therefore, the control electronics can remain in a quiescent mode with a power-storage capacitor building a full charge until the cylinder is rotated sufficiently to indicate use, wherein the control circuit enters an active state to control the electrodes according to use.

FIG. 65 illustrates an example of a circuit for electronic ink device 10. Power is shown being received from solar cell array 30, or optionally a battery 32. Alternative embodiments of the invention can be implemented using a piezoelectric material which upon being flexed provides the power for operation, or is used for input. Alternative embodiments are also contemplated that utilize other forms of energy, such as wind power driving a generator. Embodiments are contemplated herein using chemical energy from their surroundings, and so forth. Power is conditioned for use within the circuit, which is depicted herein as a rectifier 33, storage capacitor 34, and filter capacitor 36, which feed a voltage regulator 38.

A controller 40, with memory 41, is shown coupled to the separate electrodes 18 in electrode array 20. These are shown with separate connections from the controller to each separate electrode. For large displays it is more preferable that a series of series to parallel shift registers be implemented wherein the number of I/O lines required of the controller is thereby held to a fixed number despite display size. Embodiments of integrated electrode arrays are described elsewhere within this application. Furthermore, another embodiment describes the use of a matrix approach to controlling the electrode voltages in response to the combination of voltages that exist at multiple adjacent electrodes. Inputs to the controller preferably comprise optional inputs 26, as well as means for detecting the position and/or rotation of the display, such as a state of motion sensor 42 and a position sensor 44. The position must be sensed with sufficient repeatability, within less than a pixel, to allow outputting voltage changes to the electrode bar for changing the text and/or graphics on the display. Contacts may be used for detecting the motion, or optical sensors or other mechanisms may be employed to register the position. For example an off, on, off, on . . . set of connections are swiped by an electrode connected to controller 40, wherein it detects the transition from off (i.e. Gnd) to on (i.e. +V). Another contact can be utilized as an index, or multiple indexes so that the absolute position of the device can also be determined. It should be appreciated that a rotating encoder may be utilized with a wheel pressed against the movable display to detect motion, or another convenient means may be selected for registering the motion and preferably the position.

A circuit is shown to allow controller 40 to put itself to sleep (into a low power mode) when the display is not be used, as determined by it not be moved for a period of time. This aspect of the invention is depicted as an analog switch 46 which regulates power to circuit with controller 40. Preferably at least a keep alive voltage is maintained for memory 41 so that memory is not lost, presuming in this case that the memory is volatile and requires power to maintain state. In response to motion being detected from sensors 42, 44, the OR gate is temporarily activated which activates switch 46 to provide power to controller 40. Upon being activated, controller 40 activates OR gate 48 to maintain the switch in the On position for maintaining circuit power. When the controller senses that the device is no longer being used, such as in response to the position not changing for a specified period of time, it then deactivates the input to the OR gate which then allows the switch to enter the off position thereby reducing power requirements.

Generation the position change trigger can be performed with the above off, on, off switching (or V1, V2 switching; or V+, V− switching) by capacitively coupling the output to a very light pull-up or pull-down (may be inherent for input of controller) wherein the change of position generates a short transient pulse for temporarily activating controller 40. Controller 40 is preferably configured to lock on its power source and then to test is motion is actually occurring, if not then it can go right back to a low power mode.

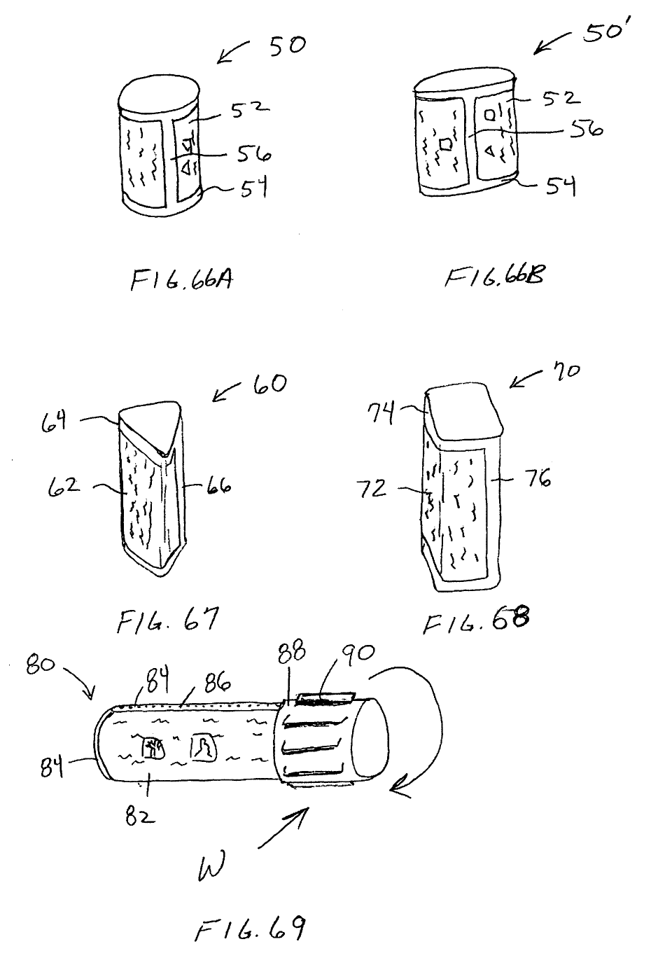

FIG. 66A and FIG. 66B illustrate another embodiment of the inventive display system 50 is fabricated as a flexible structure, which for example can collapse, and/or compress, when not in use. The housing then can flex back to a sufficiently smooth cross section to allow rotating flexible electronic ink material 52 on housing 54 having electrodes retained proximal the surface of eink material 52 on the underside of electrode bar 56. For example the housing can be a soft foam core, or otherwise be made collapsible. In this way the device can be stored in less space. It should be appreciated in this embodiment and the prior embodiments that the housing with the separate (pixelated) electrodes may be rotated about the eink material, instead of rotating the eink material within the housing.

FIG. 67 and FIG. 68 illustrate a couple of examples of another form of embodiment of the invention 60, 70 implemented with a flexible electronic ink material 62, 72 incorporating a common electrode. In this way housing 64, 74 with electrode bar 66, 76 can be configured in any exterior shape, although preferably the shape has substantially rounded edges. For instance the housing can have cross sections which triangular 60, square 70, or other shapes, such as oval, thin rectangular, thick rectangular, pentagons, hexagons, and any other desired closed shape over which the flexible display material can be moved in relation to the electrode bar, or the electrode bar moved in relation to the electronic ink material.

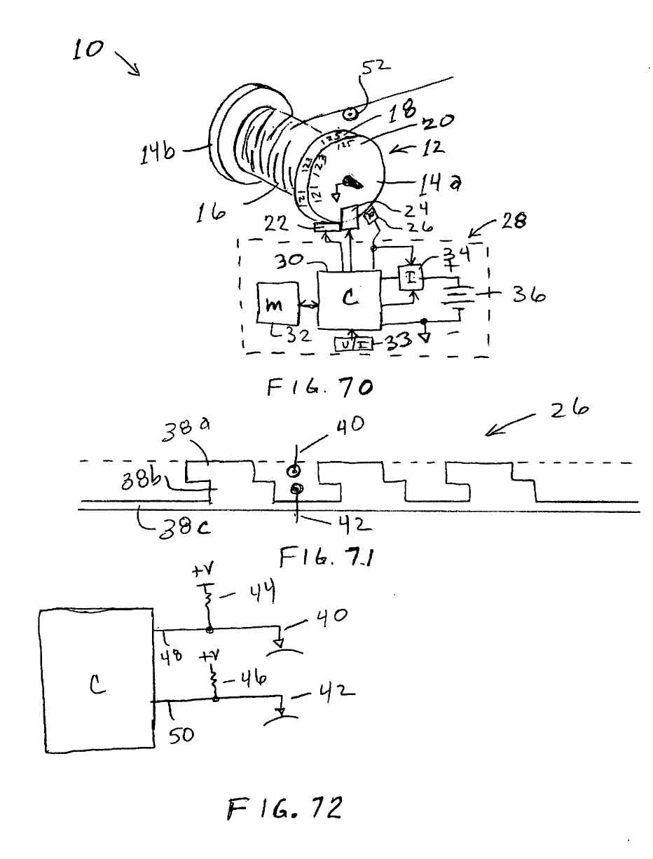

FIG. 69 is another embodiment of a display 80 which is driven by wind. An electronic ink material 82 is retained within a housing 84 having an electrode bar 86. The electronic ink material 82 and electrode bar 86 are configured to move in relation to one another, the rate of movement being registered by the display controller for timing the programming of the electrodes in the electrode bar. A means for converting wind energy to mechanical motion between the electrode bar 86 and electronic ink material 82 is shown comprising a rotating wind turbine 88 with apertures 90. It should be appreciated that propellers, and other structures utilized for converting wind energy to mechanical motion can be alternatively utilized. Preferably, the motion of the turbine not only provides motion of the separate electrodes in relation to the eink material, but also is configured with a dynamo for generating energy to provide power to the circuitry, for example for charging a battery or capacitor and providing all operating power.

The present embodiment may be implemented within a number of different applications, such as over rotatable knobs, on containers (i.e. prescription bottles, supplements, sport bottles, coffee mugs and beverage containers), over the exterior of electronic devices configured in a round shape (i.e. MP3 players, personal stereos, memory cards, USB memory sticks, cameras, low cost phones, etc.) utilized for an informational and user interface on various pieces of equipment. It will be appreciated that a wide variety of applications can make use of this form of low cost, low power display.

Spool or Reel Mounted Display.

A rotating housing, such as a spool/reel, configured with an integrated semi-static display. In one embodiment the display is updated as the housing rotates, such as for indicating the amount of line which has been extended from the reel.

FIG. 70 depicts a rotating spool or reel device 10 on shaft 11, such as a fishing reel, or any other spool device for which the amount of elongate material being played out from the spool, or remaining on the spool is to be displayed. The spool body 12 has ends 14a, 14b, and a winding core 16. An electronic ink layer 18 or 20 overlaying a common electrode (shown coupled to a ground potential through shaft 11) is coupled to some portion of the spool ends 14a, 14b, such as the edges or ends of the spool.

An electrode array 22, 24 is shown for printing on the edge and/or end of spool. A position/movement sensor 26 is shown for synchronizing the printing to the spool motion and for registering the amount of line being played out.

A control circuit 28 is shown having a controller 30 with memory 32 containing the mapping for printing the numbers on the reel. User inputs 33 are shown for selecting aspects of the operations, for example for setting a baseline (similar to a tare function but this zeros out the location of the spool), selecting units (i.e. centimeters, inches, foot and inches, etc.), and so forth. An on/off switch can be provided, this unit is preferably configured with a power controller 34 (i.e. FET switch(es)) shown for temporarily powering on controller 30 from battery 36 (or other charge storage device—which may be charged such as from solar energy cells, piezoelectrics, generators, or other energy generating means) in response to sufficient movement of the spool, wherein the controller locks the power controller into an on-state during operation and shuts it off when not in use for a sufficient period of time.

In another aspect of the invention calibration is incorporated wherein the user can indicate the amount of line which has been played out so that the unit will more accurately register the amount, instead of just relying on factory estimates which are based on reel size. For example a calibration-zero function is provided wherein the user can indicate the zero point, at which no line is played out. The zero function can also be used if a given amount must be played out to a minimum, for example setting the zero point to be the minimum amount of line necessary for clearing through the hoops of a fishing pole. In addition the calibration is preferably configured for establishing other points as determined by the user. For example the user may establish calibration points every fifty feet for a fishing reel, wherein the system saves the data points and can provide corrective estimations between the data points thereby increasing accuracy across the whole range of distances. An input is provided for selecting at least a zero distance, and more preferably entering any desired distance, either directly or as multiples of a given distance (i.e. 5 feet, 10 feet, 25 feet, 50 feet, 5 meters, and so forth). The processor stores the correlation between the calibrated distance indicated by the user with the number of rotations of the spool, or the amount of line played out as registered by other means. The processor then performs a point and slope correction across the range of calibrated distances, and can even extrapolate these corrections for distances beyond the calibration entries. When line is extended or retracted the correction factors are applied against the registered spool rotation or that registered by other means with the result being output on the display.

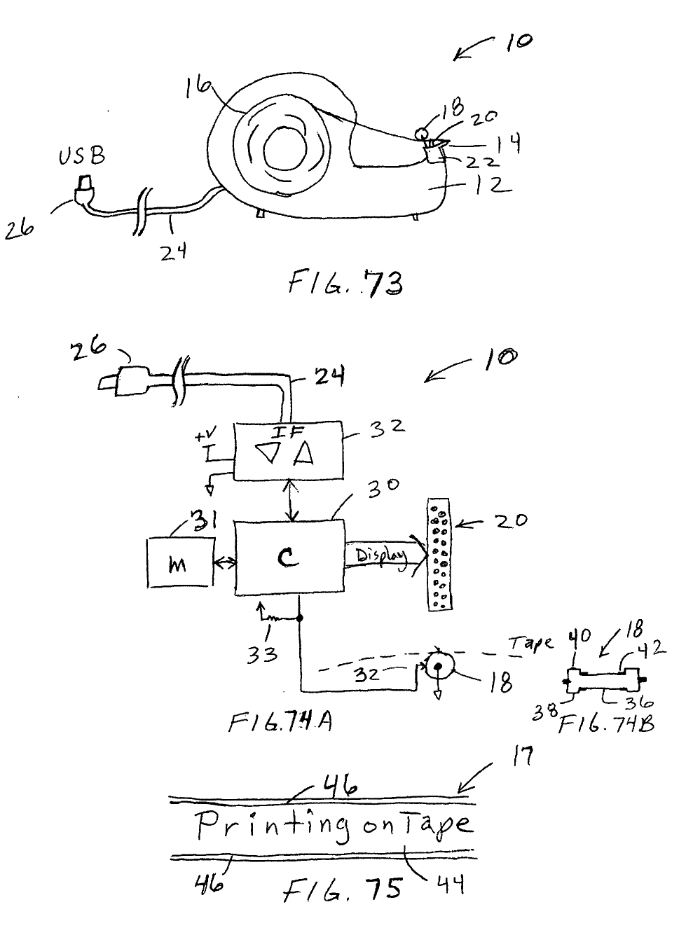

FIG. 71 and FIG. 72 illustrate a simple example of a position sensing means 26 implemented on a rotating portion of the spool 10. Conductive pads are shown with first segments 38a, and second segments 38b, which are interconnected to a voltage level, such as to ground potential. A first and second contactor 40, 42 are configured to contact the conductive pads 38a, 38b (preferably would be configured much wider that long so that positioning accuracy of contactors not a factor), which is sensed by the controller. One simple mechanism for sensing is shown wherein when a contactor 40, 42 touches the segments 38a, 38b it pulls the voltage of a controller input 48, 50, from its high voltage state through pull-up 44, 46 toward ground, which is sensed by the controller. The size of the segments of the conductive strips should be at least as finely pitched as the electronic ink programming electrodes, wherein dot output for the display can be accurately generated in response to the on, off, on state changes. The present embodiment utilizes the dual contactor so that the direction of motion can be detected. It will be noted from the position as shown that in moving in a first direction the contactors make contact with 38a first and in the other direction make contact with 38b first. In this way the direction of movement is readily determined, wherein the amount of material played out, or rewind can be constantly kept track of.

The controller is preferably configured with programming for calculating the circumference of the spool wherein it can determine the amount of line being played out or wound up in response to the rotation of the spool.

Another embodiment can be implemented by directly sensing the motion of the elongated material being played out or rewound. For example a rotating pulley 52 coupled to a rotational sensing element coupled to the controller. This is a more accurate means of registering the material going on or off the reel, and may be implemented in a manner like that shown in FIG. 71 and FIG. 72.

Tape Dispenser Configured for Making Labels.

A tape dispenser for semi-static printing upon a tape material having an electronic ink material coating. The text or graphics being output on the tape being preferably communicated to the tape dispenser via a wired or wireless communication link.

FIG. 73 depicts a tape dispenser 10. Much of this dispenser may appear as a conventional tape dispenser with a housing 12, cutting edge 14, and a spool of tape 16. However, this dispenser is configured for writing to tape 17 which has electronic ink, or similar electric field programmable static display material, embedded therein. A movement sensor 18 with a common electrode contact (not shown) and electrode array 20 are shown coupled to circuitry 22. The circuit 22 is configured for modulating the voltage on the separate electrodes within electrode array 20 at a rate synchronized to the registered motion of the tape by sensor 18, in response to data received through wire 24 and connector 26, such as a USB connection or other connection to a computer, PDA, cellular phone, or other device whose text and graphic content is to be programmed onto the tape being removed from the spool. Operating power is preferably received over the interface connection 26, wherein no internal power is required. Although shown as a wired interface it will be understood that a wireless interface (i.e. Bluetooth®, Firewire®, etc.) could be adopted for communicating text and graphics data with the unit.

Optionally, the device may provide two sets of programming electrodes, a first single electrode to be sure the whole tape is erased to a desired state, and a second set of pixelated electrodes for setting the electronic ink on the tape to the desired state. It should be appreciated text and graphics can be printed on the tape in a conventional format or in a reverse video format. The font, style, size, borders, and other aspects of the text and/or graphics being printed is controlled within this embodiment by the external device.

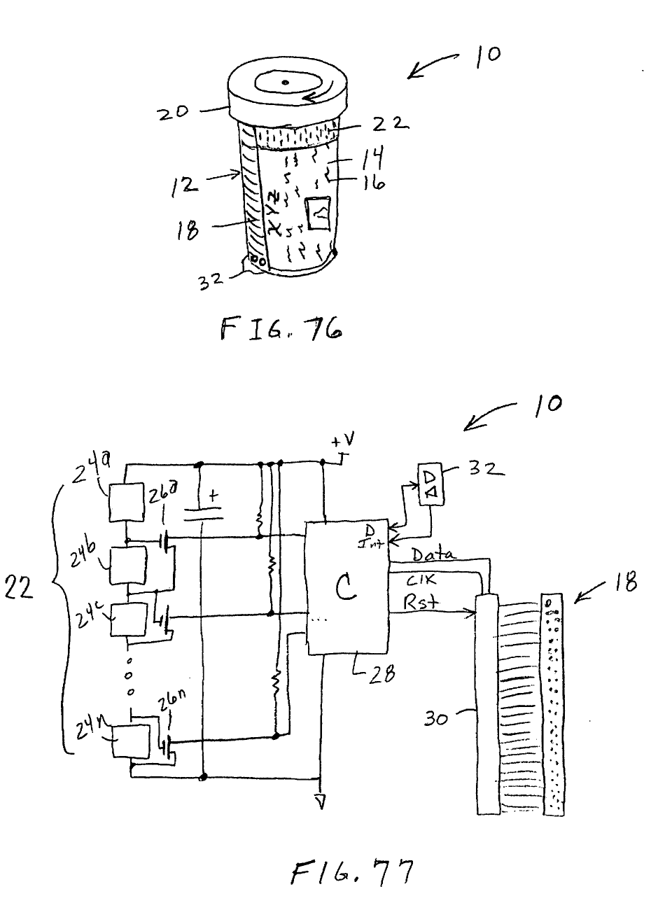

FIG. 74A depicts a circuit embodiment for tape dispenser 10 with controller 30 and memory 31 and interface 32 connected through wiring 24 to a communication link connector 26. The data for being written onto the tape material removed from the tape spool is received by the controller over the wired link. An application running on a computer based device, such as one having a user interface, is configured to allow the user to determine what is to be printed, which is communicated over the link to the tape dispenser device of the invention. Less preferably a user interface could be coupled directly to the device but this would increase complexity.

The movement of the tape is registered as the top of the tape moves past a motion sensor 18 (i.e. mechanical or optical). A contactor 32 is shown for registering movement as it passes over ground pads on the exterior of sensor 18, which pull down the voltage of an input to controller 30, which is otherwise pulled up. FIG. 74B depicts a mechanism for establishing electrical connection with the common electrode behind the electronic ink material layer (it is the sufficient difference in potential that programs the optical state of the electronic ink). The rotating sensor 18 is shown as a small spool having ends 38 and a center core 36 forming notch to keep the tape aligned as it is drawn out. Ground contacts are shown on the periphery of the ends 38 for sensing motion. Contacts or sets of contacts are shown on the edges of core 36 for contacting the common electrode within the tape.

FIG. 75 depicts the top view of tape 17 having a layer of electronic ink 44. Preferably the tape is configured with a common electrode behind the electronic ink layer. Electrical access to the common electrode may be provided in a number of alternative ways, such as depicted as having edge surface contacts 46 connected to the common electrode. The tape can be manufactured as a clear material or in any desired opaque or transparent color. The tape may be fabricated with a common electrode which is a thin conductive coating, the center section of which is then coated with a material containing the electronic ink, thereby leaving the edges still in contact with the common electrode.

Combination Solar Power and Sensor.

A display apparatus configured for displaying information in response to user rotation. Power for operating the display is generated from a set of solar cells, or the like, which are also connected to allow the circuitry to detect user rotation. A semi-static rotating display is described in which operating power and detection of motion, and optionally position, are provided in response to signals generated from portions of a solar cell array.

FIG. 76 depicts a rotating sleeve display device 10 with a cylindrical housing 12 is shown with an electronic ink surface 14 configured to be programmed for displaying text and graphics 16. A pixelated electrode array 18 is retained proximal to the surface of eink surface 14 for programming. A common electrode is beneath the electronic ink surface to provide a common opposing electrode for the electrode array 18.

The embodiment is shown in a container embodiment having a removable cap 20, although a number of alternative embodiments (i.e. drinking glasses, supplies, beverages, non-containers, informational displays, alert messages, and so forth) can be implemented without departing from the teachings herein.

This embodiment is configured with a ring of solar cells 22 that provide power for the circuit and also provides for detecting the relative position between the electrode array and the electronic ink material.

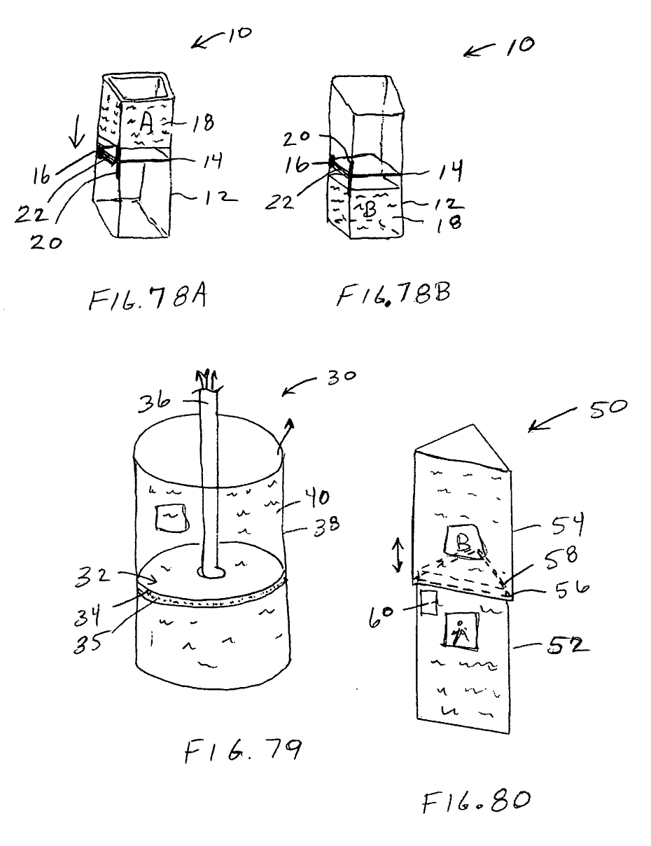

FIG. 77 illustrates an example circuit 10 powered by a series coupled set of solar cells 24a-24n. Controller 28 is configured for outputting data to control the voltages output on the electrode array 18 when programming the state of the electronic ink. A shift register 30 is shown for converting a serial data stream (i.e. data, clock, and reset or any convenient format) from the controller into parallel outputs for driving electrode array 18. A means for sensing which solar cells are receiving light is represented as switches (i.e. MOSFETS) 26a-26n whose gate transition voltage is approximately the threshold for the solar cell output between receiving light and not receiving light. The controller can thus detect the motion and positioning of the electrode array. It should be appreciated the circuit can be alternatively configured to just provide pulses in response to the motion, wherein the actual position need not be individually registered, thus reducing the data to be processed and number of traces.

A data interface 32 is shown for loading display data into the memory of device. The data may be received in any desired formation, such as text, bit mapped, and so forth.

To provide a high position resolution and low cost, it is preferable that the solar cells be fabricated as part of a polymeric circuit element. The sensing means is preferably configured within the solar cell circuit as a parallel to serial shift register, or similar, for allowing the controller to register position without requiring a large number of input lines on the controller.

Another very simple embodiment of a container can be configured with an exterior (or less preferably interior surface) containing electronic ink over a common electrode. The container is configured for insertion within a programming device that surrounds the exterior of the container, or is inserted within the interior, and which has sufficient fixed, or movable, electrodes to program the desired text and or graphics onto the electronic ink by applying a voltage to the separate electrodes in relation to the common electrode. In this way labels can be printed onto bottles without the need to laboriously tape an prescription printout onto the face of the bottle. The bottle can be reused for the refill, with any information on the label being automatically updated, such as the number of remaining refills, the expiration date, dosing, date of filling, as well as contact information.

Gravity Updated Semi-Static Display.

A semi-static display having two slidable engaged elements wherein the output is updated in response to sliding the two parts in relation to one another.

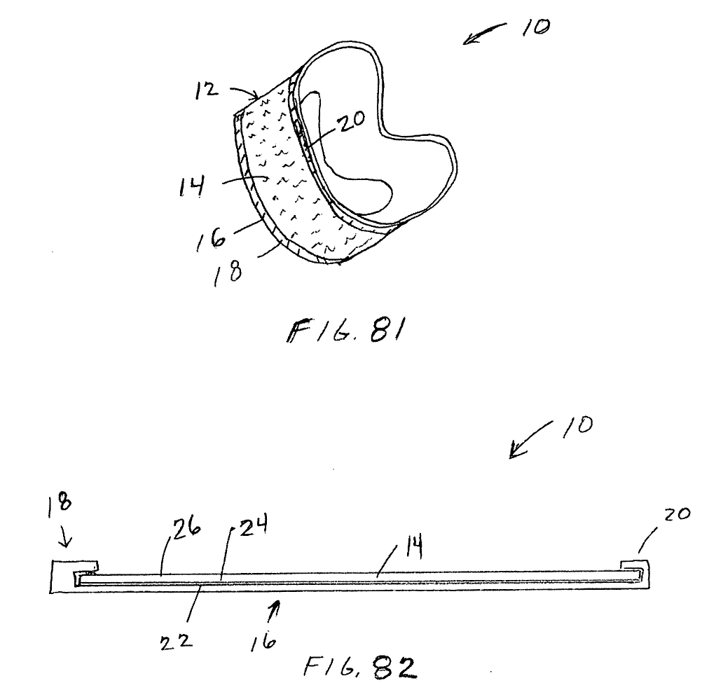

FIG. 78A and FIG. 78B depict two states of a gravity controller display 10. A transparent housing 12, is configured with an electrode array 14 about the interior perimeter which is coupled to a controller 16. Within housing 12 is a inner sleeve 18 having electronic ink on an outer surface and configured for sliding within housing 12. Sleeve 18 may be configured to sink in response to the effect of gravity, or to float in response to its relative buoyancy. Housing 12 may be filled with any convenient gases or liquids, such as air, water, combinations of water and oil and so forth. A common electrode is preferably buried beneath the electronic ink on sleeve 18, and a means provided for establishing electrical continuity with the controller. By way of example a contact rail 20 is shown which makes contact with sleeve 18 even when it is moved past the electrode arrays. A pixel pitch position sensor is preferably located along with the contact rail with at least dual contact patterns and contactors, as described previously, allowing the controller to sense both the motion and direction of sleeve 18 within housing 12.

It should be appreciated that a less preferable embodiment can be created by reversing the role of housing and sleeve. Power can be provided from a battery source, or more preferably from solar cells 22 on the unit which charge an energy storage device such as a capacitor.

Data to be written to the display is preferably received by wireless transmission, although it may be received optically, acoustically, by wired connection, or any other convenient data communication mechanism. For example the unit can be configured to receive data from digital radio broadcast, wherein it prints out information on inner sleeve when the unit is inverted so to allow the sleeve to pass by the electrode array. In one example, the unit can be configured with an audio output for the radio, while the unit stores text and/or images associated with the story. At any time the user can flip the unit over if they want to see a picture associated with the audio story being played. The unit can provide for displaying weather reports, time information, information communicated from any devices such as PC, PDA, wireless phones and the like. The unit can also be utilized for providing a low cost display for use with various games.

The electronics can be implemented in a similar manner as those described previously, and any source of data may be used to drive the display.

FIG. 79 illustrates an example of a piston style display 30 having a piston 32 herein depicted as an almost planar element 34 having an array of separate electrodes 35 about at least a portion of its exterior surface and moved by a rod 36 within a housing 38 whose interior contains electronic ink 40, or other voltage programmable static display element, over a common electrode (not shown).

The electronics for modulating the voltage on the separate electrodes are not shown in this example and are preferably located elsewhere and communicate signals through rod 36 to piston 32. Similarly, the means for registering the motion of piston 32 is depicted as if located within the element which drives the motion of the rod. The continuity between the common electrode and the electrode driving circuit can be established by wiring (not shown). Housing 38 is shown transparent for clarity, however, it is preferably semi-opaque to opaque, when utilizing conventional electronic ink which is not transparent regardless of programmed state. The unit can utilize electronic ink apparatus and methods described elsewhere for creating variable transparency electronic ink materials, wherein the interior of the piston can be lit to increase contrast and readability.

One application particularly well suited to this piston display device is the piston power workout device as found in another application by the inventor, which is incorporated herein by reference.

FIG. 80 illustrates an example of an over-under slide mechanism 50. This mechanism is preferably operated by manually pushing the portions together or apart. A first portion 52 is configured to be slidably engaged within a second portion 54. The exterior of either or both portions 52, 54 can provide a display output.

Electrodes within an electrode array 56 within the interior of second portion 54 can be voltage modulated in relation the voltage on a common electrode underneath electronic ink covering a portions of first portion 52. In this way as the upper portion is slide up from, or down over, the lower portion it programs the state of the electronic ink thus programming any desired text or graphics thereon.

In a similar manner electrodes in electrode array 58 on the exterior of first portion 52 can be voltage modulated in relation to the voltage on a common electrode behind the electronic covering the inner surface of second portion 54 which is transparent allowing the state of the electronic ink to be seen through the housing. Wherein the electronic ink displayed on the exterior of second portion 54 can be updated in response to sliding the two portions together or apart.

Electronics 60 is shown for controlling the modulation of the electrode arrays, and it can be configured to output information contained in a fixed memory, or it may receive information from an external source for display on the first or second portion of the display. It will be appreciated that the display may be made in any cross section insofar as the first and second portions are slidably engaged so that the electrode array passes over the outer and/or inner surfaces which are covered with electronic ink.

These embodiments can provide economical means for displaying a large amount of data, because each transition of the device allows displaying another set of information. It will be appreciated that user inputs may be coupled to any of these embodiments for providing menuing system, selecting moving forward or backward in a group of pages, or otherwise interacting with the display device to control its operation.

Flexible Sliding Display Powered by Piezoelectrics.

A flexible band display having a first portion that is slidably engaged about a second portion. The device is preferably powered by solar cells, and/or piezoelectric transducers which generate a voltage in response to the flexure of the material.

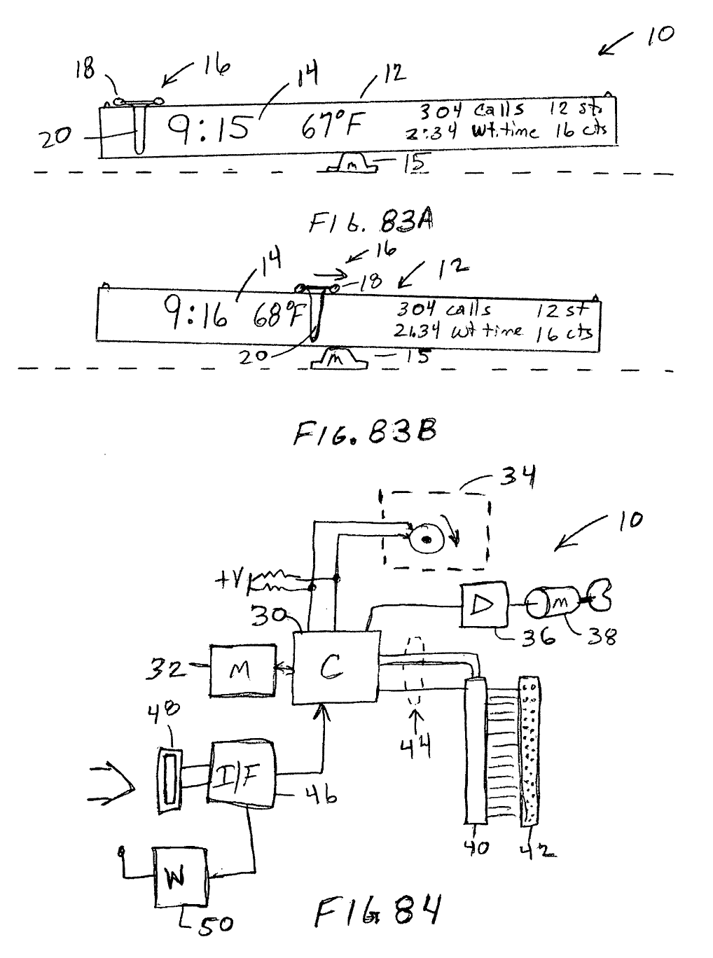

FIG. 81 and FIG. 82 depict a rotating sleeve display device 10 within a band 12. A material 14 having electronic ink, or other electric field programmable static display technology, is configured to slide within a carrier band 16. One implementation example of FIG. 82 shows band 16 which retains a material 14, such as by u-shaped retainers, or a material which covers a sufficient portion of material 14. Carrier band 16 is configured to have at least one array of electrodes 22 directed toward material 14 which has electronic ink 24 located near the interface between the two layers for being programmed by electrode 22. Material 14 is transparent so that the state of the underside eink 24 can be seen. A substantially transparent common electrode 26 (i.e. very thin metallic layer, such as the nickel used in lining antistatic bags) is coupled to the face of material 14 and coupled through u-shaped retainers or other conduction path with the circuit driving the electrode array.

In use the user slide the inner material along to update the display. The display can be configured so that it only display information on a selected portion of the display although material 14 slides around the whole device, this alleviates the need to rotate a body part when the display is being worn as an arm, wrist, or leg band.

Piezoelectric material may be integrated with the band, such on the edges or under the material 14, or even within material 14, wherein power is generated in response to flexure of the device, or even the sliding of material 14 along a non-circular path. In this way the device can be powered when being worn at day or night time. Alternatively or additionally, solar cells or similar electrical energy device can be coupled to the device for providing or augmenting the power.

The piezoelectric material may be incorporated to provide user interface functions, for example for selecting menuing in response to detecting the location where the material is flexed, such as pressing a button or flexing an edge of the device.

Data for the display can be received in any desired manner, such as by wireless means, or wired connection, furthermore the device could display information that it collects or that is has stored internally. A user interface of any convenient form may be coupled to the device, such as along the edges to facilitate user control of display output.

It will be appreciated that photo cells can be alternatively, or more preferably additionally incorporated within the device to provide at least a portion of the operating power for the device. The flexing of the display can generate power utilized for activating the device and/or for discerning specific user input, such as on a user interface.

Alternatively, but less preferably the device can contain embedded row and column for dynamically controlling the output of the display, wherein the piezoelectric materials provide the necessary operating power. Furthermore, unless the display is sufficiently flexed, or flexure is applied to a specific location, the power output from the piezoelectric transducer material is utilized for charging an energy storage device, such as a capacitor. The capacitor itself may be distributed between layers in the device or retained with the electronics which can be operatively coupled to the display device.

Tilt Response Semi-Static Display.

A display that is updated in response to being tilted, for example every minute, wherein an electrode array moves across the unit and can reprogram the electronic ink to new display settings.

FIG. 83A and FIG. 83B depict a tilting display device 10 having a display panel 12 covered with electronic ink 14, or a similar electrically state programmable static display. Display panel 12 in this embodiment is coupled to a means for imparting a tilt. In this example the means is provided by a base 15, having an actuator for tilting the display, such as at regular intervals.

A sliding device 16 is shown at a first end in FIG. 83A, which in response to a change in tilt begins moving to the opposing side as shown in FIG. 83B. The sliding device 16 can slide along a rail, or using wheels 18 as shown, preferably coupled along a path or track. An electrode array 20 extends from the tilting device and contains separate electrodes whose voltage can be modulated with respect to the voltage held on a common electrode behind the electronic ink on display panel 12.

FIG. 84 depicts a schematic for this arrangement with a controller 30 and memory 32. A means for detecting motion of sliding device 16 can be provided in any desired manner such as optical sensors, wires, mechanical detection, and so forth. By way of example the two adjacent segmented path mechanism is shown allowing the controller to detect the direction and motion of the platform. Tilt of the display panel 12 can be controlled by controller 30 which communicates with a power interface 36 which controls actuator 38, which could be geared motor with a cam, muscle wire actuation, or any other convenient means of altering the tilt of the display. It should be appreciated that the tilting need not be controlled by controller 30, as it may be operated separately, for example periodically oscillating display panel 12 back and forth, wherein the controller will be aware of the motion as it detects the movement of sliding device 16.

Controller 30 modulates the setting of electrodes in electrode array 42, such as by means of a serial to parallel converter 40. If the controller is located in base 15, then the pixel output must be communicated 44 to sliding device 16, such as through a serial connection (i.e. through the wheels, sliding connectors, or a wireless connection).

Data for output to the display is preferably received by an interface 46 coupled to controller 30. Interface 46 receives data via wired connection 48 or wireless connection 50. It will be appreciated that the wireless connection (as in all devices described herein) may comprise an RF device, magnetic field communication, inductive communication, optical link, acoustic link, and so forth.

Tracked Semi-Static Display.

A tracked display that is updated in response to the motion of a vehicle over a portion of a display board. Vehicle motion may be via a track (linear) or without a track (2D). The vehicle can contain all the control electronics and can update a display of arbitrary length.

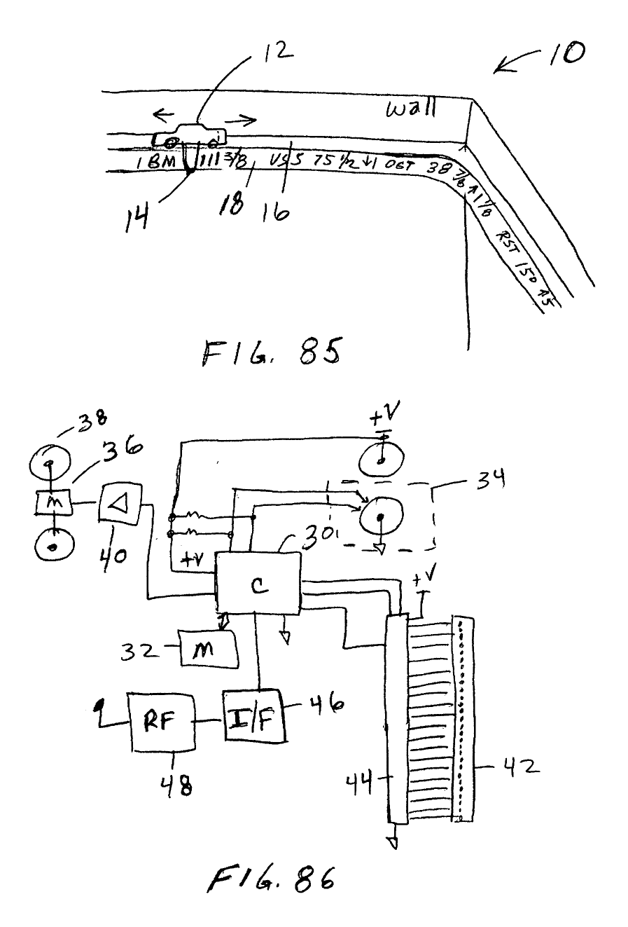

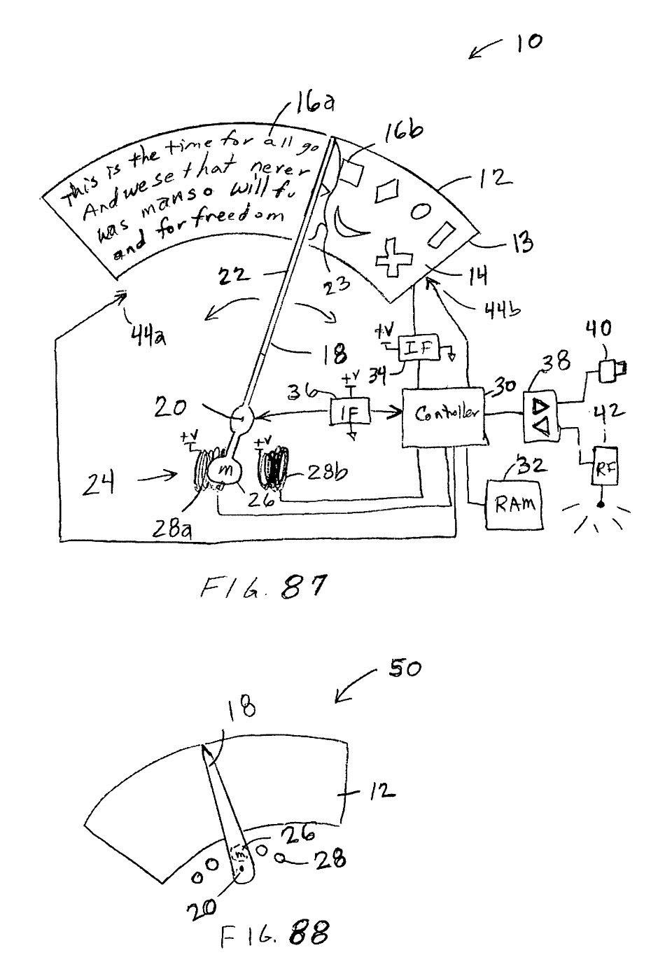

FIG. 85 depicts a tracked display device 10 comprising a movable platform, vehicle 12, configured with a electrode array 14 for programming the optical state of electronic ink as it is swept over the electronic ink area. Vehicle 12 is configured to move over a track 16 adjacent to a display board 18 on which is electronic ink, or other electrically programmable static display material, retained proximal to electrode array 14. The member extending from vehicle 12 upon which electrode array 14 is connected may be configured with a lip, or wheel which hooks on the bottom of the display board thus maintaining a fixed distance between the electrode array and the display board 18. Display board 18 is configured with a common electrode beneath the electronic ink, this being preferably connected to the same source of power (i.e. the ground leg) that the vehicle is deriving power from. Preferably the vehicle power is both positive and negative to simplify setting the display to either state.

FIG. 86 depicts a schematic for this embodiment with a controller 30 and memory 32. Power and ground is shown being derived from opposing wheels. A motion sensing means 34 is depicted again using the dual contactors sensing a dual skewed conductive pattern as the wheel rotates in relation to the vehicle. The wheels to the device are driven by an interface 40 which controls a simple DC motor 36 coupled to a pair of drive wheels 38. It should be appreciated that stepper motors, or similar accurate positioning means, may be utilized, however it is typically less costly to register the motion as shown than to move a device with high accuracy. To provide actual location information, the track can be configured to indicate to the vehicle select positions along the track, for example a post for triggering a vehicle switch providing a simple indexing means, a compass, a bar code reader or other form of detecting an actual position allowing the device to generate an output which is responsive to the actual position of the vehicle.

Controller 30 outputs display information as pixels for driving the electrodes in electrode array 42, such as via a serial to parallel converter 44. Data to be output on the display is preferably received wirelessly, such as shown through an interface 46 coupled to a radio-frequency communication link 48. Preferably the display data is received from a transmitter coupled to a computer system in the vicinity.

As the vehicle traverses a path, which may be around a room, or even following a corkscrew path covering the room more than once, it updates the display. It should be appreciated that a large scale display of this magnitude using LEDs could cost over a hundred thousand dollars and consume a great deal of power while being maintenance intensive, however, utilizing the present invention it could be implemented for about one hundred dollars and the technique applicable to a wide variety of display board situations.

Swinging Arc Sign.

An text and graphics display which outputs data in the form of an arc. The display can be produced at low cost and can simultaneously provide analog meter functions as well as controlling what is programmed on the backing (legend) of the display.

The system and method is configured for displaying text and graphics in a planar arc in response to the back and forth movement of an arm having a plurality of electrodes configured for programming electronic ink contained on a backing material into a first or second state. The arm is moved back and forth by an actuator when the display needs to be updated, periodically, or in a continuous manner such as appearing like a metronome.

In addition, the position of the arm itself can provide information in addition to the information which is programmed on the electronic ink the display material. For example, the arm can be used to display a measured value, such as volts, decibels, current, applause, danger level and so forth. The unit can thus be used for switching between the display of different functions with additional information being written on the backing of the display, such as what is measured along with warnings, calculations based on the collected information, trend lines, history of the data and so forth.

FIG. 87 illustrates an example embodiment of an arc display 10. A display base 12 is shown of a planar material having a base electrode 13 over which is retained electronic ink spheres 14, or similar material (eink will be referred to herein although other similar materials may be utilized) configured for being programmed to at least a first and second optical state in response to a sufficient electric field applied between a plurality of electrodes and the base electrode, and remaining in that state statically once the programming voltage field is removed. The eink can be programmed for displaying text, such as depicted on 16a and graphics, for example shown on the area of 16b. In the figure, the electrode arm is in the process of sweeping across display base 12 to update that display, which by way of example is shown changing between display text and graphics, although of course text and graphics can be mixed on the display.

An arm 18 is configured having a pivot 20 and a first side 22 on which a plurality of electrodes 23 are disposed (not visible as on reverse of arm adjacent material 12). It The electrode area 23 is shown spanning only a portion of arm 18, however, the electrodes can alternatively span the entire length of the arm, even extending to the opposing side of arm 18, specifically 26 which can be elongated. The arc area being covered by arm 18 may be extended to any size arc, including up to a full circle. Additionally, other arms may extend from pivot 20 to allow writing on portions of the eink with less movement of the arms, therefore faster and with less energy. Still further, the geometry of the arms can be different than that shown, and even change shape during use. For example the arm may extend by means of an actuator (i.e. muscle wire, or electromagnetic) in response to commands from the controller, thus allowing the size of the display output to change based in the conditions.

The second end of arm 18 is coupled to an actuator 24, exemplified as a magnet which can be pulled toward electromagnet 28a or electromagnet 28b, thereby swinging the arm across the face of the material holding the electronic ink. Other mechanisms can also be utilized for moving the arm back and forth across the arc 12.

A controller 30 with memory 32 is configured for controlling the voltages applied between the plurality of electrodes 23 and base electrode 13. The RAM memory is configured for retaining data to be displayed on the electronic ink 14 of material 12. Preferably, controller 30 outputs a serial bit stream through a conductor to electrodes 23 which are preferably implemented as a serial-to-parallel output electrode driver control as described in a related application from inventor. The controller preferably determines the position of arm 18 based on the timing and duty cycle being applied to arm 18 and empirical data about arm movement collected while implementing the display. Furthermore, a means for sensing arm motion can be incorporated to assure correct pixel output in response to position. One simple sensing means being provided as one or more position sensors 44a, 44b along the span of base 12, such as a electrical contacts 44a, 44b allowing the controller to detect when arm 18 touches the contact. The controller can use this information to correct for variable conditions, such as the drag induced by bearing 20, and similar disturbances from the nominal design.

Optional voltage level shifting interfaces 34, 36 are shown for translating the voltage levels to the electrodes so that sufficient programming voltages are provided. For example the highs and lows from controller 30 can be translated to a V+ and a V− with a sufficient voltage swing from ground to program the eink into a first alterative second state. If the output voltage of the controller is sufficiently high, then the level translator for the base can be used as a voltage divider wherein the controller outputs of low and high correspond to setting the eink into a first or second state.

Controller 30 can receive data for display 10 in any convenient manner, depicted is an interface driver 38 shown coupled to a wired interface 40, such as USB, Firewire, other standards or proprietary connections, and to a wireless interface 42, such as RFID, BlueTooth, and so forth.

Controller 30 can also generate signals for controlling the position of arm 18 wherein its position on base 12 is indicative of some measure, preferably for which a legend is printed on base 12 either printed permanently or in response to programming of the electronic ink. The actuator 24 may be configured to respond directly to voltage or current levels in a “linear mode” to indicate a position in the manner of a conventional old-style meter, however, with controller 30 programming the optical state of the electronic ink on base 12.

In one embodiment the frequency with which a given signal level is reached is indicated by the motion of arm 18, wherein the display shows current historical norms. Consider an example in which 100 electrode segments are contained along arm 18, wherein in response to movement of arm 18 the controller then activates a number of electrode corresponding to the number of times that position has been reached by the movement of arm 18 in a “linear mode”. and Preferably, controller 30 is configured to also control actuator 24 (or adjacent actuator) to move the arm for writing on any location of base 12 at a speed known to the controller.

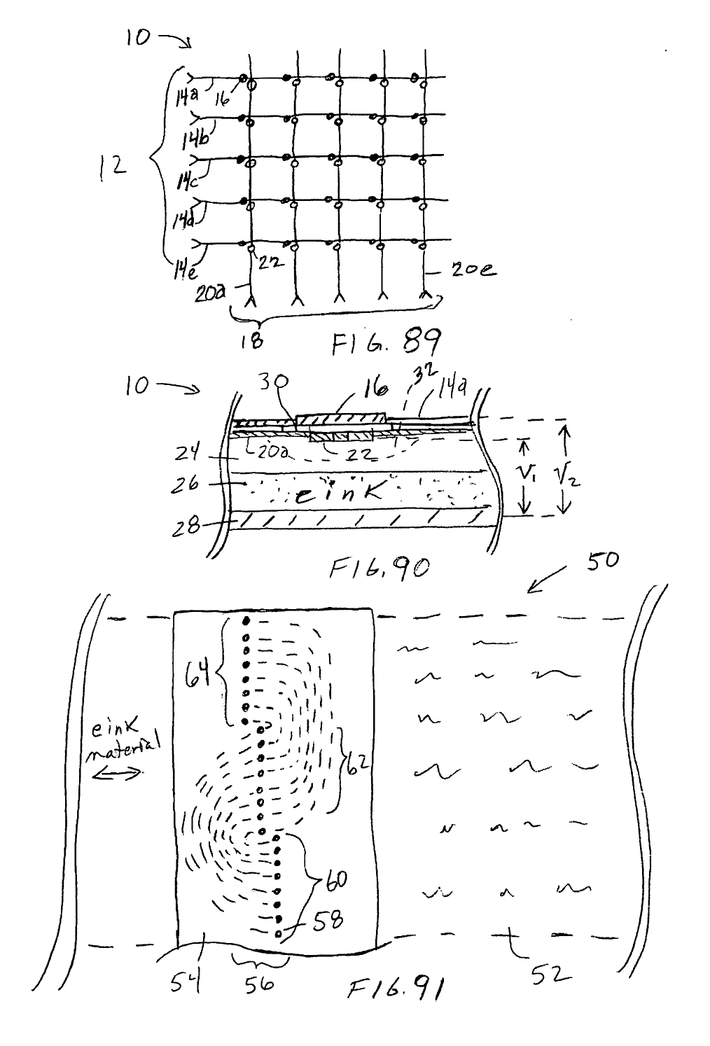

FIG. 88 depicts an alternate form of the display 50, in which the actuator and plurality of electrodes are on the same side of arm 18. A magnet 27 is located along the arm over a plurality of electromagnets 28. The controller moving the arm in similar manner as described earlier.

The actuator may comprise a motor, solenoid, voice coil, or other form of electromagnetic actuator. Furthermore actuation may be accomplished using other than electromagnetic actuators, for example muscle wire may be used to actuate against a biasing means, a piezoelectric motor can be used, and other mechanisms capable of generating a sufficient force for moving arm 18. Embodiments can also be created in which arm 18 is moved in response to non-electrical activity, such as for example moving in response to pressure changes as in a barometer, or similar mechanisms. The controller can provide for writing historical information on the backing 12, and preferably having an override is desired to allow writing over the entire display area for conveying alerts and other information as desired.

The resultant display is very low cost, consumes very little power and can provide a “retro” look which is popular in many applications. It will be appreciated that this can be utilized in a wide variety of applications. The display can be powered from conventional AC power, adapters, batteries, solar cells and so forth. It should also be recognized that the controller need support very few output lines, unlike the number of outputs necessary for controlling an LCD or similar row and column form of display.

Matrix Addressed Electrode Array.

An method and system of actively driving electronic ink display areas using a voltage combination provided on a first side in relation to a common electrode on a second side of the display. A novel form of row-column addressing for electronic ink displays is described which provides a number of advantages over conventional active electronic ink addressing techniques.

FIG. 89 depicts a row-column array 10 having rows 12 with lines 14a-14e to which first conductive plates 16 are coupled. Columns 18 have lines 20a-20f with second conductive plates 22. It should be appreciated that any number of rows or columns may be utilized with the display. Although the layout appears conventional, the differences can be readily discerned in FIG. 90.

In FIG. 90 the matrix is integrated within layers containing the electronic ink forming an active display. It can be seen in this view that the first and second conductive plates are adjacent one another such as preferably stacked, with both of them on the same side of the electronic ink area 26. An optional transparent layer 24 is shown, to simplify application of the matrix. A third conductor 28 is coupled behind electronic ink layer 26, preferably forming a conductive plane.

In this present invention the electronic ink pixel programming voltages are provided in response to the combination of the voltages V₁+V₂ on first and second conductors in relation to the common electrode 28. For example, consider the common electrode at ground potential and that programming of the eink in this embodiment requires a voltage of Vpth. By applying a positive voltage to line 14a and line 20a and no voltage to the remainder of the lines, the area at the junction of lines 14a and 20a is programmed to a new optical state, wherein the remainder of the display is erased. The voltage on lines 14a and 20a do not program the remainder of these lines because the voltage field generated is only about half of that required. In other embodiments the unused lines can be biased to a slightly negative voltage thus increasing noise margin, and at a higher negative voltage can erase that portion of the display.

The sizes of the conductive patterns can be adapted to suit the method of driving. For example, in the embodiment shown the electronic ink layer 26 is less sensitive to the voltage applied on first electrode 14a than to the voltage applied to the second electrode layer 20a, wherein the size the conductive area of 14a is enlarged relative to that of conductive area 22a. By using opposite voltage it will be appreciated that the programming voltage applied on 14a can be fully or partially nulled out by an opposing voltage applied on electrode 20a.

It should also be appreciated that this technique can be applied for more than two layers on the top surface, and various other mechanisms for combining the voltages to produce sufficient voltage at the given distance to program the optical state of the electronic ink.

It should also be appreciated that common electrode 28 can be replaced by a row or column, or more preferably another row-column combination. The use of row-columns on each face can provide a flexible input and output system, in which inputs and outputs can be provided on both sides of the material.

This form of eink active display driving has a large number of advantages.

(1) It will be appreciated that this form of display can still be programmed using a moving plurality of electrodes over the surface containing first and second electrodes; a voltage being applied to the moving electrodes in relation to the common electrode 28.

(2) It should also be appreciated that only side of the material is being processed in this approach.

(3) Furthermore, the proximity of the electrodes near the upper surface of the material allows for sensing inputs on the surface. For example in a simple embodiment, the insulator between conductor 16 and 22 is interrupted by a gap 30. Pressure applied to the top of conductor 16 causes contact with conductor 22. To sense the input, the electronics can either sense the current path between the electrodes, or more simply be switching itself between an input mode and an output mode. The output mode preferably being entered only when no inputs are being pressed. It will be appreciated that the input can be sensed capacitively, inductively, based on electric field changes or with respect to induced RF. Therefore, the present invention allows the traces laid for controlling an active eink display (or similar static electric-field programmed display technology) to also be utilized for collecting user input.

(4) Still further, inputs on the front surface of the display can be registered automatically as a change in optical state of the eink, without the need of processor interaction. For example, if material 24 is compliant, has compliant or void spots 32, the pressure applied to the surface moves the electrodes closer to the electronic ink resulting in a programming at a lesser voltage, such as applied during the read cycle, which in and of itself is insufficient for programming the display elements.

FIG. 91 illustrates by way of example an embodiment 50 having an electronic ink material 52 and a programming surface 54 in which the respective row or column lines 56 can be staggered across surface 54, only one layer is shown for clarity. The conductive pads 58 are dispersed along each row/column making three groups 60, 62, 64. These varied arrangements can be beneficial for select applications, such as when a desired relationship between inputs or output locations is desired.

Rewritable CD Labeling (Radial).

In order to mark media such as CDs, DVDs, tapes and the like, the user has been required in the past to purchase specialized labels, print the label such as on a printer, and then adhere the label to the media. This process is time consuming and there is no easy way to replace the label with an updated one, especially when rewritable media is utilized. The present system and method provides these capabilities.

To provide a low cost method and system for marking Media. The system utilizes elnk, or another form of non-volatile display programmed with voltage field, retained on a media in combination with an electrode plane, that when utilized with a writing device containing a set of electrodes and a connection for the electrode plane allow setting the pixels of the elnk to a desired state, thus writing on the media. The media may be printed upon within a separate device, although the invention provides an apparatus wherein the media may be labeled when recorded or otherwise retained within a player.

Electronic ink may be statically programmed using voltage fields from nearby electrodes to change the color state of the ink from a first state to a second state, or back again to the first state. By passing pixel electrodes over a surface of electronic ink under which a separate opposing power plane exists, the areas of the electronic ink may be written to. The present invention utilizes these effects for printing rewritable labels on media. The method and system of the invention is particularly well suited for use with rewritable media as both the contents and labels may be easily rewritten. The following will describe a few embodiments of the invention.

Media with Electronic Ink Writable Area.

The following description is based on a DVD or CD style media of any size. It will be appreciated that labels for any form of media having a regular surface may be printed using the present invention, thereby allowing the label to be rewritten at any time without the burden and mess of removing paper or ink adhered to the media surface.

Media according with the present invention is configured with a first conductive plane (i.e. ground plane) over which electronic ink is deposited, and a sealing layer that may be optionally overlaid over the ink layer for protection and aesthetics. Optionally a second transparent electrode grid may be placed coupled to the top of the media allowing the entire portion of the electronic ink to be set or reset at once, or at least regions sandwiched between the opposing large area electrodes in response to a programming voltage field.

To simplify making contact with the conductive layer, it may be extended into the center spindle and/or the perimeter. Furthermore, the conductive layer may be extended to at least a portion of the opposing side of the disk, such as near the center spindle hole or the perimeter. In this way electrical contact may be established with the conductive layer from either side of the disk depending on the construction of the printing device. Although the disk can be contacted on any portion of the electrode, this method eliminates the possibility of subjecting the data areas on the surface of the disk to damage, such as if a disk were to be incorrectly inserted with the data side in the incorrect direction, or on disks having data stored on both sides with printing being performed on only a portion of the surface such as on a ring about the spindle hole.

Optionally, rotational angle marks may be encoded onto the disk so that the position of the disk can be readily discerned when being “printed”. By way of example a series of optically responsive markers, such as pits, color bands, dots, and so forth are aligned at a fixed spacing on the outer, or inner, perimeter of the top surface. These angle marks may be alternatively, or additionally, located on the underside of the disk. These marks can be used for synchronizing the output to the electrode bar with the surface of the CD/DVD when being written.

It should be appreciated that it may be desirable in some thin forms of media to eliminate the underlying electrode, wherein an additional area electrode is provided on the writing device which is retained sufficiently close to the media to allow the electronic ink to be written to with a voltage field output on opposing sides of the media.

Player/Duplicator Media Carrier with Elnk Printing Head.

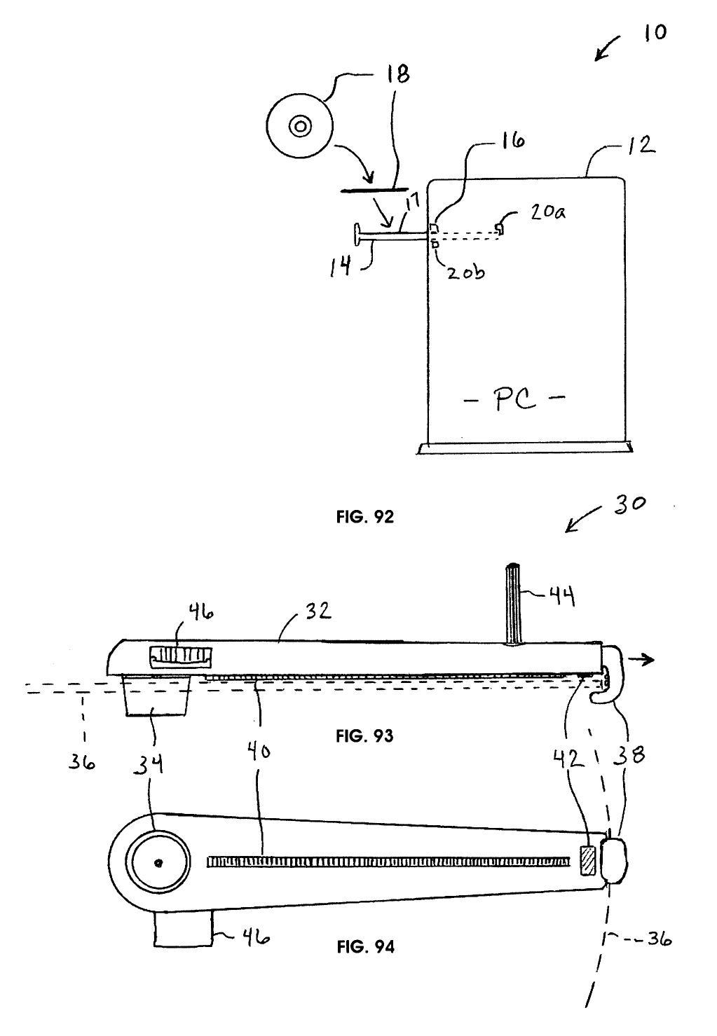

FIG. 92 depicts a personal computer 10 configured for receiving CD/DVD or similar planar media. By way of illustration, computer 10 has a housing 12 out of which a disk carrier 14 extends for receiving or ejecting a planar media such as a CD-ROM, R/W CD, DVD, R/W DVD, and so forth. It should be appreciated that this slide loading media player/recorder may be implemented within devices other than computers, such as laptop computers, media duplicators, home entertainment systems, personal stereos, audio and video recorder systems, media playback systems, systems for generating media for backing up computers, and other devices for accepting forms of media having elnk pixels near at least one surface to be written upon.

The present invention incorporates an electrode bar 16 and background electrode 17 configured for “printing” on a planar media having a surface containing electronic ink, or similar composition having areas that can be set to a first or second optical state in response to the application of a sufficient electric field. Electrode bar 16 is configured with a series of separate electrodes that may be set to a voltage that is above or below the voltage of background electrode 17 for programming the pixels in the elnk to either a first or second state.

Background electrode 17 may be retained at a fixed voltage or it may be varied with a voltage that depends on whether the disk is to be written to a first state or a second state.

As disk 18 (a media according to the present invention with electronic ink surface) within carrier 14 is retracted into the housing 12, or is ejected from housing 12, the electrodes write a label on the surface of disk 18 by modulating the voltages on the electrode with respect to the background electrode the time spent per pixel being dependent on the velocity of travel for the tray.

A sensor assembly 20a, 20b can be utilized for indicating to the software when the tray is open and when closed. The software preferably maintains a time value for the motion of the tray that can be divided by pixel pitch, with offsets for spacing on either side of the media. The software can thus modulate the voltage on the elements of the electrode bar at the proper timing to label the surface of the media. The drive may additionally register the actual travel rate wherein write speed to the elnk is matched to actual travel which can prevent irregular spacing particularly on older drives.

Programming executing on the system allows the user to enter label information, or to accept label information written in other programs, for example a text and graphics file written in a word processor. The programming may be contained in a separate application program or it may be integrated within a routine configured for accessing the media, in particular a program which allows writing data to the media. The present invention allows the disk to be relabeled whenever it is written, or otherwise at the discretion of the user since the data need not be written to allow a label to be written on the media.

The example above illustrates the use of slide drawer that linearly draws (moves) the media over an electrode array (bar), however, it should be appreciated that the media may be drawn in a circular pattern over the electrode with similar effect.

Rotating Label Writing Device.

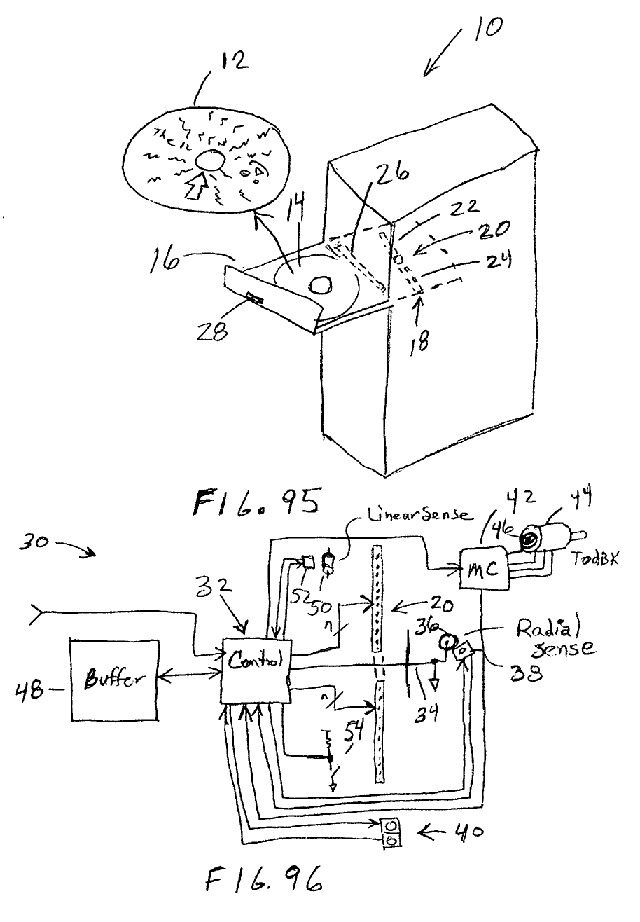

FIG. 93 and FIG. 94 illustrate an example of a separate media printing device 30 that is configured for being rotated about the central hole of the media while it programs the pixels on the surface of the disk to at least first and second states thereby printing a preferably non-volatile label on the media. A housing 32 is shown with a tapered spindle 34 extending from a distal end for insertion within a central aperture within a media 36. The proximal end is optionally configured with a combination tensioner and background electrode contact 38, which retains the media in the proper orientation with an electrode array 40, and can be used to make contact with the opposing electrode retained beneath the electrically programmable pixels, such as the elnk. It should be appreciated that the tensioner may be configured to extend from the sides of housing 32 to allow printing a label on media that has a smaller than the traditional diameter, for example the credit card sized media being increasingly utilized for business cards. A wheel 42 is shown near the proximal end of electrode bar 40 to allow the media to be rotated smoothly while held proximal to the electrodes within the bar. Wheel 42 may be conductive and configured for making contact with the background electrode. Furthermore wheel 42 may be coupled to a sensor for sensing the rotation of the media for controlling the rate at which pixels are programmed to display at least a first or second optical state.

A rotation stem 44 is shown extending near the proximal end of device 30 as a convenient means for the user to grasp the device and rotate it about media 18. Stem 44 preferably is configured to rotate so it is subject to less friction between the user's fingers in response to rotation. Alternatively stem 44 may be non-rotating but configured with a smooth exterior that easily slips on the user's skin under rotation. A sensor may be coupled to a rotating stalk to sense the motion of the printing unit over the media for controlling the rate at which pixels are programmed.

A programming port 46 is shown, herein exemplified as a USB port. The unit may be alternately configured to communicate with a source of pixel programming using any convenient communications medium, such as Firewire™, IR, RFID, wireless, RS-232, or any other means of transferring data from a host system.

The printing device may be powered from any convenient source of power, such as batteries, fuel cells, capacitors, solar cells, inductive charging, power drawn through the programming port, and so forth. This embodiment draws power from the USB port during programming to charge a capacitor that supplies programming power. A battery may be used in the unit for retaining device memory if that is important for a given application.

The embodiment is shown having a USB port through which power and programming are loaded into the device. The device is shown as a separate unit, however it may be implemented for accepting a USB memory device wherein the unit itself need not contain much memory or a USB interface. This can be performed in a similar manner that some current MP3 players are connected to a USB memory unit that has been loaded with MP3 tunes.

To use the device, the device is connected to a programming source and the printer memory is programmed to the desired pattern, such as on a personal computer, laptop computer, PDA, or other electronic device configured for generating a desired label pattern. Preferably, application software is provided on a target machine, such as a PC, that allows the user to create a label using an interface similar to a word processing interface. Once created, the data is converted to a bitmap pattern following a polar pattern for loading into the device. It will be appreciated that using a polar pattern allows the device to directly modulate the pixels in response to rotational movement wherein it need not transform Cartesian coordinates to polar coordinates on the fly.

Once loaded the user locks it into the center hub, and then uses a handle to rotate it about the disk. The rotation of the handle can be sensed as the angular speed of the device for synchronizing the writing pixels comprising the label onto the surface. In this way the disks need not have any angular markings present on the disk.

Incorporate within Other Forms of Players.

The techniques described above may be utilized for printing a pattern on elnk coated media within a number of different record or playback devices. By way of example a top loading media player may incorporate an electrode bar similar to that of FIG. 93 and FIG. 94, wherein the media is rotated by hand, or using a crank or similar input device, when held against the electrode bar to write a label on the media. For example, pressing in on a crank handle can lower the spindle and engage a peripheral edge wheel that transfers rotation from the crank to the media thus by sensing crank rotation the pixels on the media surface can be written to at the proper rate to create the desired label pattern. Alternatively, a separate spindle may be incorporated within the lid of the device for programming the pixels. It should be recognized that a number of similar methods for moving the media in relation with the electrode bar will be apparent to one of ordinary skill in the art without departing from the teachings of the present invention.

Other Forms of Media.

The technique described above may be utilized with other forms of media, such as credit cards, smart cards, memory cards, memory sticks, USB based devices, tape cassette, video cassettes and so forth. It will be appreciated that the pixels of elnk or similar are joined over a background electrode that is accessible to the writer, and the surface of the label being slid across a pixelated electrode (electrode bar with individually controllable electrodes the width of a pixel), as the pixel electrode voltages are modulated according to a pattern suited to the label being printed.

Voice Input Printing.

Label printing according to the invention may be configured to generate pixel programming for a label in response to other forms of input that is converted to a pixel bitmap. By way of example voice input may be utilized to enter text that is to be printed as a label, and the user may be prompted for text strings corresponding to title, author, date, volume label, description and so forth. It will be recognized that some devices do not naturally (without connecting to a system with a more sophisticated user interface) lend themselves to keyboard input, such as a portable CD/DVD recorder/player, or camera. In this case the system is configured to receive voice information, which is converted to text with voice recognition. If a display screen is available, the system can display the text prior to it being printed on the disk surface. Otherwise, the disk surface can be printed, and if wrong rewritten.

Another embodiment is described for the system and method of printing rewritable labels (text and/or graphics) on media. In the parent application the printing of media is described in one embodiment as being performed as the media is slid into the media writing device (i.e. CD/DVD drive, floppy disk slot, or other media receiving mechanism). The typical embodiment described therein, showed a series of electrodes configured for programming the state of the media as it was inserted or removed, wherein the writing is oriented in a Cartesian format, in a manner similar to the lines of text on this page.

It should be well understood, however, that the programming of the text can be any desired orientation or system of positioning. Herein is described in more detail an embodiment in which the text (or graphics) is printed in a polar format in response to rotation of a rotatable media, such as CDs, DVDs, or other media in which the exposed surface of the media can rotate within the media drive housing.

During printing the media may be rotated by the conventional spindle drive, by a separate drive assembly, or in response to user rotation (or mechanical user energy input which is then converted to rotational motion). It should be appreciated that the speed at which the electronic ink (or similar electric field programmable display) can be set to at least a first or second optical state, is limited by the speed by which the material can change states. Some forms of electronic ink may be capable of changing state at a sufficient rate, however, mechanisms are also described for reducing the effective rotation rate to “print” the rewritable label on the media.

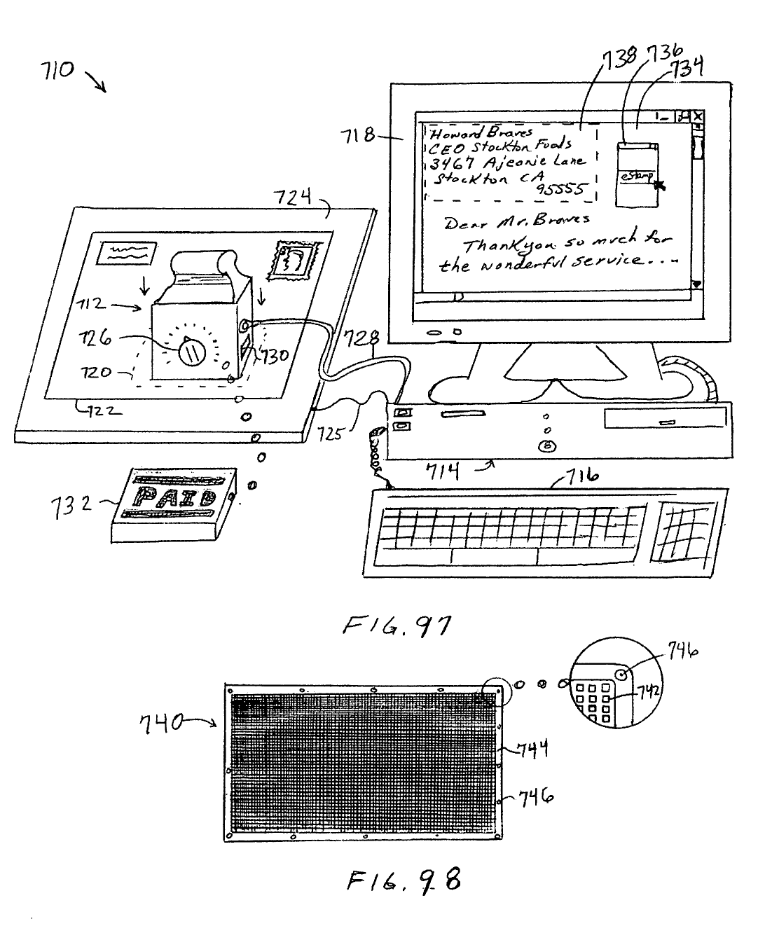

FIG. 95 depicts a preferred configuration 10 of a rewritable media drive device, which is similar to that of FIG. 92, but is also configured to provide for programming the state of the electronic ink based on radially-oriented text or graphics. This radial write feature generally inferred in the system of FIG. 93-94, but this embodiment illustrates the use of it in a media receiving electronics device. A media 12 is shown having at least one surface, portions of which contain electronic ink, or similar electric field programmable static elements. As described in the parent application, the media contains electronic ink over a base electrode to which an electrical access means is provided, wherein a voltage applied on a plurality of electrodes held proximal to the electronic ink, and having a sufficient voltage in relation to the base electrode causes the electronic ink to change state based on the relative polarity of voltage between base electrode and the electrode elements retained proximal the surface. For example, by having the base electrode held at ground potential and then varying the plurality of electrodes to either V+ or V− the sections of the display can be set to a first optical state or a second optical state. It should also be appreciated that more voltage states can be generated in the case of multicolor electronic ink, such as is responsive to different voltage levels, and so forth.

A means 14 for receiving the media is shown, such as within a slidable drawer 16, or alternately beneath a lid (not shown). The receiving means in the case of a slidable drawer is moved into a ready position 18. A means 20 for generating a plurality of pixel voltages is shown, which may comprise one electrode bar or two separated electrode bars 22, 24. The electrode bars 22, 24 are shown positioned crossing the center of the circular media, wherein under rotation of the media 12 all portions of the media surface can be accessed (if desired) by an electrode bar (or bars) of sufficient length. Alternatively, or additionally, the electrode bars may be placed at another position and not across the center of the media. For example, a single electrode 26 is shown at the entrance of the drive slot. This electrode can be utilized for programming the optical state of the media in a horizontal line (Cartesian manner), or optionally, the drive motion can be stopped approximately centered over the electrode wherein motion of the media be means of an actuator, motor, or even manually, can allow programming of the media surface with radial (polar) oriented text and/o graphics.

In one embodiment of the invention, the contact for the background electrode is provided within or about the circular hub, therein electrical contact is established when placing the media on the hub of the programmer/player device. Other contact arrangements for the background electrode can be implemented, however, it will be appreciated that since the disk is attached and driven from the hub, there is necessarily contact about the hub area. Also since this area does not contain data use of this area for a contact does not hinder size or use. The contact is preferably integrated as ac conductive layer over the disk, over which the electronic ink material is deposited over a large portion of the surface of the disk, excepting at least on side of the hub wherein contact is made with an electrode in the hub drive.

An optional manual input 28 is shown, such as a wheel, crank, push or pull device or other mechanical rotation means allowing the user to manually rotate the disk. This manual mode is preferably only provided in media drives that are incapable of driving the disk at a sufficiently slow speed for programming the media surface. The manual input can comprise any direct drive mechanism, means for storing and delivering rotations energy (i.e. flywheel, wound spring, etc.), or means of changing the gearing or engagement of the motor to alter the rotational speed of the drive during writing of the label.

FIG. 96 depicts a circuit 30 for controlling the programming of the optical state of the eink, such in a radial and/or horizontal orientation. A controller 32, such a microcontroller or other circuit element is shown. An electrode bar 20 (separate or single) is shown coupled to the controller, such as through two sets of “n” connections with each connection controlling a pixel of the electrode bar. In another embodiment the electrode bars may contain interface circuits, such as serial-to-parallel circuitry, an embodiment of which is described in another related electronic ink application by the same inventor. A base contact 34 is also provided for establishing contact with the media, such as by means of a contact wheel 36 which contacts the surface of the media. A rotation sensor 38 (i.e. optical sensor) is shown adjacent to contact wheel 36 for registering the rotation of the media. Optionally a sensor 40 may be configured for directly detecting the motion of the media, for example by detecting the movement of the electronic ink pixels, or more preferably in response to detecting optical markings (i.e. protrusions, indentations, etching, printing, etc.) along a circular path on the disk surface, such as near the outer edge. In either case the rotation of the disk can be registered by the system. In another embodiment media rotation can be detected in response to how the spindle drive is controlled. Controller 32 is shown coupled to a motor controller 42 (or other form of spindle drive control) which controls the speed of motor 44 (or similar rotational actuator. Power may be applied in pulses to slow the speed of the drive, gearing may be changed, drag induced, or any other convenient mechanism for providing a sufficiently slow rotation speed for eink programming. The motor may be controlled in a manner wherein the precise position is known, such as using a stepper motor. Alternatively, a rotational position sensor 46 may be coupled to the motor to register motion.

Controller 32 is configured to receive commands and data for programming the optical state of the electronic ink. Data is preferably retained in a memory buffer 48 therein reducing the workload of the host processor and eliminating the need to synchronize communications during the writing of the label on the media. Preferably the memory is sufficiently large to retain the text and/or graphics to be written on the disk surface. Once loaded with the data the controller is activated to program the electronic ink on the media surface, wherein it modulates the voltages on the electrodes, and optionally the base electrode while the disk is rotating.

If the drive is to be utilized for writing labels in a horizontal orientation, such as shown with the electrode bar 26 (in place of electrode bar 20), then the linear motion of the media must be detected during programming, such as by sense wheel 50 and sensor 52 (i.e. optical, hall effect, etc.). In addition, to switch between modes a detent, or sensor 54 is needed to detect when the media is centered over electrode bar 20 (or 26).

It should be appreciated that the rewritable media labeling system and method described can be economically implemented on a number of different systems and applications.

Electronic Ink Stamping.

Inked stamps are for marking both personal and business documents. Examples of common stamps include: “PAID”, return address, “Received O” date stamps, “COPY”, “Proprietary”, and so forth. Currently individual stamps are purchased with preprogrammed messages with seprate or integrated ink retention that must be periodically inked. These stamps have limited utility and are often messy, and once programmed can not be rewritten.

A method and system for stamping two dimensional surfaces containing electronic ink with a user selected indicia which is retained thereafter on the article, until reprogrammed. An electronic ink stamp is taught having a similar look and feel as conventional pressure applied ink stamps. The unit is pressed onto a surface containing electronic ink, wherein it “stamps” a message from memory, or received from an external device, onto the surface as state changes of the electronic ink. The stamp unit has a grid of electrodes and configured for “stamping” text and/or graphics onto surfaces containing spheres of electronic ink, or similar materials with voltage field responsive optical properties that remain static after the voltage field is removed. A common electrode is also retained under the electronic ink, either deposited beneath the electronic ink, or as a separate voltage plane for retention behind the area of electronic ink. (alternatively, the plane can be in front with individual pixel electrodes providing programming from the rear)

A number of messages can be preloaded onto the stamp which are user selected. Preferably the unit is also configured for interfacing with a computer, PDA, or similar computational device having a user interface. It may be interfaced by wire, or wireless communication.

FIG. 97 illustrates an embodiment 710 of the electronic ink stamp device 712 shown connected to a programming means in the form of a computer 714 with keyboard 716 and display 718.

Electronic ink stamp device 712 is depicted positioned for stamping information on a field 720 of electronic ink upon envelope 722 to which postage and return address have already been attached. It will be appreciated that the stamp device may be utilized for adding return addresses or electronic postage to an envelope. For example electronic postage is added by writing the indicia over a area of electronic ink on the envelope (or other form of mailing package). Once positioned, the user presses down on the unit wherein the state of the electronic ink is set to the message by applying sufficient voltages to each of the pixel electrodes and to the common electrode. It will be appreciated that areas of electronic ink can be programmed to either of at least two states (i.e. typically either “set” to a color, or “reset” to white, or other background color).

A common electrode may be fabricated beneath the label of electronic ink to which the stamp unit makes contact upon pressing the stamp unit down upon the label. For example a surface of the envelope (paper, bag, or other article) may be plated with sufficient nickel (i.e. similar to that applied to conductive nickel bags used for static protection), or other conductive material. An optional primer layer may be applied over the common electrode if desired, and the electronic ink layer added, over which another optional protective layer may be applied.

The method of operation preferably comprises: (a) detecting user applied pressure exceeding a threshold; (b) detecting continuity between at least two common electrode contacts; (c) outputting a proper voltage to all common electrode contacts; (d) outputting a programming voltage for a sufficient programming interval to each pixel in response to a message pattern retained in memory; (e) switching off programming voltages. Optionally, the end of the cycle can be annunciated, such as with an audio annunciator, LED output, or other form annunciator, letting the user know they can remove pressure and lift the stamper. If the user made a mistake, they can simply reposition the stamp unit and restamp another message on the material.

Alternatively, the common electrode need not be contained within the area to be stamped, but may be on a conductive surface 724, shown connected 725 to the computer as a source of ground voltage (about which the pixelated programming voltage are set (+/−) to allow setting areas of electronic ink in either desired state).

A message selector 726 allows the user to select which message is to be output on the electrodes of the electronic stamp. These messages can be preprogrammed, such as shipped with the unit, downloaded from a web site of stamp patterns, or created by the user for a single use or repeated use, captured by the user from a screen image shown on a computer screen, PDA, email. A cable interface 728 is shown connecting to a computer, such as an RS-232 interface, USB interface, and so forth. The cable interface can be left attached to the unit, wherein the user can pop up a screen of messages and select from them for immediate or later use. A wired or wireless port 730 may be alternatively incorporated allowing communication with an external device, via wireless RF (i.e. Bluetooth™), Infrared link, and so forth, or using a wired link, such as through USB port 730. The wired link can be used temporarily, wherein the user connects the stamp unit to the computer, such as a USB port, and then loads message data onto the stamp unit. The unit can then be removed and used for stamping. Any desired form of selector may be utilized on the unit. A simple push button may be utilized for selecting from preprogrammed messages, while the multiposition selector shown allows the user to reprogram any selected stamp message within the set of messages stored on the unit. Optionally, a small display (i.e. elnk, LCD, OLED, etc.) can be incorporated to display the currently selected stamp image, allowing a user to readily switch messages, such as pressing a button to scroll through a set of images, or select a category followed by an specific stamp image.

Although a display may be incorporated to allow the user to see the patterns, it is preferable that a cover 732 be adapted with electronic ink wherein each time the position of the selector is changed with the cover on the electronic ink is written with the new pattern, allowing the user quickly find the desired stamp pattern. The case is preferably configured to sense that cover 732 is attached, such as a switch, conductive path, or so forth, wherein the operation changes based on presence of cover (i.e. such as outputting pattern immediately upon changing pattern, and mirror imaging the pattern for proper viewing by the user). The cover preferably has the electronic ink deposited on the inner surface with a transparent ground plane over the exterior providing the opposing electrode that is retained at a particular voltage in relation to the programming voltage on the pixelated electrodes.

In the figure, computer display 718 is shown with an application display 734 from which the user has performed a right click to pop up a function screen 736 from which they selected a capture of screen information 738. The programming that downloads the message information to the stamp unit preferably provides user controlled formatting of the bit image, such as on a separate pop up screen, before transmitting it for use on the stamp unit. Data may be collected by the programming in a textual format or a graphic format. When captured in a text format then the program allows the user to select font and printed textual attributes, such as size, bolding, underlining, and so forth.

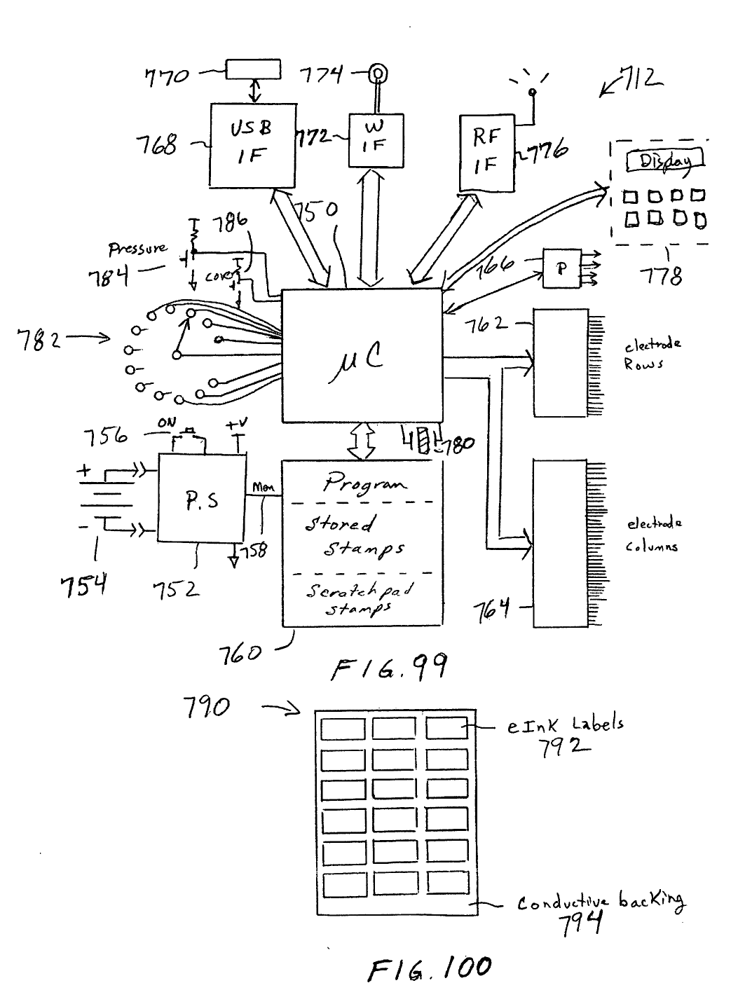

FIG. 98 illustrates the underside 740 of stamp unit 712 with a grid of electrode pixels 742 distributed over the surface. The output voltage of these can be controlled by a row and column grid which controls the activation of a buried transistor for each pixel to drive it to the desired voltage, generally either a set voltage or a reset voltage. It will be appreciated that a number of techniques are known in the art for driving a collection of pixels to a desired state.

The base 744 of the stamp 712 is shown fabricated from insulating material from which conductive electrodes 746 extend to make contact with a buried common electrode.

FIG. 99 illustrates an example embodiment of stamp unit circuit 712, comprising a microprocessor 750 (or other control element which is preferably programmable) with a number of inputs and outputs. A power supply 752 is shown connected to a battery 754 or other form of power source, such as fuel cell, high capacity capacitor, photocells, etc. A power control switch 756 is shown for activating the unit for use. An optional power output 758 is shown connecting from the power supply to the memory 760, such as for retaining the contents in a non-volatile state when the power to the unit has been turned off. The memory 760 preferably retains microcontroller (uC) programming as well as stored stamp messages, and memory space for user programmed stamps and other features. Output for driving the pixel electrodes is exemplified by row and column drivers 762, 764 connecting to buried transistors or other means of producing a desired voltage at the pixel.

A power controller 766 is shown with multiple outputs for detecting the continuity between common electrode contacts and when programming to supply the desired voltage to all common electrode outputs.

A number of interfaces are shown for connecting to external equipment, such as a wired port 768 with connector 770, such as USB. The unit can be hardwared, such as through interface 772 and cable 774. A wireless connection can also be established, such as RF or infrared, herein an RF interface is depicted 776. Optionally, the unit can be configured with a full user interface 778, providing user inputs and/or display outputs. This user interface may be similar to that provided for a conventional ink based label printer. An audio annunciator 780 is preferably incorporated to signal stamp completion, errors, and other status information.

A multiposition message selector 782 is depicted for selecting messages contained within the memory of the unit. A switch 784 is shown for detecting user application of pressure in response to a “stamping” operation. A detect switch 786 is also shown for optionally detecting the presence of the electronic ink cover 732, wherein the operation of the unit preferably changes as described.

FIG. 100 depicts a sheet 790 of electronic ink labels 792 and a conductive backing sheet 794. Preferably the surface of the labels can be printed on conventionally, and areas unprinted by conventional means, such as open blocks can then be printed by the stamp unit, or other electronic ink printing means, such as otherwise described by the inventor.

A number of embodiments of the stamp unit can be implemented with a variety of features, which may be utilized separately or in combinations, the following being provided by example.

Date field—The stamp unit can be configured to independently retain a date (and optionally time), or to obtain a proper date when connected to a computer, or to obtain a time and date from a GPS time signal, or other RF timing signal, such as a widely distributed signal linked to an atomic clock. A message then can include a date field, wherein the message need not be changed for each date. A real-time clock can be coupled to a microprocessor for maintaining the proper date.

User ID—the date and time from the unit, can be utilized with a means for identifying each user, such as within a timecard system. For example, a thumbprint scan pad on the unit identifies the user when the stamp unit is grasped, wherein the date, time, and person is included in the stamp message output onto a time record containing electronic ink. The electronic information may be retained for downloading into a billing system, wherein both a paper record and electronic record is maintained. The user ID can also be utilized for controlling the use of device features. For example, only a given individual may utilize the unit for directly stamping postage to prevent unwarranted use in a corporate setting. This may be applicable to a mode in which the unit is configured to automatically generate a desired level of postage when a stamp impression is performed.

Field data from external device—other external devices can provide field data for use within a stamp message. For example, the stamp unit may be connected to a scale (wired or wireless) or a scale may be incorporated within the stamp unit. Electronic postage stamps are automatically created by the unit in the correct value to suit the weight category of the piece.

Series field—The stamp unit can be configured with a field that the microprocessor updates after each stamp impression. For example, a serial number field, which changes with each depression of the stamp by an amount set by the user.

List mode—A list of messages can be downloaded from a computer to the stamp unit, wherein with each stamp impression the next message in the list is selected. This mode is particularly well suited for stamping addresses on a number of envelopes from a contact list, contact manager, or similar program retaining an address list. A user input is preferably provided allowing the user to roll back to the previous element in the list in case a mistake is made during stamping.

Capture mode—a portion of a screen (either used in captured graphical format or captured as the associated textual or images) is marked for imprinting by the stamp. The area selected is then adjusted to fit the pixel of the stamp, for example a area of 400 pixels×150 may be selected, wherein the stamp unit may contain 200 pixels×100 pixels. Also the color range of the captured area is preferably adjusted to the electronic system utilized, typically monochrome. The modified image may be shown on the computer prior to downloading or output on the stamp unit with elnk cover as described above, wherein the user can see how the output will be rendered, wherein they can make changes to the masking color contrast and so forth to reach the desired result.

Voice Capture—in a few applications it may be desirable to capture voice commands and select or create an output image in response. A microphone and voice processing routines executing on a microprocessor, signal processor, and/or other processing element is required to provide this level of user interface. For example, upon pressing a input selector a text string can be received in voice and converted by the processor into a string of text for output by the stamp device.

Common Electrode.

The continuity testing between common electrodes which are pressed down to make contact with a possibly buried (overlying insulator) common electrode can be incorporated within the rolling wheel common electrode contactor, wherein the test is performed between contacts on the same wheel, or preferably between contact on two wheels. Signals are preferably generated while the electronic ink is being printed if continuity is lost. The test can be performed periodically, wherein instead of outputting on each contact, one contact is set to output with others set to input, wherein the connection can be checked, such as based on charging or discharing the input capacitance. In this way the programming voltage can be supplied while the user is given feedback as to how well they are making contact with the common electrode, for example to allow the user to modulate the pressure applied.

Programmed Inked Deposition Operations.

The reprogrammable stamp described in FIG. 97-99 can also be configured for generating inked stamp imprints without substantially changing the design of the device. This mode allows the stamp to then be used on conventional material that do not have an electronic ink layer and a buried electrode layer.

It has not been fully appreciated in the creation of small portable stamping units that certain inks can be electrostatically charged, wherein they are repelled by a first polarity of charge and stick to surface containing a second polarity of charge.

In this embodiment of the invention a charged-aerosol inking station is provided for stamp unit. Once the stamp image has been selected the user places the stamp unit in the inker and activates inking. At that time the stamp electrodes are activated and the electrostatically charged ink is expelled as an aerosol within the base unit and adheres to a first portion of the pad of the stamp, while being repelled from other portions. Once inked the user pulls the unit from the inker and can make an inked impression on any material. The user can repeatedly charge and stamp the device if multiple impressions of the same image are needed. The image of the inked stamp is the image created from the pixels of the electrode array as programmed by the controller in response to user input. It should be appreciated that if the user wishes to change the stamp image being inked, that the electrode area on the pad of the stamp must be thoroughly cleaned, such as with a cleaning wipe, before reinking the stamp in the base station.

An embodiment can be created which can be utilized for either electronic ink based materials without ink, or with ink for conventional materials.

Accordingly, it will be seen that this invention provides a number of devices, systems, and methods associated with the display of text and/or graphics in a variety embodiments which incorporate electronic ink.

It will be appreciated that aspects of the invention can be combined with one another, and with what is known in the art, in an unlimited number of ways wihout departing from the teachings of the present invention.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof. For example, one of ordinary skill may find other suitable substitutes for certain applications, such as the following which are described without limitation: numerous types and configurations of electronic ink used in the embodiments; configuration, placement, number of electrodes, background contacts, as well as variations of the input methods.

Moreover, static and semi-static displays according to the various embodiments of the invention may be provided with all of the features described herein, or only portions thereof, which combinations may be practiced and/or sold together or separately. For example, an programmable label CD may be manufactured and sold separately from the writer, although the teachings of the present invention describe their use in combination. In this regard it will be appreciated that the invention assumes that these items can be sold individually, without departing from the present invention, the claims preferably drawn to covering each element separately or in combination. In addition each aspect described may be “adapted to” include or otherwise couple to equipment described herein, or equipment in general, without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A display material for providing controlled transparent illumination, comprising:
a plurality of tapered apertures within an opaque planar base material;
wherein said tapered apertures are sealed providing a narrow transparent window on a first side of said base material and a wider transparent window on a second side of said base material;
fluid filling said tapered apertures; and
particles retained within the fluid of said tapered apertures the combination forming transparent cells;
said particles configured for moving within said fluid in response to the application of a sufficient electric field;
whereby said particles upon moving into said narrow transparent window on said first side of material in response to an electric field block a substantial portion of light transmission, but when moved into said wider transparent window on a second side block substantially less light increasing the transparency of said material.

2. A display material as recited in claim 1, wherein the sealing of said tapered apertures comprises:
a transparent cover over a first side of said base material; and
a transparent, semi-transparent, reflective material, or a backlight layer covering a second side of said base material.

3. A display material as recited in claim 2, wherein said transparent cover can be clear or colored.

4. A display material as recited in claim 2, wherein an image may be overlayed within said cover, as a transparent image, reflective image, or light producing image.

5. An apparatus as recited in claim 1, wherein said fluid filled cells are of a sufficiently small size to allow the electrostatic potential applied between the first and second sides of said material to induce movement of said reflective particles toward one side of said material.

6. An apparatus as recited in claim 1, wherein said fluid filled cells are of a sufficiently small size so that said particles are held in a static position regardless of mechanical positioning, despite removal of programming voltage potentials.

7. A display material as recited in claim 1, wherein the apertures in said display material may be programmed to first or second state of light transmission in response to the application of a first or second voltage polarity across the material.

8. A display material as recited in claim 7, wherein said voltage potential is applied as the material passes proximal to an array of electrodes coupled to a control circuit for modulating the voltage on said electrodes.

9. A display material as recited in claim 8, wherein a single background potential electrode is retained proximal to an opposing side of said material to which said voltage on said array of electrodes is referenced.

10. A display material as recited in claim 8, wherein an electrode layer is coupled to said material and configured for receiving a background potential to which said voltage on said array of electrodes is referenced.

11. A display material as recited in claim 10, wherein said electrode layer for receiving a background potential is configured with a pattern that controls the distribution of said particles on that side of the display.

12. A display material as recited in claim 11, wherein said distribution comprises distributed about the periphery of said fluid filled cell.

13. A display material as recited in claim 7, further wherein said voltage potential is applied between row and column electrodes which are coupled proximal to said fluid filled cells and coupled to a control circuit for modulating the voltage on said electrodes.

14. A display material as recited in claim 13, wherein said electrode layer for receiving a background potential is configured with a pattern that controls the distribution of said particles on that side of the display.

15. A display material as recited in claim 14, wherein said distribution comprises distributed about the periphery of said fluid filled cell.

16. A display material as recited in claim 1, further comprising electrodes coupled to the surfaces of said display material for controlling the transparency of areas within the material.

17. A display material as recited in claim 16, wherein said areas of the material are divided into pixel regions which can be separately controlled in response to potentials applied to said electrodes.

18. A display material as recited in claim 17, wherein said electrodes comprise a common background reference electrode on a first surface and a plurality of programming electrodes on a second side for programming the state of said transparency state of said cells.

19. A display material as recited in claim 1, wherein said tapered apertures are tapered cylinders.

20. A display material as recited in claim 19, wherein said tapered cylinders have straight, concave, or convex sides.

21-59. (canceled)
